(19) United States
(12) Patent Application Publication
(10) Pub. No.: US 2009/0302604 A1
(43) Pub. Date: Dec. 10, 2009

(54) Method and Apparatus for coupling Expandable Tubular Members

(75) Inventor: Darrell Scott Costa, Kingwood, TX (US)

Correspondence Address: Conley Rose, P.C, P.O. Box 3267, Houston, TX, 77253-3267, US

(73) Assignee: ENVENTURE GLOBAL TECHNOLOGY, L.L.C., Houston, TX (US)

(21) Appl. No.: 12/089,731

(22) PCT Filed: Oct. 10, 2006
(86) PCT No.: PCT/US06/39373

§ 371 Date: Apr. 2, 2009

Related U.S. Application Data
(60) Provisional application No. 60/725,181, filed on Oct. 11, 2005.

(51) Int. Cl. F16L 13/14

(52) U.S. Cl. 285/382.1

(57) ABSTRACT

An expandable tubular coupling apparatus includes a first expandable tubular member, a second expandable tubular member, and means for sealingly coupling the first expandable tubular member to the second expandable tubular member.

### CROSS REFERENCE TO RELATED APPLICATIONS

This application claims the benefit of the filing date of U.S. provisional patent application Ser. No. 60/725,181, attorney docket number 25791.184, filed on Oct. 11, 2005, the disclosure of which is incorporated herein by reference.

This application is related to the following co-pending applications: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application serial No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/______, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. patent number 6,470,966, which was filed as patent application serial number 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May. 19, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application serial number 09/852,027, filed on May. 19, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US03/00609, filed on Jan. 19, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Nov. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

This application is also related to the following co-pending applications: (151) U.S. utility patent application Ser. No. 11/249,967, attorney docket number 25791.384, filed on Nov. 13, 2005, (152) U.S. provisional patent application Ser. No. 60/734,302, attorney docket number 25791.24, filed on Nov. 7, 2005, (153) U.S. provisional patent application Ser. No. 60/725,181, attorney docket number 25791.184, filed on Nov. 11, 2005, (154) PCT patent application serial number PCT/US2005/023391, attorney docket number 25791.299.02 filed Jun. 29, 2005 which claims priority from U.S. provisional patent application Ser. No. 60/585,370, attorney docket number 25791.299, filed on Jul. 2, 2004, (155) U.S. provisional patent application Ser. No. 60/721,579, attorney docket number 25791.327, filed on Sep. 28, 2005, (156) U.S. provisional patent application Ser. No. 60/717,391, attorney docket number 25791.214, filed on Sep. 15, 2005, (157) U.S. provisional patent application Ser. No. 60/702,935, attorney docket number 25791.133, filed on Jul. 27, 2005, (158) U.S. provisional patent application Ser. No. 60/663,913, attorney docket number 25791.32, filed on Mar. 21, 2005, (159) U.S. provisional patent application Ser. No. 60/652,564, attorney docket number 25791.348, filed on Feb. 14, 2005, (160) U.S. provisional patent application Ser. No. 60/645,840, attorney docket number 25791.324, filed on Jan. 21, 2005, (161) PCT patent application serial number PCT/US2005/043122, attorney docket number 25791.326.02, filed on Nov. 29, 2005 which claims priority from U.S. provisional patent application Ser. No. 60/631,703, attorney docket number 25791.326, filed on Nov. 30, 2004, (162) U.S. provisional patent application Ser. No. 60/752,787, attorney docket number 25791.339, filed on Dec. 22, 2005, (163) U.S. National Stage application Ser. No. 10/548,934, attorney docket no. 25791.253.05, filed on Sep. 12, 2005; (164) U.S. National Stage application Ser. No. 10/549,410, attorney docket no. 25791.262.05, filed on Sep. 13, 2005; (165) U.S. Provisional Patent Application No. 60/717,391, attorney docket no. 25791.214 filed on Sep. 15, 2005; (166) U.S. National Stage application Ser. No. 10/550,906, attorney docket no. 25791.260.06, filed on Sep. 27, 2005; (167) U.S. National Stage application Ser. No. 10/551,880, attorney docket no. 25791.270.06, filed on Sep. 30, 2005; (168) U.S. National Stage application Ser. No. 10/552,253, attorney docket no. 25791.273.06, filed on Oct. 4, 2005; (169) U.S. National Stage application Ser. No. 10/552,790, attorney docket no. 25791.272.06, filed on Oct. 11, 2005; (170) U.S. Provisional Patent Application No. 60/725,181, attorney docket no. 25791.184 filed on Oct. 11, 2005; (171) U.S. National Stage application Ser. No. 10/553,094, attorney docket no. 25791.193.03, filed on Oct. 13, 2005; (172) U.S. National Stage application Ser. No. 10/553,566, attorney docket no. 25791.277.06, filed on Oct. 17, 2005; (173) PCT Patent Application No. PCT/US2006/002449, attorney docket no. 25791.324.02 filed on Jan. 20, 2006, (174) PCT Patent Application No. PCT/US2006/004809, attorney docket no. 25791.348.02 filed on Feb. 9, 2006; (175) U.S. Utility patent application Ser. No. 11/356,899, attorney docket no. 25791.386, filed on Feb. 17, 2006, (176) U.S. National Stage application Ser. No. 10/568,200, attorney docket no. 25791.301.06, filed on Feb. 13, 2006, (177) U.S. National Stage application Ser. No. 10/568,719, attorney docket no. 25791.137.04, filed on Feb. 16, 2006, (178) U.S. National Stage application Ser. No. 10/569,323, attorney docket no. 25791.215.06, filed on Feb. 17, 2006, (179) U.S. National State patent application Ser. No. 10/571,041, attorney docket no. 25791.305.05, filed on Mar. 3, 2006; (180) U.S. National State patent application Ser. No. 10/571,017, attorney docket no. 25791.306.04, filed on Mar. 3, 2006; (181) U.S. National State patent application Ser. No. 10/571,086, attorney docket no. 25791.307.04, filed on Mar. 6, 2006; and (182) U.S. National State patent application Ser. No. 10/571,085, attorney docket no. 25791.308.07, filed on Mar. 6, 2006, (183) U.S. utility patent application Ser. No. 10/938,788, attorney docket number 25791.330, filed on Sep. 10, 2004, (184) U.S. utility patent application Ser. No. 10/938,225, attorney docket number 25791.331, filed on Sep. 10, 2004, (185) U.S. utility patent application Ser. No. 10/952,288, attorney docket number 25791.332, filed on Sep. 28, 2004, (186) U.S. utility patent application Ser. No. 10/952,416, attorney docket number 25791.333, filed on Sep. 28, 2004, (187) U.S. utility patent application Ser. No. 10/950,749, attorney docket number 25791.334, filed on Sep. 27, 2004, (188) U.S. utility patent application Ser. No. 10/950,869, attorney docket number 25791.335, filed on Sep. 27, 2004; (189) U.S. provisional patent application Ser. No. 60/761,324, attorney docket number 25791.340, filed on Jan. 23, 2006, (190) U.S. provisional patent application Ser. No. 60/754,556, attorney docket number 25791.342, filed on Dec. 28, 2005, (191) U.S. utility patent application Ser. No. 11/380,051, attorney docket number 25791.388, filed on Apr. 25, 2006, (192) U.S. utility patent application Ser. No. 11/380,055, attorney docket number 25791.389, filed on Apr. 25, 2006, (193) U.S. utility patent application Ser. No. 10/522,039, attorney docket number 25791.106.05, filed on Mar. 10, 2006; (194) U.S. provisional patent application Ser. No. 60/746,813, attorney docket number 25791.259, filed on May 9, 2006; (195) U.S. utility patent application Ser. No. 11/456,584, attorney docket number 25791.403, filed on Jul. 11, 2006; and (196) U.S. utility patent application Ser. No. 11/456,587, attorney docket number 25791.404, filed on Jul. 11, 2006; (197) PCT Patent Application No. PCT/US2006/009886, attorney docket no. 25791.32.02 filed on Mar. 21, 2006; (198) PCT Patent Application No. PCT/US2006/010674, attorney docket no. 25791.337.02 filed on Mar. 21, 2006; (199) U.S. Pat. No. 6,409,175 which issued Jun. 25, 2002, attorney docket no. 25791.159; (200) U.S. Pat. No. 6,550,821 which issued Apr. 22, 2003, attorney docket no. 25791.263; (201) U.S. patent application Ser. No. 10/767,953, filed Jan. 29, 2004, attorney docket no. 25791.309, now U.S. Pat. No. 7,077,211 which issued Jul. 18, 2006; (202) U.S. patent application Ser. No. 10/769,726, filed Jan. 30, 2004, attorney docket no. 25791.310; (203) U.S. patent application Ser. No. 10/770,363 filed Feb. 2, 2004, attorney docket no. 25791.311; (204) U.S. utility patent application Ser. No. 11/068,595, attorney docket no. 25791.349, filed on Feb. 28, 2005; (205) U.S. utility patent application Ser. No. 11/070,147, attorney docket no. 25791.351, filed on Mar. 2, 2005; (206) U.S. utility patent application Ser. No. 11/071,409, attorney docket no. 25791.352, filed on Mar. 2, 2005; (207) U.S. utility patent application Ser. No. 11/071,557, attorney docket no. 25791.353, filed on Mar. 3, 2005; (208) U.S. utility patent application Ser. No. 11/072,578, attorney docket no. 25791.354, filed on Mar. 4, 2005; (209) U.S. utility patent application Ser. No. 11/072,893, attorney docket no. 25791.355, filed on Mar. 4, 2005; (210) U.S. utility patent application Ser. No. 11/072,594, attorney docket no. 25791.356, filed on Mar. 4, 2005; (211) U.S. utility patent application Ser. No. 11/074,366, attorney docket no. 25791.357, filed on Mar. 7, 2005; (212) U.S. utility patent application Ser. No. 11/074,266, attorney docket no. 25791.358, filed on Mar. 7, 2005, (213) U.S. provisional patent application Ser. No. 60/832,909, attorney docket no. 25791.407, filed on Jul. 24, 2006, (214) U.S. utility patent application Ser. No. 11/536,302, attorney docket no. 25791.412, filed Sep. 28, 2006, and (215) U.S. utility patent application Ser. No. 11/538,228, attorney docket no. 25791.156, filed Oct. 3, 2006.

### BACKGROUND

This invention relates generally to oil and gas exploration, and in particular to the expandable tubular members used to facilitate oil and gas exploration.

Conventionally, when a wellbore is created, a number of expandable tubular members are installed in the borehole to prevent collapse of the borehole wall and to prevent undesired outflow of drilling fluid into the formation or inflow of fluid from the formation into the borehole. Typically, the expandable tubular members are coupled together and may be expanded against the borehole wall. The coupling together of the expandable tubular members and the expanding of the coupled together expandable tubular members can raise a number of issues relating to the seal between adjacent tubular members needed to prevent undesired outflow from or inflow to the wellbore.

The present disclosure is directed to overcoming one or more of the limitations of the existing procedures for coupling expandable tubular members together during oil and gas exploration.

### SUMMARY

According to one aspect of the present disclosure, an expandable tubular member includes a first expandable tubular member comprising a first coupling member, and a second expandable tubular member defining a second coupling channel, whereby the first expandable tubular member is operable to sealingly couple to the second expandable tubular member by deforming the first coupling member in the second coupling channel.

According to another aspect of the present disclosure, an expandable tubular member includes a first expandable tubular member comprising a coupling member and a compressible member coupled to the coupling member, and a second expandable tubular member defining a coupling channel and operable to couple to the first expandable tubular member by positioning the coupling member in the coupling channel.

According to another aspect of the present disclosure, an expandable tubular member includes a first expandable tubular member comprising a thread member which defines an deformation channel, and a second expandable tubular member defining a thread channel and operable to couple to the first expandable tubular member by deforming the thread member in the thread channel using the deformation channel.

According to another aspect of the present disclosure, an expandable tubular member includes a first expandable tubular member comprising a thread member, and a second expandable tubular member defining a thread channel and comprising a deformation member extending from the second expandable tubular member and into the thread channel, the second expandable tubular member operable to couple to the first expandable tubular member by deforming the thread member in the thread channel as a result of engagement of the deformation member with the thread member.

According to another aspect of the present disclosure, an expandable tubular member includes a first expandable tubular member, a second expandable tubular member, and deforming means for sealingly coupling the first expandable tubular member to the second expandable tubular member.

According to another aspect of the present disclosure, a method for coupling expandable tubular members includes providing a first expandable tubular member defining a first coupling channel and comprising a first coupling member, providing a second expandable tubular member defining a second coupling channel and comprising a second coupling member, and coupling the first expandable tubular member to the second expandable tubular member by deforming the first coupling member in the second coupling channel and deforming the second coupling member in the first coupling channel.

According to another aspect of the present disclosure, a method for coupling expandable tubular members includes providing a first expandable tubular member comprising a coupling member and a compressible member coupled to the coupling member, providing a second expandable tubular member defining a coupling channel, coupling the first expandable tubular member to the second expandable tubular member by positioning the coupling member in the coupling channel, and expanding the first expandable tubular member and the second expandable tubular member, whereby the expanding compresses the compressible material and sealingly engages the coupling member and the second expandable tubular member.

According to another aspect of the present disclosure, a method for coupling expandable tubular members includes providing a first expandable tubular member comprising a thread member which defines an deformation channel, providing a second expandable tubular member defining a thread channel, and coupling the second expandable tubular member to the first expandable tubular member by deforming the thread member in the thread channel using the deformation channel.

According to another aspect of the present disclosure, a method for coupling expandable tubular members includes providing a first expandable tubular member comprising a thread member, providing a second expandable tubular member defining a thread channel and comprising a deformation member extending from the second expandable tubular member and into the thread channel, and coupling the second expandable tubular member to the first expandable tubular member by deforming the thread member in the thread channel by engaging the deformation member with the thread member.

According to another aspect of the present disclosure, an expandable tubular member includes a first expandable tubular member defining a first coupling channel located adjacent an inner surface of the first expandable tubular member and comprising a first coupling member located adjacent an outer surface of the first expandable tubular member, and a second expandable tubular member defining a second coupling channel located adjacent an outer surface of the second expandable tubular member and comprising a second coupling member located adjacent an inner surface of the second expandable tubular member, whereby the first expandable tubular member is operable to sealingly couple to the second expandable tubular member and provide and gas and liquid tight metal to metal seal by positioning the first coupling member in the second coupling channel and deforming the first coupling member in the second coupling channel and positioning the second coupling member in the first coupling channel and deforming the second coupling member in the second coupling channel.

According to another aspect of the present disclosure, an expandable tubular member includes a first expandable tubular member defining a first coupling channel located adjacent an inner surface of the first expandable tubular member, comprising a first coupling member located adjacent an outer surface of the first expandable tubular member, and comprising a third coupling member located between the first coupling channel and the first coupling member, and a second expandable tubular member defining a second coupling channel located adjacent an outer surface of the second expandable tubular member, comprising a second coupling member located adjacent an inner surface of the second expandable tubular member, and comprising a third coupling channel located between the second coupling channel and the second coupling member, whereby the first expandable tubular member is operable to sealingly couple to the second expandable tubular member and provide and gas and liquid tight metal to metal seal by positioning the third coupling member in the third coupling channel and deforming the third coupling member in the third coupling channel.

According to another aspect of the present disclosure, an expandable tubular member includes a first expandable tubular member comprising a coupling member located adjacent an outer surface of the first expandable tubular member and a compressible metal ring coupled to the coupling member, and a second expandable tubular member defining a coupling channel located adjacent an outer surface of the second expandable tubular member and operable to couple to the first expandable tubular member by positioning the coupling member in the coupling channel, whereby a gas and liquid tight metal to metal seal is formed between the first expandable tubular member and the second expandable tubular member by the engagement of the coupling member and the second expandable tubular member upon the expansion of the first expandable tubular member and the second expandable tubular member and the compressing of the compressible member.

According to another aspect of the present disclosure, an expandable tubular member includes a first expandable tubular member comprising a thread member which defines a deformation channel located on a first end of the thread member, and a second expandable tubular member defining a thread channel having an approximately constant width from an entrance of the thread channel to an end of the thread channel, the thread member and the thread channel operable to provide a gas and liquid tight metal to metal seal between the first expandable tubular member and the second expandable tubular member by deforming the thread member in the thread channel using the deformation channel.

According to another aspect of the present disclosure, an expandable tubular member includes a first expandable tubular member comprising a thread member which defines a deformation channel located on a first end of the thread member, and a second expandable tubular member defining a thread channel which increases in width from an entrance of the thread channel to an end of the thread channel, the thread member and the thread channel operable to provide a gas and liquid tight metal to metal seal between the first expandable tubular member and the second expandable tubular member by deforming the thread member in the thread channel using the deformation channel.

According to another aspect of the present disclosure, an expandable tubular member includes a first expandable tubular member comprising a thread member which defines a deformation channel located on a first end of the thread member, and a second expandable tubular member defining a thread channel and comprising a deformation member extending from the second expandable tubular member and into the thread channel, the thread member and the thread channel operable to provide a gas and liquid tight metal to metal seal between the first expandable tubular member and the second expandable tubular member by deforming the thread member in the thread channel by engaging the deformation member with the deformation channel.

According to another aspect of the present disclosure, a method for coupling expandable tubular members includes providing a first expandable tubular member defining a first coupling channel and comprising a first coupling member, providing a second expandable tubular member defining a second coupling channel and comprising a second coupling member, coupling together and providing a gas and liquid tight metal to metal seal between the first expandable tubular member to the second expandable tubular member by deforming the first coupling member in the second coupling channel and deforming the second coupling member in the first coupling channel, and expanding the first expandable tubular member and the second expandable tubular member and providing a gas and liquid tight metal to metal seal between the first expandable tubular member and the second expandable tubular member.

According to another aspect of the present disclosure, a method for coupling expandable tubular members includes providing a first expandable tubular member defining a first coupling channel, comprising a first coupling member, and comprising a third coupling member, providing a second expandable tubular member defining a second coupling channel, comprising a second coupling member, and defining a third coupling channel, coupling together and providing a gas and liquid tight metal to metal seal between the first expandable tubular member to the second expandable tubular member by positioning the first coupling member in the second coupling channel, positioning the second coupling member in the first coupling channel, and deforming the third coupling member in the third coupling channel, and expanding the first expandable tubular member and the second expandable tubular member and providing a gas and liquid tight metal to metal seal between the first expandable tubular member and the second expandable tubular member.

According to another aspect of the present disclosure, a method for coupling expandable tubular members includes providing a first expandable tubular member comprising a coupling member and a compressible member coupled to the coupling member, providing a second expandable tubular member defining a coupling channel, coupling the first expandable tubular member to the second expandable tubular member by positioning the coupling member in the coupling channel, and expanding the first expandable tubular member and the second expandable tubular member, whereby the expanding compresses the compressible material and provides a gas and liquid tight metal to metal seal between the first expandable tubular member and the second expandable tubular member by the engagement of the coupling member and the second expandable tubular member.

According to another aspect of the present disclosure, a method for coupling expandable tubular members includes providing a first expandable tubular member comprising a thread member which defines a deformation channel, providing a second expandable tubular member defining a thread channel, coupling the second expandable tubular member to the first expandable tubular member by deforming the thread member in the thread channel using the deformation channel and providing a gas and liquid tight metal to metal seal between the first expandable tubular member and the second expandable tubular member, and expanding the first expandable tubular member and the second expandable tubular member and providing a gas and liquid tight metal to metal seal between the first expandable tubular member and the second expandable tubular member.

According to another aspect of the present disclosure, a method for coupling expandable tubular members includes providing a first expandable tubular member comprising a thread member which defines a deformation channel, providing a second expandable tubular member defining a thread channel and comprising a deformation member extending from the second expandable tubular member and into the thread channel, coupling the second expandable tubular member to the first expandable tubular member by deforming the thread member in the thread channel using the deformation member and the deformation channel and providing a gas and liquid tight metal to metal seal between the first expandable tubular member and the second expandable tubular member, and expanding the first expandable tubular member and the second expandable tubular member and providing a gas and liquid tight metal to metal seal between the first expandable tubular member and the second expandable tubular member.

According to another aspect of the present disclosure, a method for coupling expandable tubular members includes providing a first expandable tubular member comprising a thread member, providing a second expandable tubular member defining a thread channel and comprising a deformation member extending from the second expandable tubular member and into the thread channel, coupling the second expandable tubular member to the first expandable tubular member by deforming the thread member in the thread channel by engaging the deformation member with the thread member and providing a gas and liquid tight metal to metal seal between the first expandable tubular member and the second expandable tubular member, and expanding the first expandable tubular member and the second expandable tubular member and providing a gas and liquid tight metal to metal seal between the first expandable tubular member and the second expandable tubular member.

### BRIEF DESCRIPTION OF THE DRAWINGS

FIG. 1a is a cross sectional view illustrating an exemplary embodiment of a first expandable tubular member.

FIG. 1b is a cross sectional view illustrating an exemplary embodiment of the first expandable tubular member of FIG. 1a.

FIG. 2a is a cross sectional view illustrating an exemplary embodiment of a second expandable tubular member.

FIG. 2b is a cross sectional view illustrating an exemplary embodiment of the second expandable tubular member of FIG. 2a.

FIG. 3a is a flow chart illustrating an exemplary embodiment of a method for coupling expandable tubular members.

FIG. 3b is a cross sectional view illustrating an exemplary embodiment of the first expandable tubular member of FIG. 1b coupled to the second expandable tubular member of FIG. 2b during the method for coupling expandable tubular members of FIG. 3a.

FIG. 3c is a cross sectional view illustrating an exemplary embodiment of the first expandable tubular member and the second expandable tubular member of FIG. 3b being expanded during the method for coupling expandable tubular members of FIG. 3a.

FIG. 4a is a cross sectional view illustrating an exemplary embodiment of a first expandable tubular member.

FIG. 4b is a cross sectional view illustrating an exemplary embodiment of the first expandable tubular member of FIG. 4a.

FIG. 5a is a cross sectional view illustrating an exemplary embodiment of a second expandable tubular member.

FIG. 5b is a cross sectional view illustrating an exemplary embodiment of the second expandable tubular member of FIG. 5a.

FIG. 6a is a flow chart illustrating an exemplary embodiment of a method for coupling expandable tubular members.

FIG. 6b is a cross sectional view illustrating an exemplary embodiment of the first expandable tubular member of FIG. 4b coupled to the second expandable tubular member of FIG. 5b during the method for coupling expandable tubular members of FIG. 3a.

FIG. 6c is a cross sectional view illustrating an exemplary embodiment of the first expandable tubular member and the second expandable tubular member of FIG. 6b being expanded during the method for coupling expandable tubular members of FIG. 6a.

FIG. 7a is a cross sectional view illustrating an exemplary embodiment of a first expandable tubular member.

FIG. 7b is a cross sectional view illustrating an exemplary embodiment of the first expandable tubular member of FIG. 7a.

FIG. 8a is a cross sectional view illustrating an exemplary embodiment of a second expandable tubular member.

FIG. 8b is a cross sectional view illustrating an exemplary embodiment of the second expandable tubular member of FIG. 8a.

FIG. 9a is a flow chart illustrating an exemplary embodiment of a method for coupling expandable tubular members.

FIG. 9b is a cross sectional view illustrating an exemplary embodiment of the first expandable tubular member of FIG. 7b coupled to the second expandable tubular member of FIG. 8b during the method for coupling expandable tubular members of FIG. 9a.

FIG. 9c is a cross sectional view illustrating an exemplary embodiment of the first expandable tubular member and the second expandable tubular member of FIG. 9b being expanded during the method for coupling expandable tubular members of FIG. 9a.

FIG. 10a is a cross sectional view illustrating an exemplary embodiment of a first expandable tubular member.

FIG. 10b is a cross sectional view illustrating an exemplary embodiment of the first expandable tubular member of FIG. 10a.

FIG. 11a is a cross sectional view illustrating an exemplary embodiment of a second expandable tubular member.

FIG. 11b is a cross sectional view illustrating an exemplary embodiment of the second expandable tubular member of FIG. 11a.

FIG. 12a is a flow chart illustrating an exemplary embodiment of a method for coupling expandable tubular members.

FIG. 12b is a cross sectional view illustrating an exemplary embodiment of the first expandable tubular member of FIG. 10b coupled to the second expandable tubular member of FIG. 11b during the method for coupling expandable tubular members of FIG. 12a.

FIG. 12c is a cross sectional view illustrating an exemplary embodiment of the first expandable tubular member and the second expandable tubular member of FIG. 12b being expanded during the method for coupling expandable tubular members of FIG. 12a.

FIG. 13a is a cross sectional view illustrating an exemplary embodiment of a first expandable tubular member.

FIG. 13b is a cross sectional view illustrating an exemplary embodiment of the first expandable tubular member of FIG. 13a.

FIG. 14a is a cross sectional view illustrating an exemplary embodiment of a second expandable tubular member.

FIG. 14b is a cross sectional view illustrating an exemplary embodiment of the second expandable tubular member of FIG. 14a.

FIG. 15a is a flow chart illustrating an exemplary embodiment of a method for coupling expandable tubular members.

FIG. 15b is a cross sectional view illustrating an exemplary embodiment of the first expandable tubular member of FIG. 13b coupled to the second expandable tubular member of FIG. 14b during the method for coupling expandable tubular members of FIG. 15a.

FIG. 15c is a cross sectional view illustrating an exemplary embodiment of the first expandable tubular member and the second expandable tubular member of FIG. 15b being expanded during the method for coupling expandable tubular members of FIG. 15a.

FIG. 15d is a cross sectional view illustrating an exemplary embodiment of the first expandable tubular member and the second expandable tubular member of FIG. 15b expanded after the method for coupling expandable tubular members of FIG. 15a.

FIG. 16a is a cross sectional view illustrating an exemplary embodiment of a first expandable tubular member.

FIG. 16b is a cross sectional view illustrating an exemplary embodiment of the first expandable tubular member of FIG. 16a.

FIG. 17a is a cross sectional view illustrating an exemplary embodiment of a second expandable tubular member.

FIG. 17b is a cross sectional view illustrating an exemplary embodiment of the second expandable tubular member of FIG. 2a.

FIG. 18a is a flow chart illustrating an exemplary embodiment of a method for coupling expandable tubular members.

FIG. 18b is a cross sectional view illustrating an exemplary embodiment of the first expandable tubular member of FIG. 16b coupled to the second expandable tubular member of FIG. 17b during the method for coupling expandable tubular members of FIG. 18a.

FIG. 18c is a cross sectional view illustrating an exemplary embodiment of the first expandable tubular member and the second expandable tubular member of FIG. 18b being expanded during the method for coupling expandable tubular members of FIG. 18a.

FIG. 19a is a cross sectional view illustrating an exemplary embodiment of a first expandable tubular member.

FIG. 19b is a cross sectional view illustrating an exemplary embodiment of the first expandable tubular member of FIG. 19a.

FIG. 20a is a cross sectional view illustrating an exemplary embodiment of a second expandable tubular member.

FIG. 20b is a cross sectional view illustrating an exemplary embodiment of the second expandable tubular member of FIG. 20a.

FIG. 21a is a flow chart illustrating an exemplary embodiment of a method for coupling expandable tubular members.

FIG. 21b is a cross sectional view illustrating an exemplary embodiment of the first expandable tubular member of FIG. 19b coupled to the second expandable tubular member of FIG. 20b during the method for coupling expandable tubular members of FIG. 21a.

FIG. 21c is a cross sectional view illustrating an exemplary embodiment of the first expandable tubular member and the second expandable tubular member of FIG. 21b being expanded during the method for coupling expandable tubular members of FIG. 21a.

FIG. 22a is a cross sectional view illustrating an exemplary embodiment of a first expandable tubular member.

FIG. 22b is a cross sectional view illustrating an exemplary embodiment of the first expandable tubular member of FIG. 22a.

FIG. 23a is a cross sectional view illustrating an exemplary embodiment of a second expandable tubular member.

FIG. 23b is a cross sectional view illustrating an exemplary embodiment of the second expandable tubular member of FIG. 23a.

FIG. 24a is a flow chart illustrating an exemplary embodiment of a method for coupling expandable tubular members.

FIG. 24b is a cross sectional view illustrating an exemplary embodiment of the first expandable tubular member of FIG. 22b coupled to the second expandable tubular member of FIG. 23b during the method for coupling expandable tubular members of FIG. 24a.

FIG. 24c is a cross sectional view illustrating an exemplary embodiment of the first expandable tubular member and the second expandable tubular member of FIG. 24b being expanded during the method for coupling expandable tubular members of FIG. 24a.

FIG. 25a is a cross sectional view illustrating an exemplary embodiment of a first expandable tubular member.

FIG. 25b is a cross sectional view illustrating an exemplary embodiment of the first expandable tubular member of FIG. 25a.

FIG. 26a is a cross sectional view illustrating an exemplary embodiment of a second expandable tubular member.

FIG. 26b is a cross sectional view illustrating an exemplary embodiment of the second expandable tubular member of FIG. 26a.

FIG. 27a is a flow chart illustrating an exemplary embodiment of a method for coupling expandable tubular members.

FIG. 27b is a cross sectional view illustrating an exemplary embodiment of the first expandable tubular member of FIG. 25b coupled to the second expandable tubular member of FIG. 26b during the method for coupling expandable tubular members of FIG. 27a.

FIG. 27c is a cross sectional view illustrating an exemplary embodiment of the first expandable tubular member and the second expandable tubular member of FIG. 27b being expanded during the method for coupling expandable tubular members of FIG. 27a.

FIG. 28 is a graph illustrating an exemplary experimental embodiment of the expansion of the first tubular member and the second tubular member of FIGS. 16a, 16b, 17a, 17b, 18a, 18b, and 18c.

### DETAILED DESCRIPTION OF THE ILLUSTRATIVE EMBODIMENTS

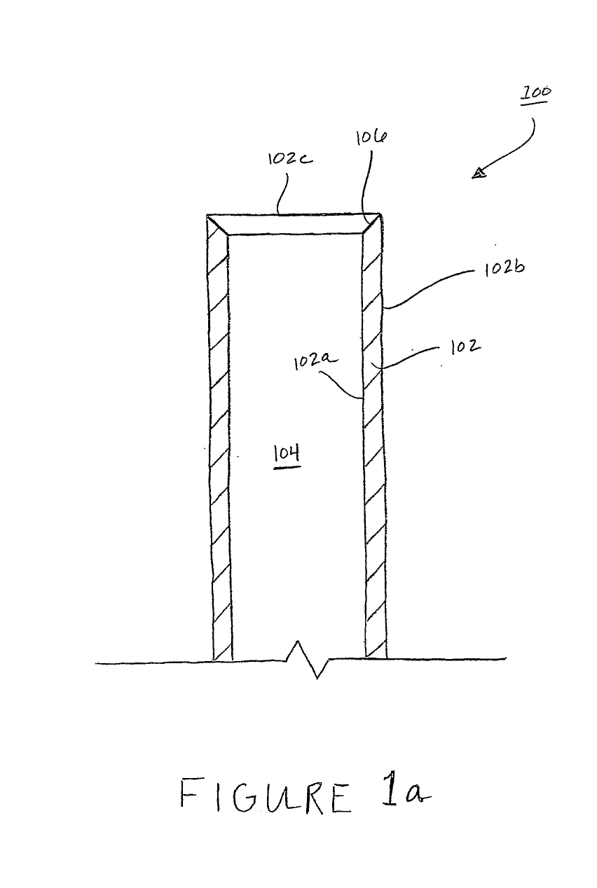

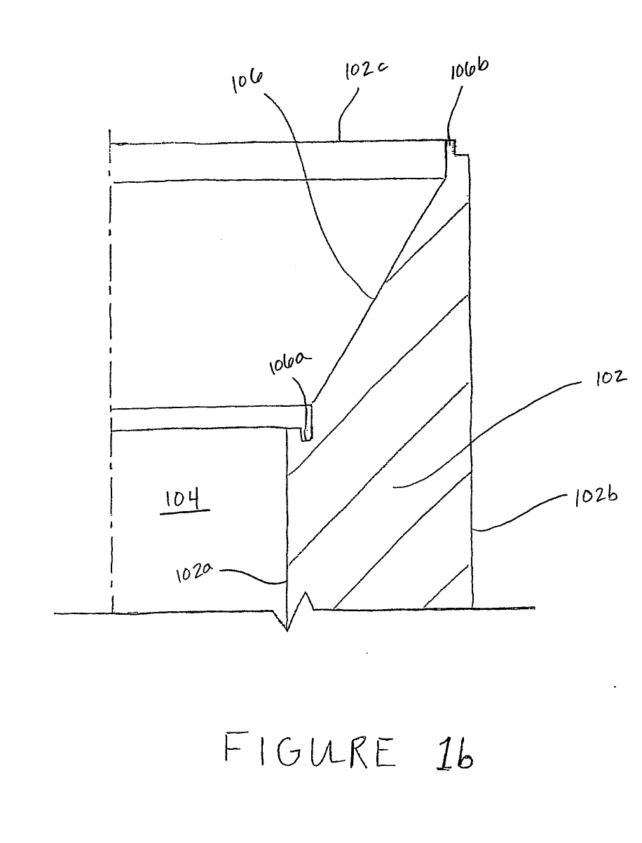

Referring now to FIGS. 1a and 1b, a first expandable tubular member 100 is illustrated. The first expandable tubular member 100 includes a wall 102 having an inner surface 102a, an outer surface 102b located opposite the inner surface 102a, and defining a passageway 104 along the length of the first expandable tubular member 100. A coupling edge 106 is located on a distal end 102c of the first expandable tubular member 100 and extends between the inner surface 102a and the outer surface 102b at an angle with respect to the inner surface 102a and the outer surface 102b. The coupling edge 106 and the wall 102 define a first coupling channel 106a which is substantially parallel with the inner surface 102a and outer surface 102b and is located adjacent the inner surface 102a of the first expandable tubular member 100. A first coupling member 106b extends from the coupling edge 106 on the first expandable tubular member 100 and is substantially parallel with the inner surface 102a and outer surface 102b and located adjacent the outer surface 102b of the first expandable tubular member 100. In an exemplary embodiment, the first expandable tubular member 100 is fabricated from a metallic material.

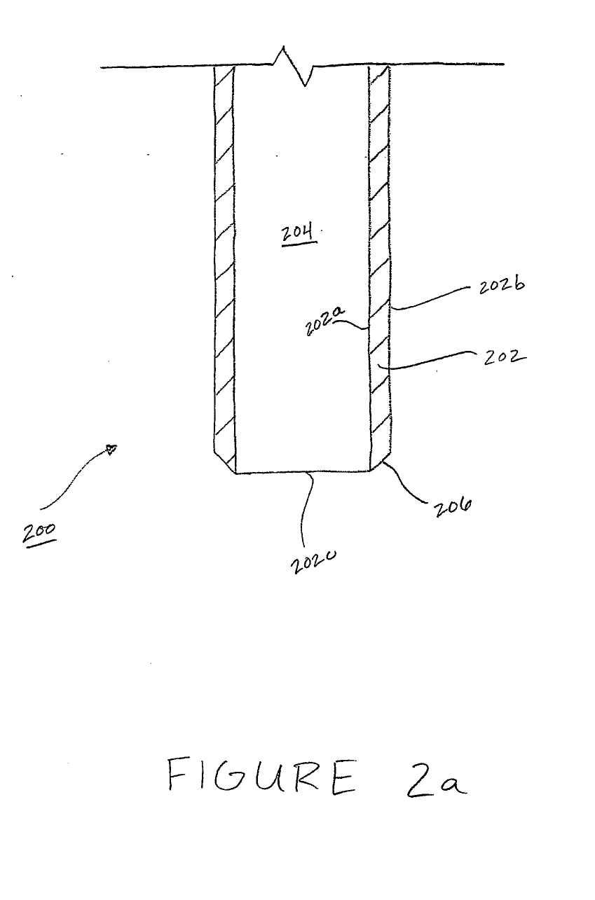

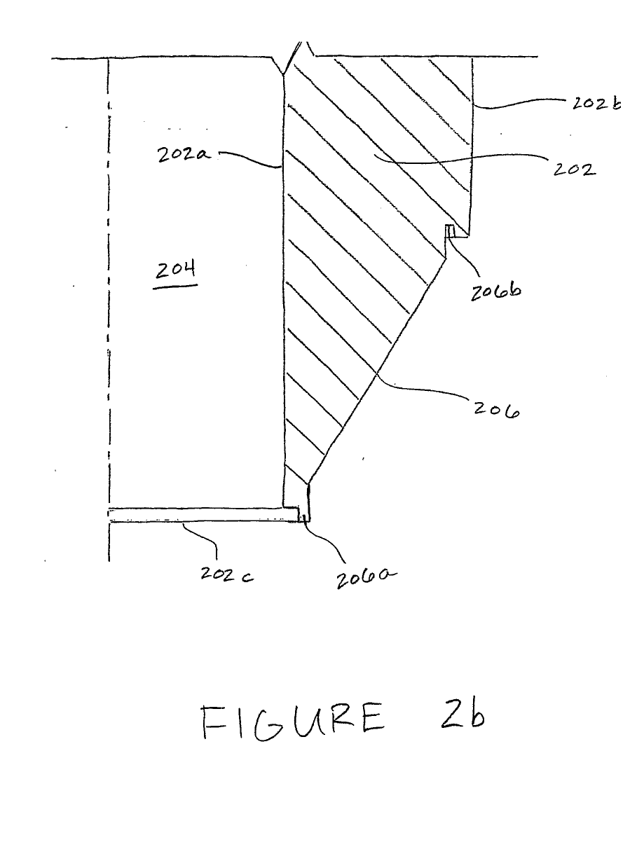

Referring now to FIGS. 2a and 2b, a second expandable tubular member 200 is illustrated. The second expandable tubular member 200 includes a wall 202 having an inner surface 202a, an outer surface 202b located opposite the inner surface 202a, and defining a passageway 204 along the length of the second expandable tubular member 200. A coupling edge 206 is located on a distal end 202c of the first expandable tubular member 200 and extends between the inner surface 202a and the outer surface 202b at an angle with respect to the inner surface 202a and the outer surface 202b. A second coupling member 206a extends from the coupling edge 206 on the second expandable tubular member 200 and is substantially parallel with the inner surface 202a and the outer surface 202b and located adjacent the inner surface 202a of the second expandable tubular member 200. The coupling edge 206 and the wall 202 define a second coupling channel 206b which is substantially parallel with the inner surface 202a and the outer surface 202b and is located adjacent the outer surface 202b of the second expandable tubular member 200. In an exemplary embodiment, the second expandable tubular member 200 is fabricated from a metallic material.

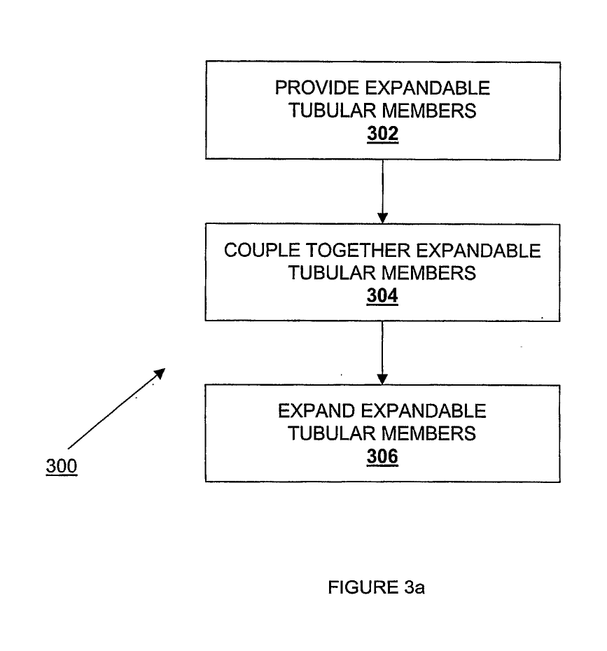

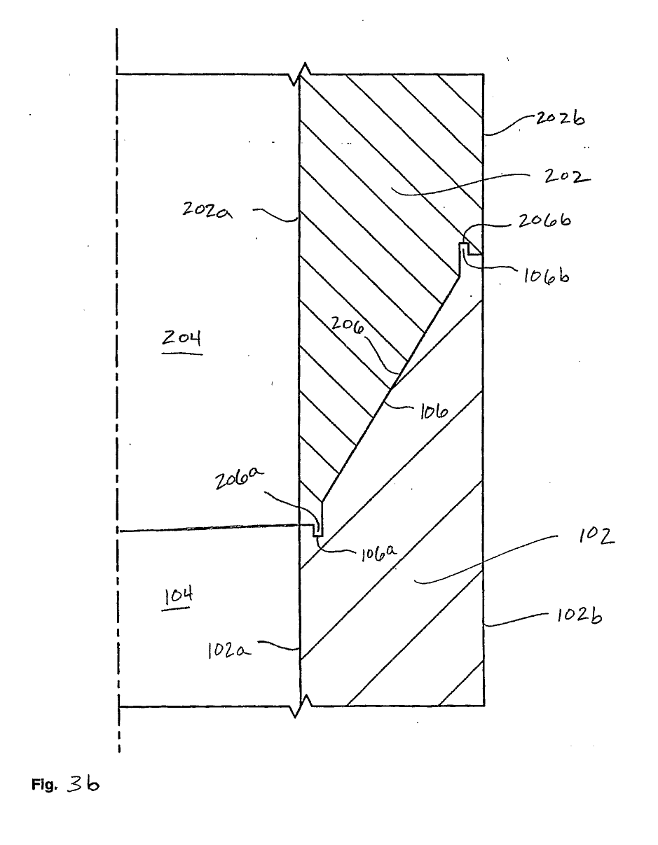

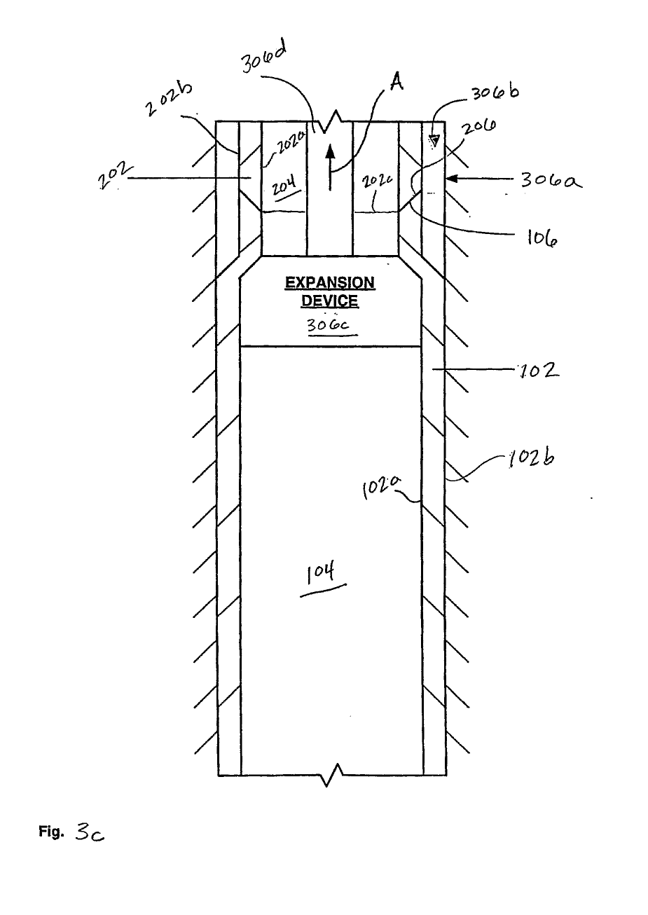

Referring now to FIGS. 1a, 2a, 3a, and 3b, a method 300 for coupling expandable tubular members is illustrated. The method 300 begins at step 302 where the first expandable tubular member 100 and the second expandable tubular member 200 are provided. The method 300 then proceeds to step 304 where the first expandable tubular member 100 and the second expandable tubular member 200 are coupled together. The first expandable tubular member 100 and the second expandable tubular member 200 are positioned such that the distal end 102c on the first expandable tubular member 100 is adjacent the distal end 202c on the second expandable tubular member 200. The first coupling member 106b on the first expandable tubular member 100 is then positioned in the second coupling channel 206b on the second expandable tubular member 200, and the second coupling member 206a on the second expandable tubular member 200 is positioned in the first coupling channel 106a on the first expandable tubular member 100. With the first coupling member 106b positioned in the second coupling channel 206b and the second coupling member 206a positioned in the first coupling channel 106a, the coupling edge 106 on the first expandable tubular member 100 engages the coupling edge 206 on the second expandable tubular member 200 and the passageway 104 on first expandable tubular member 100 is substantially co-axial with the passageway 204 on the second expandable tubular member 200. In an exemplary embodiment, the volume of material in the first coupling member 106b is greater than the volume of the second coupling channel 206b, and the volume of material in the second coupling member 206a is greater than the volume of the first coupling channel 106a, and as a result the first coupling member 106b and the second coupling member 206a are deformed in the second coupling channel 206b and the first coupling channel 106a, respectively, providing an interference fit upon engaging the first expandable tubular member 100 and the second tubular member 200 which creates localized stresses between the first expandable tubular member 100 and the second tubular member 200, thereby coupling them together. In an exemplary embodiment, the coupling of the first expandable tubular member 100 to the second expandable tubular member 200 provides an air and liquid tight seal between the first expandable tubular member 100 and the second expandable tubular member 200. In an exemplary embodiment, the coupling of the first expandable tubular member 100 to the second expandable tubular member 200 provides a metal to metal seal between the first expandable tubular member 100 and the second expandable tubular member 200. In an exemplary embodiment, the coupling of the first expandable tubular member 100 and the second expandable tubular member 200 may include methods such as, for example, threading, welding, brazing, or a variety of other coupling methods known in the art.

Referring now to FIGS. 1a, 2a, 3a, 3b, and 3c, the method 300 proceeds to step 306 wherein the first expandable tubular member 100 and the second expandable tubular member 200 are expanded. A wellbore 306a is provided which defines a passageway 306b along its length. The coupled-together first expandable tubular member 100 and second expandable tubular member 200 are positioned in the passageway 306b of the wellbore 306a. An expansion device 306c, which may be a conventional expansion device known in the art, is provided which is coupled to a drill string 306d and which includes a larger diameter than the inside diameter of the first expandable tubular member 100 and the second expandable tubular member 200. The expansion device 306c is positioned in the passageway 104 on the first expandable tubular member 100 and in engagement with the inner surface 102a of the first expandable tubular member 100, which results in the expansion of the first expandable tubular member 100. The expansion device 306c may then be moved in a direction A such that the first expandable tubular member 100 and the second expandable tubular member 200 are expanded into engagement with the wellbore 306a. Upon expansion of the first expandable tubular member 100 and the second expandable tubular member 200, the first coupling member 106b on the first expandable tubular member 100 deforms but remains positioned in the second coupling channel 206b on the second expandable tubular member 200 and the second coupling member 206a on the second expandable tubular member 200 deforms but remains positioned in the first coupling channel 106a on the first expandable tubular member 100. In an exemplary embodiment, the positioning of the first coupling member 106b in the second coupling channel 206b and the positioning of the second coupling member 206a in the first coupling channel 106a provides an air and liquid tight seal between the first expandable tubular member 100 and the second expandable tubular member 200 after expansion. In an exemplary embodiment, the positioning of the first coupling member 106b in the second coupling channel 206b and the positioning of the second coupling member 206a in the first coupling channel 106a provides a metal to metal seal between the first expandable tubular member 100 and the second expandable tubular member 200 after expansion.

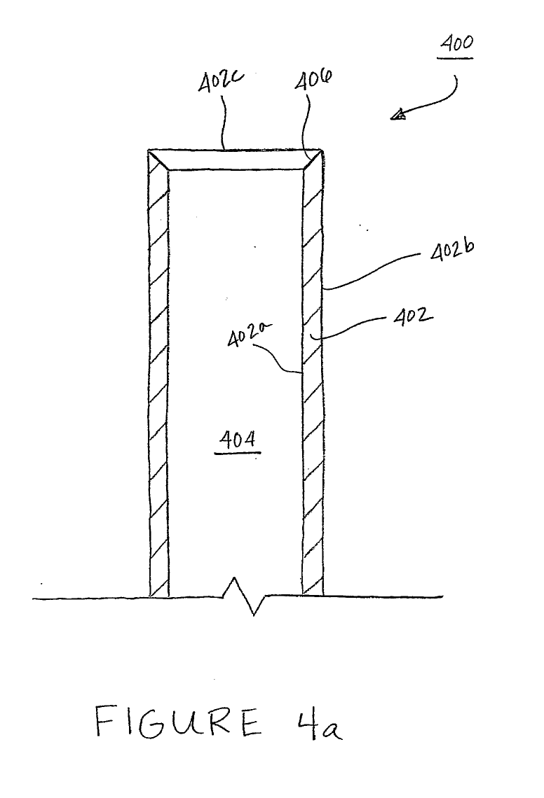

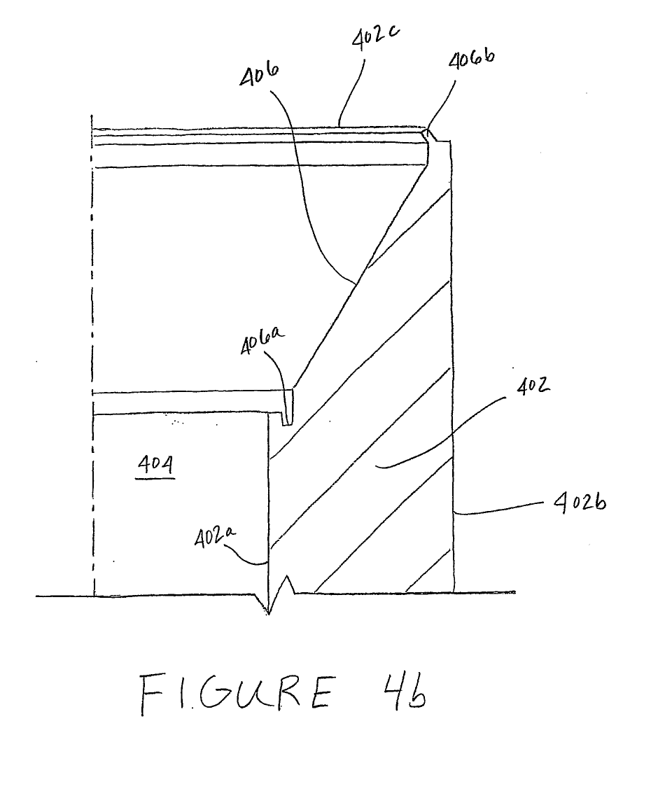

Referring now to FIGS. 4a and 4b, a first expandable tubular member 400 is illustrated. The first expandable tubular member 400 includes a wall 402 having an inner surface 402a, an outer surface 402b located opposite the inner surface 402a, and defining a passageway 404 along the length of the first expandable tubular member 400. A coupling edge 406 is located on a distal end 402c of the first expandable tubular member 400 and extends between the inner surface 402a and the outer surface 402b at an angle with respect to the inner surface 402a and the outer surface 402b. The coupling edge 406 and the wall 402 define a first coupling channel 406a which is substantially parallel with the inner surface 402a and the outer surface 402b and is located adjacent the inner surface 402a of the first expandable tubular member 400. A first coupling member 406b extends from the coupling edge 406 on the first expandable tubular member 400 at an angle with respect to the inner surface 402a and the outer surface 402b and is located adjacent the outer surface 402b of the first expandable tubular member 400. In an exemplary embodiment, the first expandable tubular member 400 is fabricated from a metallic material.

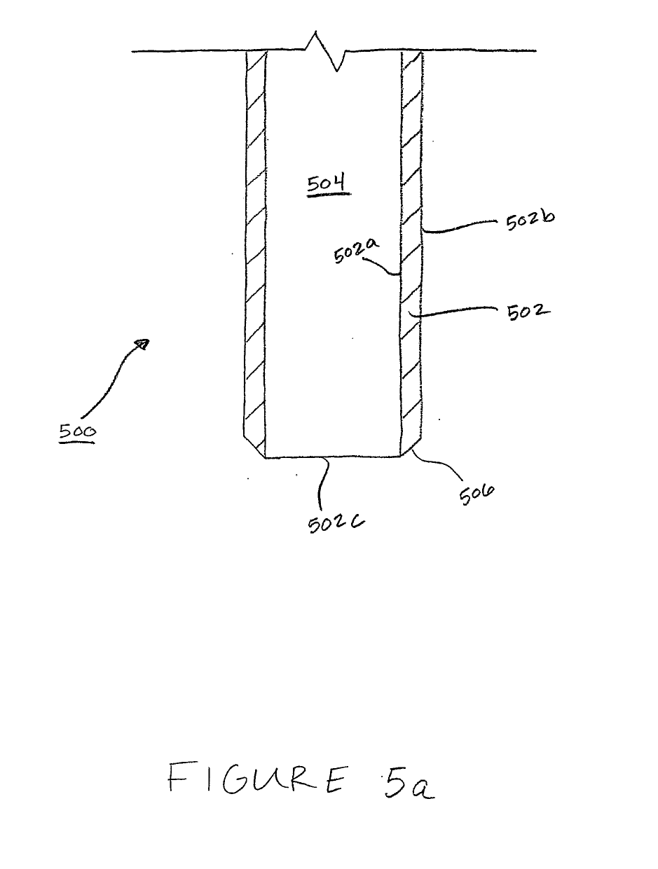

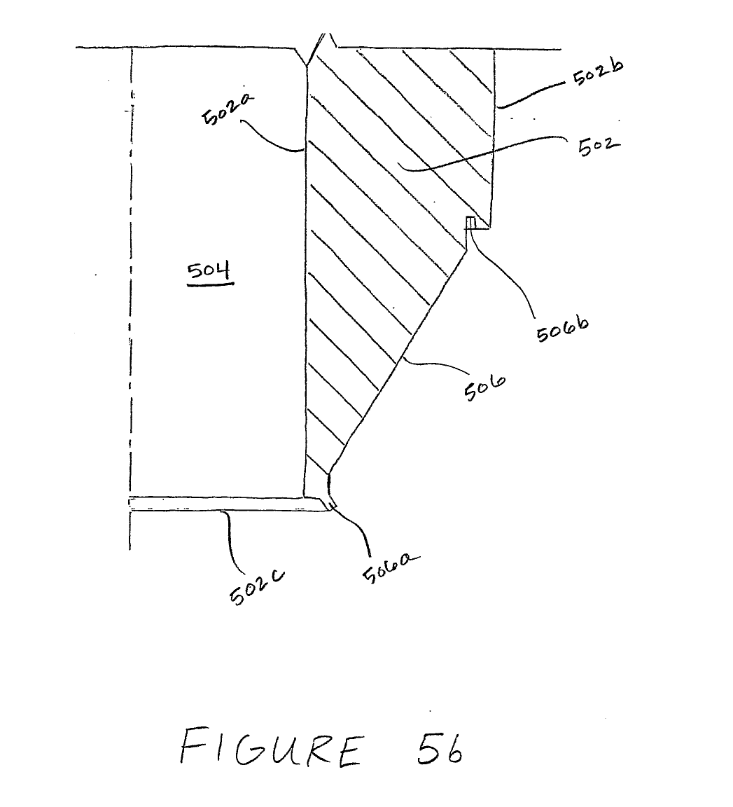

Referring now to FIGS. 5a and 5b, a second expandable tubular member 500 is illustrated. The second expandable tubular member 500 includes a wall 502 having an inner surface 502a, an outer surface 502b located opposite the inner surface 502a, and defining a passageway 504 along the length of the second expandable tubular member 500. A coupling edge 506 is located on a distal end 502c of the first expandable tubular member 500 and extends between the inner surface 502a and the outer surface 502b at an angle with respect to the inner surface 502a and the outer surface 502b. A second coupling member 506a extends from the coupling edge 506 on the second expandable tubular member 500 at an angle with respect to the inner surface 502a and the outer surface 502b and is located adjacent the inner surface 502a of the second expandable tubular member 500. The coupling edge 506 and the wall 502 define a second coupling channel 506b which is substantially parallel with the inner surface 502a and the outer surface 502b and is located adjacent the outer surface 502b of the second expandable tubular member 500. In an exemplary embodiment, the second expandable tubular member 500 is fabricated from a metallic material.

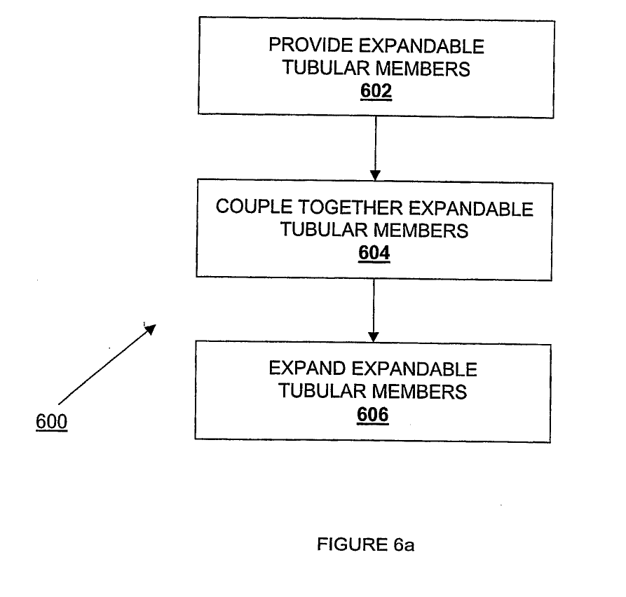

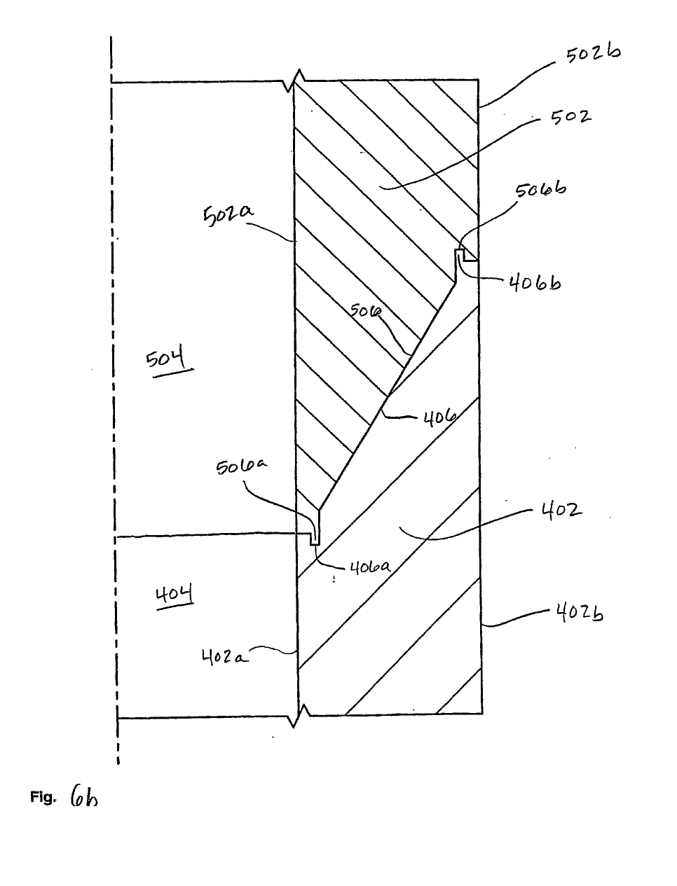

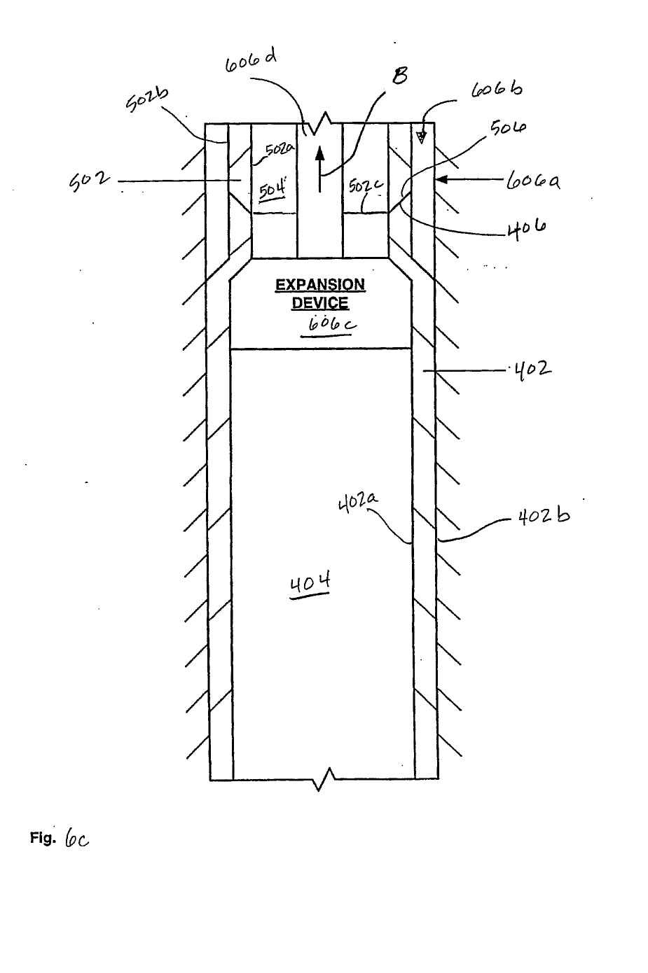

Referring now to FIGS. 4a, 5a, 6a, and 6b, a method 600 for coupling expandable tubular members is illustrated. The method 600 begins at step 602 where the first expandable tubular member 400 and the second expandable tubular member 500 are provided. The method 600 then proceeds to step 604 where the first expandable tubular member 400 and the second expandable tubular member 500 are coupled together. The first expandable tubular member 400 and the second expandable tubular member 500 are positioned such that the distal end 402c on the first expandable tubular member 400 is adjacent the distal end 502c on the second expandable tubular member 500. The first coupling member 406b on the first expandable tubular member 400 is then positioned in the second coupling channel 506b on the second expandable tubular member 500 by deforming the first coupling member 406b into the second coupling channel 506b, and the second coupling member 506a on the second expandable tubular member 500 is positioned in the first coupling channel 406a on the first expandable tubular member 400 by deforming the second coupling member 506a into the first coupling channel 406a, as illustrated in FIGS. 4b, 5b, and 6b. With the first coupling member 406b positioned in the second coupling channel 506b and the second coupling member 506a positioned in the first coupling channel 406a, the coupling edge 406 on the first expandable tubular member 400 engages the coupling edge 506 on the second expandable tubular member 500 and the passageway 404 on first expandable tubular member 400 is substantially co-axial with the passageway 504 on the second expandable tubular member 500. In an exemplary embodiment, the volume of material in the first coupling member 406b is greater than the volume of the second coupling channel 506b, and the volume of material in the second coupling member 506a is greater than the volume of the first coupling channel 406a, and as a result the first coupling member 406b and the second coupling member 506a are deformed in the second coupling channel 506b and the first coupling channel 406a, respectively, providing an interference fit upon engaging the first expandable tubular member 400 and the second tubular member 500 which creates localized stresses between the first expandable tubular member 400 and the second tubular member 500, thereby coupling them together. In an exemplary embodiment, the coupling of the first expandable tubular member 400 to the second expandable tubular member 500 provides an air and liquid tight seal between the first expandable tubular member 400 and the second expandable tubular member 500. In an exemplary embodiment, the coupling of the first expandable tubular member 400 to the second expandable tubular member 500 provides a metal to metal seal between the first coupling member 406b and the second expandable tubular member 500 and between the second coupling member 506a and the first expandable tubular member 400. In an exemplary embodiment, the coupling of the first expandable tubular member 400 and the second expandable tubular member 500 may include methods such as, for example, threading, welding, brazing, or a variety of other coupling methods known in the art.

Referring now to FIGS. 4a, 5a, 6a, 6b, and 6c, the method 600 proceeds to step 606 wherein the first expandable tubular member 400 and the second expandable tubular member 500 are expanded. A wellbore 606a is provided which defines a passageway 606b along its length. The coupled-together first expandable tubular member 400 and second expandable tubular member 500 are positioned in the passageway 606b of the wellbore 606a. An expansion device 606c, which may be a conventional expansion device known in the art, is provided which is coupled to a drill string 606d and which includes a larger diameter than the inside diameter of the first expandable tubular member 400 and the second expandable tubular member 500. The expansion device 606c is positioned in the passageway 404 on the first expandable tubular member 400 and in engagement with the inner surface 402a of the first expandable tubular member 400, which results in the expansion of the first expandable tubular member 400. The expansion device 606c may then be moved in a direction B such that the first expandable tubular member 400 and the second expandable tubular member 500 are expanded into engagement with the wellbore 606a. Upon expansion of the first expandable tubular member 400 and the second expandable tubular member 500, the first coupling member 406b on the first expandable tubular member 400 deforms but remains positioned in the second coupling channel 506b on the second expandable tubular member 500 and the second coupling member 506a on the second expandable tubular member 500 deforms but remains positioned in the first coupling channel 406a on the first expandable tubular member 400. In an exemplary embodiment, the positioning of the first coupling member 406b in the second coupling channel 506b and the positioning of the second coupling member 506a in the first coupling channel 406a provides an air and liquid tight seal between the first expandable tubular member 400 and the second expandable tubular member 500 after expansion. In an exemplary embodiment, the positioning of the first coupling member 406b in the second coupling channel 506b and the positioning of the second coupling member 506a in the first coupling channel 406a provides a metal to metal seal between the first coupling member 406b and the second expandable tubular member 500 and between the second coupling member 506b and the first expandable tubular member 400 after expansion.

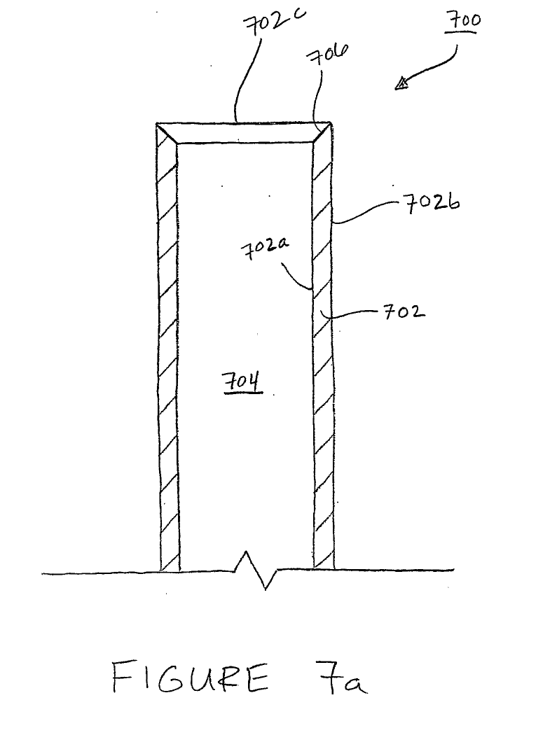

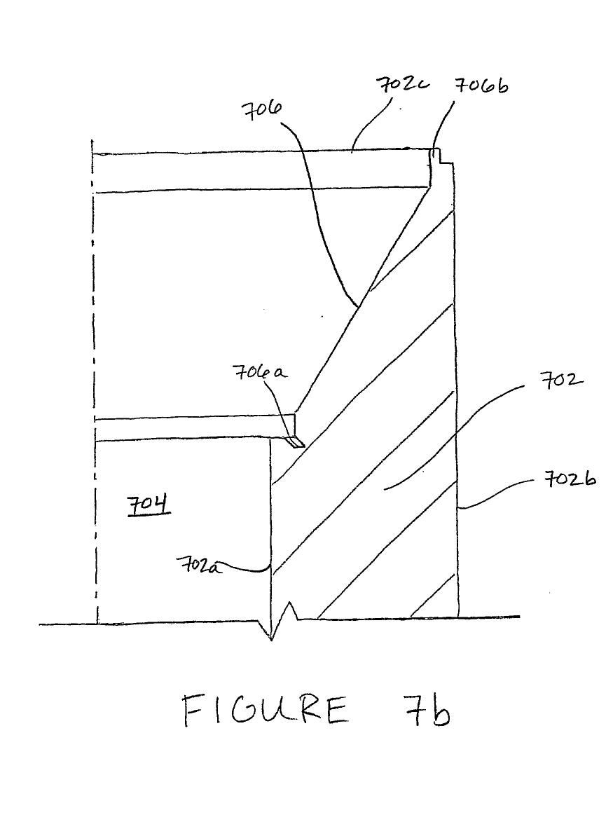

Referring now to FIGS. 7a and 7b, a first expandable tubular member 700 is illustrated. The first expandable tubular member 700 includes a wall 702 having an inner surface 702a, an outer surface 702b located opposite the inner surface 702a, and defining a passageway 704 along the length of the first expandable tubular member 700. A coupling edge 706 is located on a distal end 702c of the first expandable tubular member 700 and extends between the inner surface 702a and the outer surface 702b at an angle with respect to the inner surface 702a and the outer surface 702b. The coupling edge 706 and the wall 702 define a first coupling channel 706a which is oriented at an angle with respect to the inner surface 702a and the outer surface 702b and located adjacent the inner surface 702a of the first expandable tubular member 700. A first coupling member 706b extends from the coupling edge 706 on the first expandable tubular member 700 and and is substantially parallel with the inner surface 702a and the outer surface 702b and located adjacent the outer surface 702b of the first expandable tubular member 700. In an exemplary embodiment, the first expandable tubular member 700 is fabricated from a metallic material.

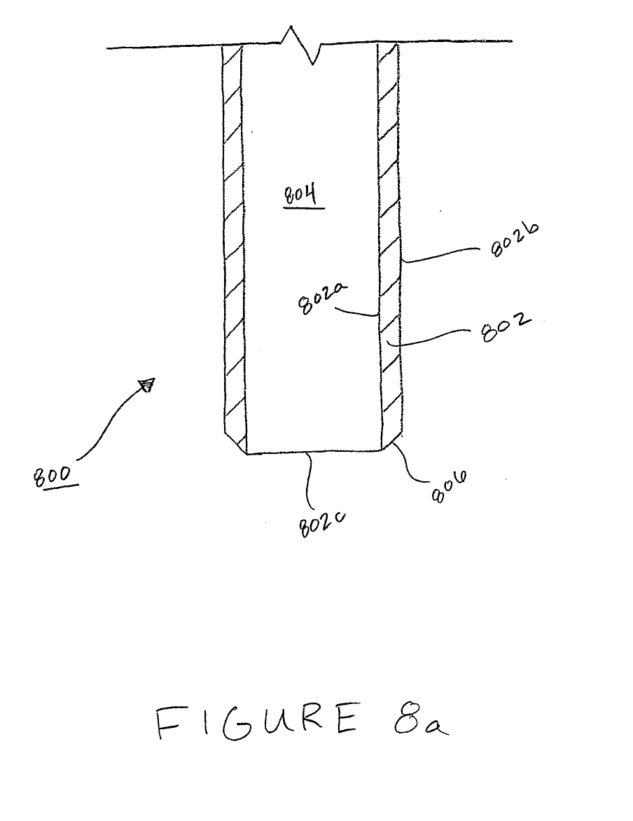

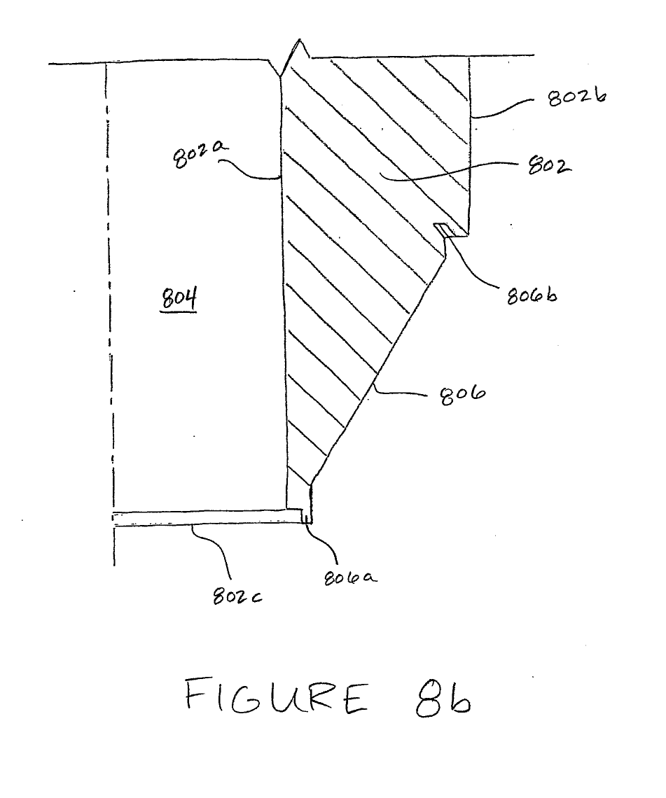

Referring now to FIGS. 8a and 8b, a second expandable tubular member 800 is illustrated. The second expandable tubular member 800 includes a wall 802 having an inner surface 802a, an outer surface 802b located opposite the inner surface 802a, and defining a passageway 804 along the length of the second expandable tubular member 800. A coupling edge 806 is located on a distal end 802c of the first expandable tubular member 800 and extends between the inner surface 802a and the outer surface 802b at an angle with respect to the inner surface 802a and the outer surface 802b. A second coupling member 806a extends from the coupling edge 806 on the second expandable tubular member 800 and is substantially parallel with the inner surface 802a and the outer surface 802b and located adjacent the inner surface 802a of the second expandable tubular member 800. The coupling edge 806 and the wall 802 define a second coupling channel 806b which is oriented at an angle with respect to the inner surface 802a and the outer surface 802b and located adjacent the outer surface 802b of the second expandable tubular member 800. In an exemplary embodiment, the second expandable tubular member 800 is fabricated from a metallic material.

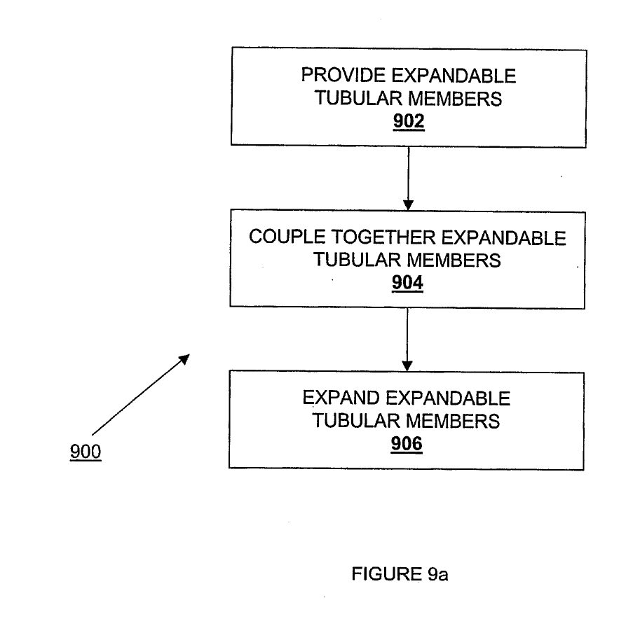

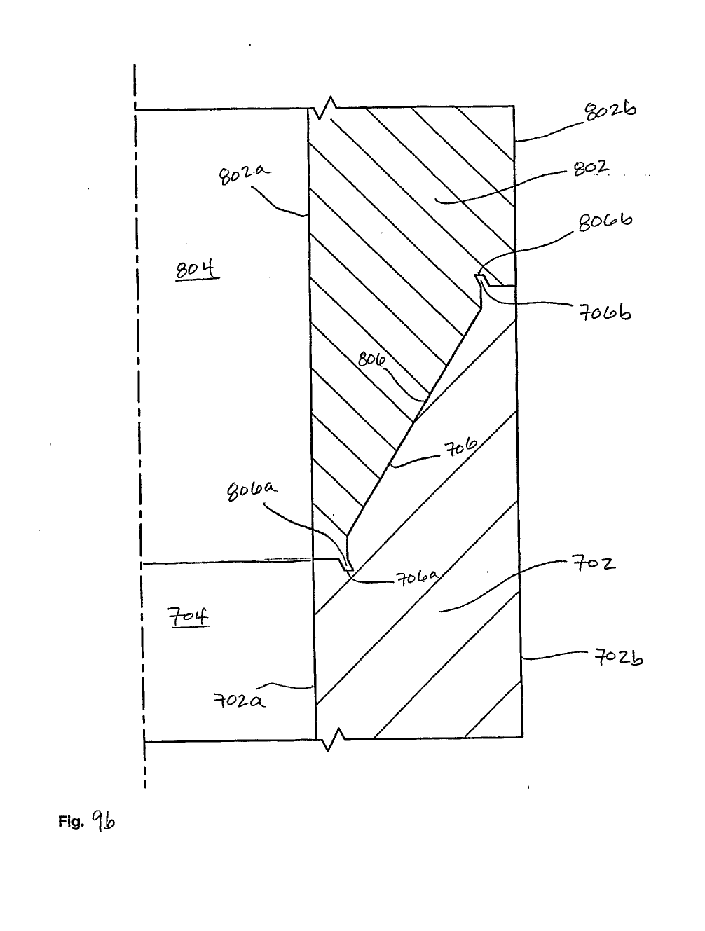

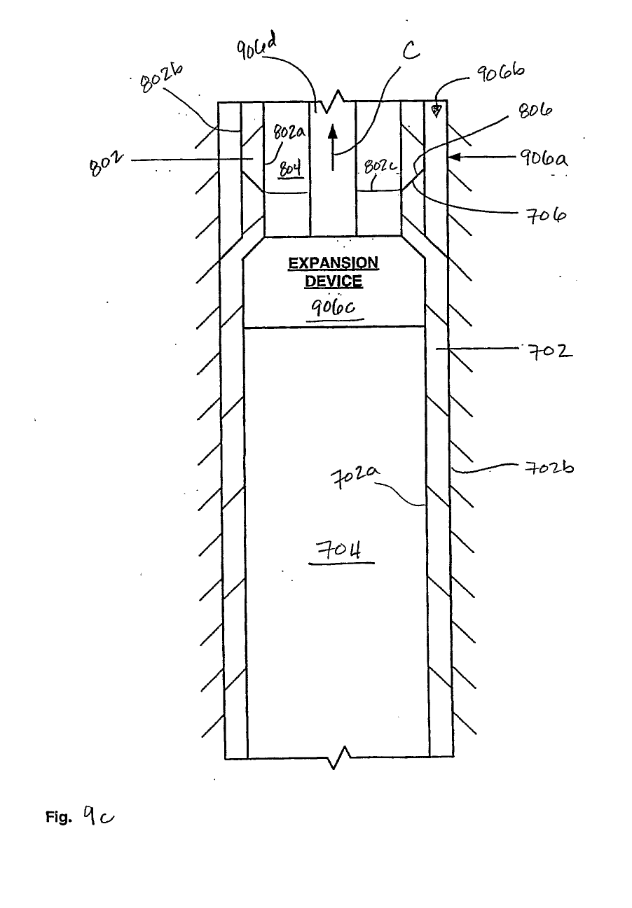

Referring now to FIGS. 7a, 8a, 9a, and 9b, a method 900 for coupling expandable tubular members is illustrated. The method 900 begins at step 902 where the first expandable tubular member 700 and the second expandable tubular member 800 are provided. The method 900 then proceeds to step 904 where the first expandable tubular member 700 and the second expandable tubular member 800 are coupled together. The first expandable tubular member 700 and the second expandable tubular member 800 are positioned such that the distal end 702c on the first expandable tubular member 700 is adjacent the distal end 802c on the second expandable tubular member 800. The first coupling member 706b on the first expandable tubular member 700 is then positioned in the second coupling channel 806b on the second expandable tubular member 800 by deforming the first coupling member 706b into the second coupling channel 806b, and the second coupling member 806a on the second expandable tubular member 800 is positioned in the first coupling channel 706a on the first expandable tubular member 700 by deforming the second coupling member 806a into the first coupling channel 706a, as illustrated in FIGS. 7b, 8b, and 9b. With the first coupling member 706b positioned in the second coupling channel 806b and the second coupling member 806a positioned in the first coupling channel 706a, the coupling edge 706 on the first expandable tubular member 700 engages the coupling edge 806 on the second expandable tubular member 800 and the passageway 704 on first expandable tubular member 700 is substantially co-axial with the passageway 804 on the second expandable tubular member 800. In an exemplary embodiment, the volume of material in the first coupling member 706b is greater than the volume of the second coupling channel 806b, and the volume of material in the second coupling member 806a is greater than the volume of the first coupling channel 706a, and as a result the first coupling member 706b and the second coupling member 806a are deformed in the second coupling channel 806b and the first coupling channel 706a, respectively, providing an interference fit upon engaging the first expandable tubular member 700 and the second tubular member 800 which creates localized stresses between the first expandable tubular member 700 and the second tubular member 800, thereby coupling them together. In an exemplary embodiment, the coupling of the first expandable tubular member 700 to the second expandable tubular member 800 provides an air and liquid tight seal between the first expandable tubular member 700 and the second expandable tubular member 800. In an exemplary embodiment, the coupling of the first expandable tubular member 700 to the second expandable tubular member 800 provides a metal to metal seal between the first coupling member 706b and the second expandable tubular member 800 and between the second coupling member 806a and the first expandable tubular member 700. In an exemplary embodiment, the coupling of the first expandable tubular member 700 and the second expandable tubular member 800 may include methods such as, for example, threading, welding, brazing, or a variety of other coupling methods known in the art.

Referring now to FIGS. 7a, 8a, 9a, 9b, and 9c, the method 900 proceeds to step 906 wherein the first expandable tubular member 700 and the second expandable tubular member 800 are expanded. A wellbore 906a is provided which defines a passageway 906b along its length. The coupled-together first expandable tubular member 700 and second expandable tubular member 800 are positioned in the passageway 906b of the wellbore 906a. An expansion device 906c, which may be a conventional expansion device known in the art, is provided which is coupled to a drill string 906d and which includes a larger diameter than the inside diameter of the first expandable tubular member 700 and the second expandable tubular member 800. The expansion device 906c is positioned in the passageway 704 on the first expandable tubular member 700 and in engagement with the inner surface 702a of the first expandable tubular member 700, which results in the expansion of the first expandable tubular member 700. The expansion device 906c may then be moved in a direction C such that the first expandable tubular member 700 and the second expandable tubular member 800 are expanded into engagement with the wellbore 906a. Upon expansion of the first expandable tubular member 700 and the second expandable tubular member 800, the first coupling member 706b on the first expandable tubular member 700 deforms but remains positioned in the second coupling channel 806b on the second expandable tubular member 800 and the second coupling member 806a on the second expandable tubular member 800 deforms but remains positioned in the first coupling channel 706a on the first expandable tubular member 700. In an exemplary embodiment, the positioning of the first coupling member 706b in the second coupling channel 706b and the positioning of the second coupling member 806a in the first coupling channel 706a provides an air and liquid tight seal between the first expandable tubular member 700 and the second expandable tubular member 800 after expansion. In an exemplary embodiment, the positioning of the first coupling member 706b in the second coupling channel 806b and the positioning of the second coupling member 806a in the first coupling channel 706a provides a metal to metal seal between the first coupling member 706b and the second expandable tubular member 800 and between the second coupling member 806b and the first expandable tubular member 700 after expansion.

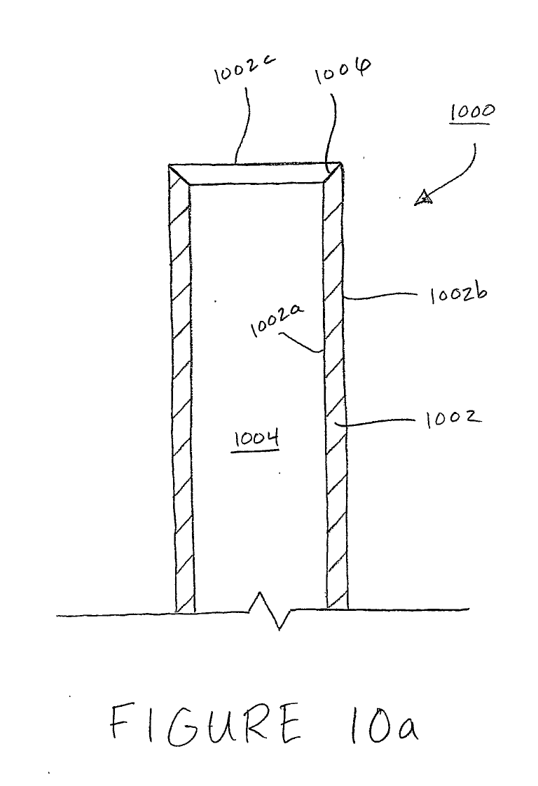

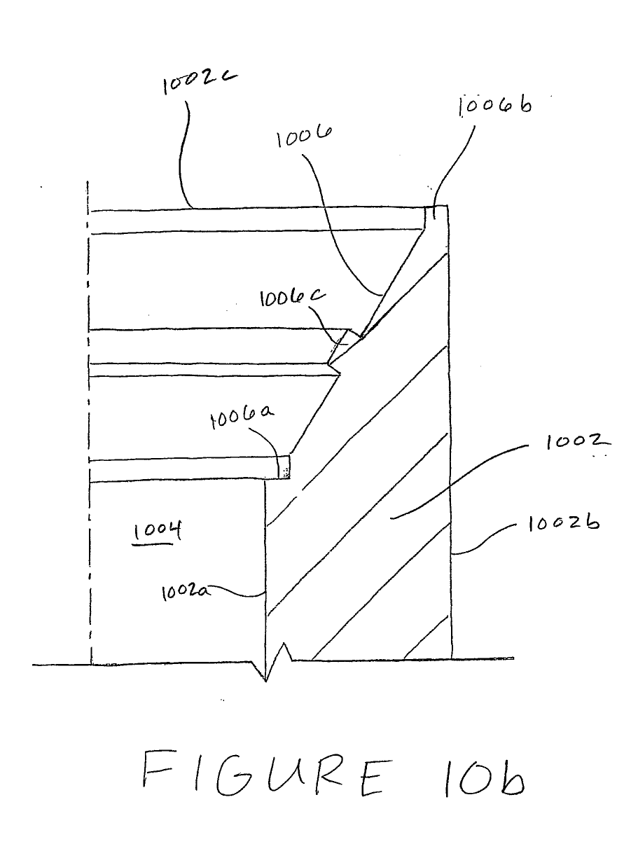

Referring now to FIGS. 10a and 10b, a first expandable tubular member 1000 is illustrated. The first expandable tubular member 1000 includes a wall 1002 having an inner surface 1002a, an outer surface 1002b located opposite the inner surface 1002a, and defining a passageway 1004 along the length of the first expandable tubular member 1000. A coupling edge 1006 is located on a distal end 1002c of the first expandable tubular member 1000 and extends between the inner surface 1002a and the outer surface 1002b at an angle with respect to the inner surface 1002a and the outer surface 1002b. The coupling edge 1006 and the wall 1002 define a first coupling channel 1006a which is located adjacent the inner surface 1002a of the first expandable tubular member 1000. A first coupling member 1006b extends from the coupling edge 1006 on the first expandable tubular member 1000 and is substantially parallel to the inner surface 1002a and the outer surface 1002b and located adjacent the outer surface 1002b of the first expandable tubular member 1000. A third coupling member 1006c extends substantially perpendicularly from the coupling edge 1006 and is located substantially midway between the first coupling channel 1006a and the first coupling member 1006b. In an exemplary embodiment, the first expandable tubular member 1000 is fabricated from a metallic material.

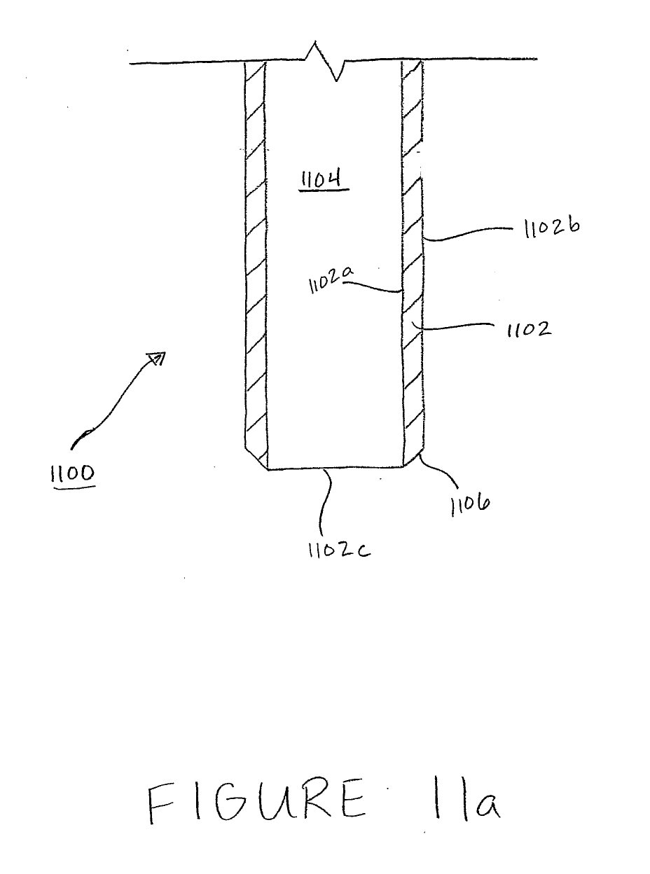

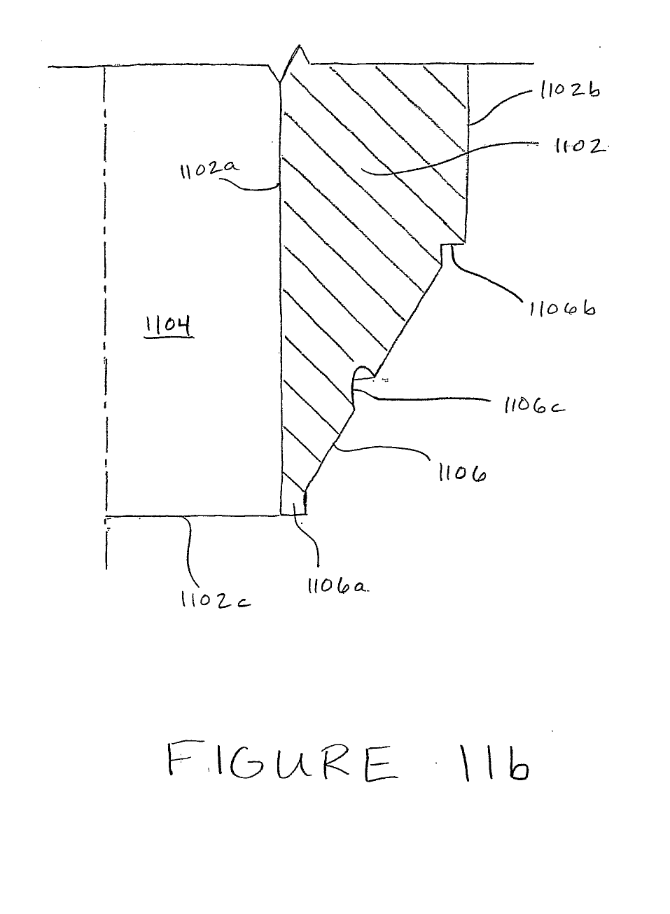

Referring now to FIGS. 11a and 11b, a second expandable tubular member 1100 is illustrated. The second expandable tubular member 1100 includes a wall 1102 having an inner surface 1102a, an outer surface 1102b located opposite the inner surface 1102a, and defining a passageway 1104 along the length of the second expandable tubular member 1100. A coupling edge 1106 is located on a distal end 1102c of the first expandable tubular member 1100 and extends between the inner surface 1102a and the outer surface 1102b at an angle with respect to the inner surface 1102a and the outer surface 1102b. A second coupling member 1106a extends from the coupling edge 1106 on the second expandable tubular member 1100 and is substantially parallel to the inner surface 1102a and the outer surface 1102b and located adjacent the inner surface 1102a of the second expandable tubular member 1100. The coupling edge 1106 and the wall 1102 define a second coupling channel 1106b which is located adjacent the outer surface 1102b of the second expandable tubular member 1100. The coupling edge 1106 and the wall 1102 also define a third coupling channel 1106c which is arcuate in cross section and located substantially midway between second coupling member 1106a and second coupling channel 1106b. In an exemplary embodiment, the second expandable tubular member 1100 is fabricated from a metallic material.

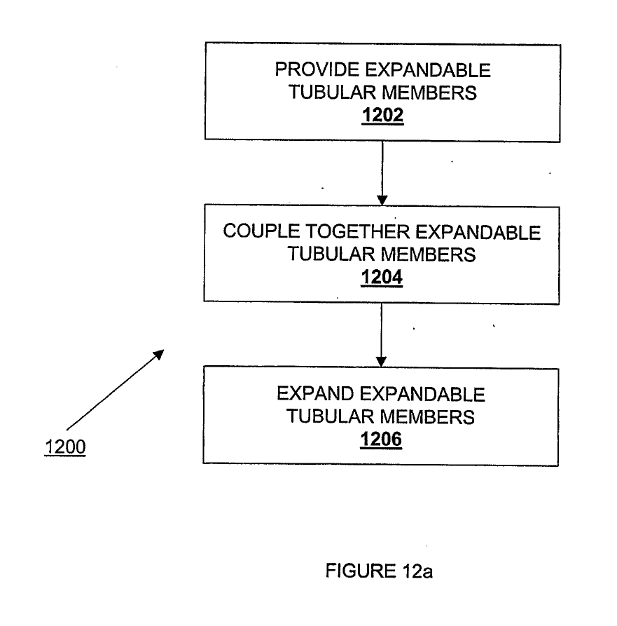

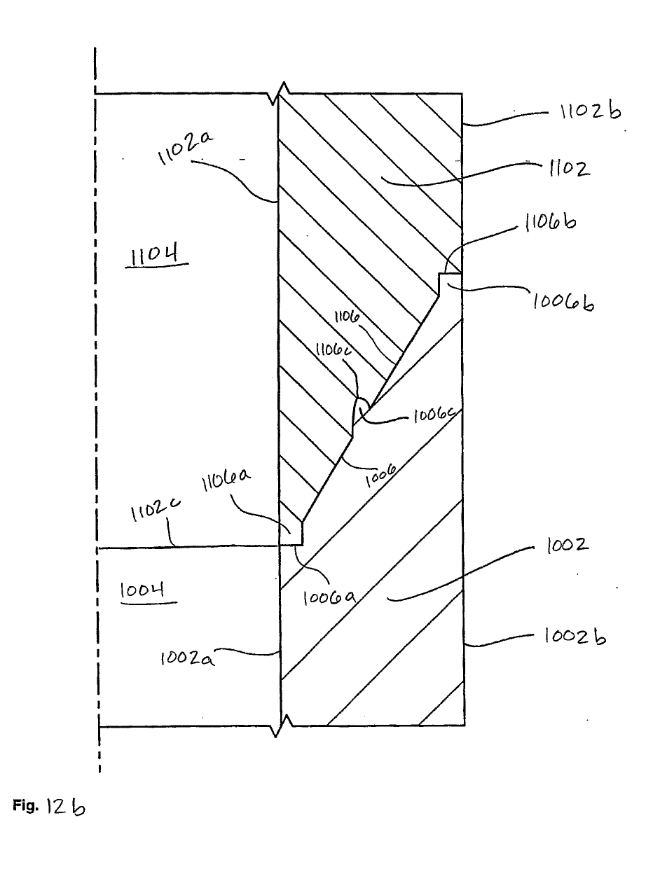

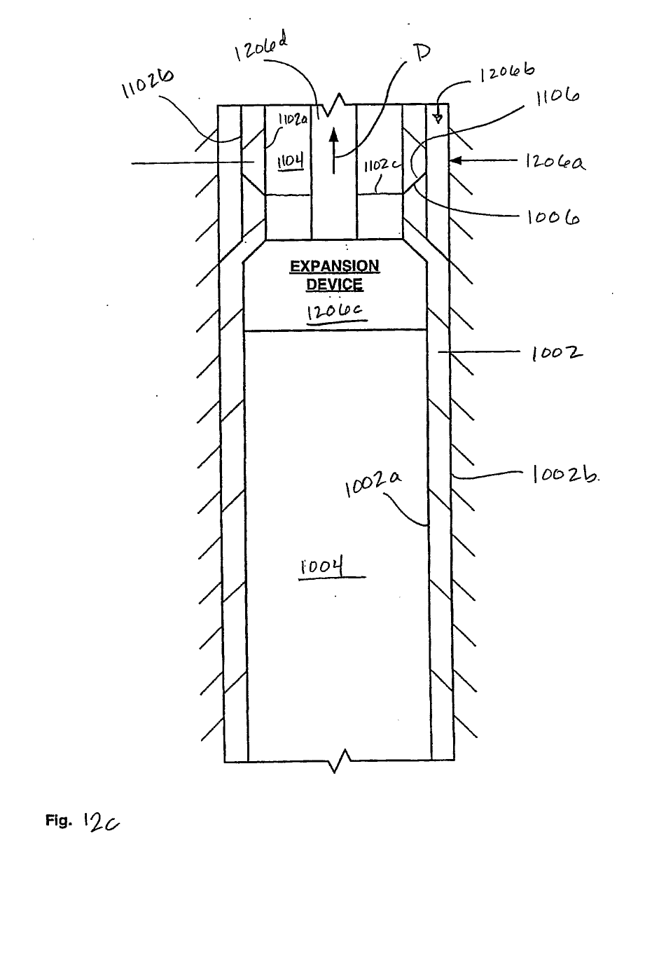

Referring now to FIGS. 10a, 11a, 12a, and 12b, a method 1200 for coupling expandable tubular members is illustrated. The method 1200 begins at step 1202 where the first expandable tubular member 1000 and the second expandable tubular member 1100 are provided. The method 1200 then proceeds to step 1204 where the first expandable tubular member 1000 and the second expandable tubular member 1100 are coupled together. The first expandable tubular member 1000 and the second expandable tubular member 1100 are positioned such that the distal end 1002c on the first expandable tubular member 1000 is adjacent the distal end 1102c on the second expandable tubular member 1100. The first coupling member 1006b on the first expandable tubular member 1000 is then positioned in the second coupling channel 1106b on the second expandable tubular member 1100 and the second coupling member 1106a on the second expandable tubular member 1100 is positioned in the first coupling channel 1006a on the first expandable tubular member 1000, deforming the third coupling member 1006c into the third coupling channel 1106c, as illustrated in FIGS. 10b, 11b, and 12b. With the first coupling member 1006b positioned in the second coupling channel 1106b, the second coupling member 1106a positioned in the first coupling channel 1006a, and the third coupling member 1006c deformed in the third coupling channel 1106c, the coupling edge 1006 on the first expandable tubular member 1000 engages the coupling edge 1106 on the second expandable tubular member 1100 and the passageway 1004 on first expandable tubular member 1000 is substantially co-axial with the passageway 1104 on the second expandable tubular member 1100. In an exemplary embodiment, the volume of material in the third coupling member 1006c is greater than the volume of the third coupling channel 1106c and as a result the third coupling member 1006c is deformed in the third coupling channel 1106c, providing an interference fit upon engaging the first expandable tubular member 1000 and the second tubular member 1100 which creates localized stresses between the first expandable tubular member 1000 and the second tubular member 1100, thereby coupling them together. In an exemplary embodiment, the coupling of the first expandable tubular member 1000 to the second expandable tubular member 1100 provides an air and liquid tight seal between the first expandable tubular member 1000 and the second expandable tubular member 1100. In an exemplary embodiment, the coupling of the first expandable tubular member 1000 to the second expandable tubular member 1100 provides a metal to metal seal between the third coupling member 1006c and the second expandable tubular member 1100. In an exemplary embodiment, the coupling of the first expandable tubular member 1000 and the second expandable tubular member 1100 may include methods such as, for example, threading, welding, brazing, or a variety of other coupling methods known in the art.

Referring now to FIGS. 10a, 11a, 12a, 12b, and 12c, the method 1200 proceeds to step 1206 wherein the first expandable tubular member 1000 and the second expandable tubular member 1100 are expanded. A wellbore 1206a is provided which defines a passageway 1206b along its length. The coupled-together first expandable tubular member 1000 and second expandable tubular member 1100 are positioned in the passageway 1206b of the wellbore 1206a. An expansion device 1206c, which may be a conventional expansion device known in the art, is provided which is coupled to a drill string 1206d and which includes a larger diameter than the inside diameter of the first expandable tubular member 1000 and the second expandable tubular member 1100. The expansion device 1206c is positioned in the passageway 1004 on the first expandable tubular member 1000 and in engagement with the inner surface 1002a of the first expandable tubular member 1000, which results in the expansion of the first expandable tubular member 1000. The expansion device 1206c may then be moved in a direction D such that the first expandable tubular member 1000 and the second expandable tubular member 1100 are expanded into engagement with the wellbore 1206a. Upon expansion of the first expandable tubular member 1000 and the second expandable tubular member 1100, the third coupling member 1006c on the first expandable tubular member 1000 deforms but remains positioned in the third coupling channel 1106c on the second expandable tubular member 1100. In an exemplary embodiment, the deformation of the third coupling member 1006c in the third coupling channel 1106c provides an air and liquid tight seal between the first expandable tubular member 1000 and the second expandable tubular member 1100 after expansion. In an exemplary embodiment, the deformation of the third coupling member 1006c in the third coupling channel 1106c provides a metal to metal seal between the third coupling member 1006c and the second expandable tubular member 1100.

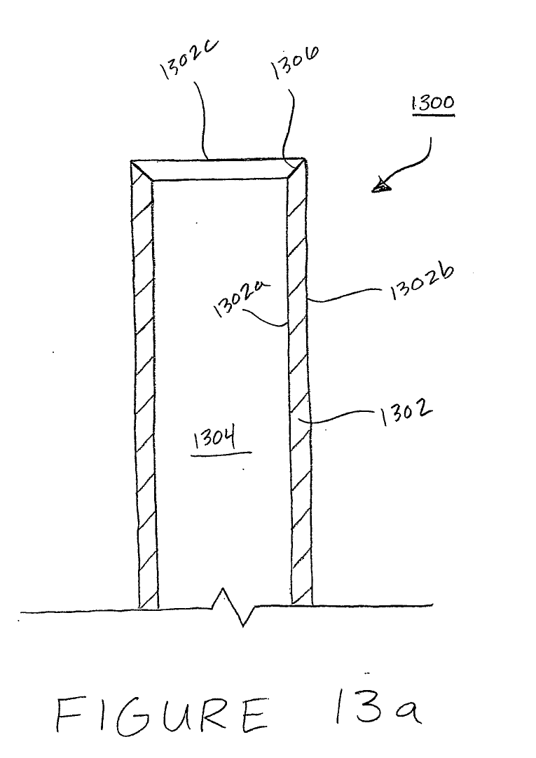

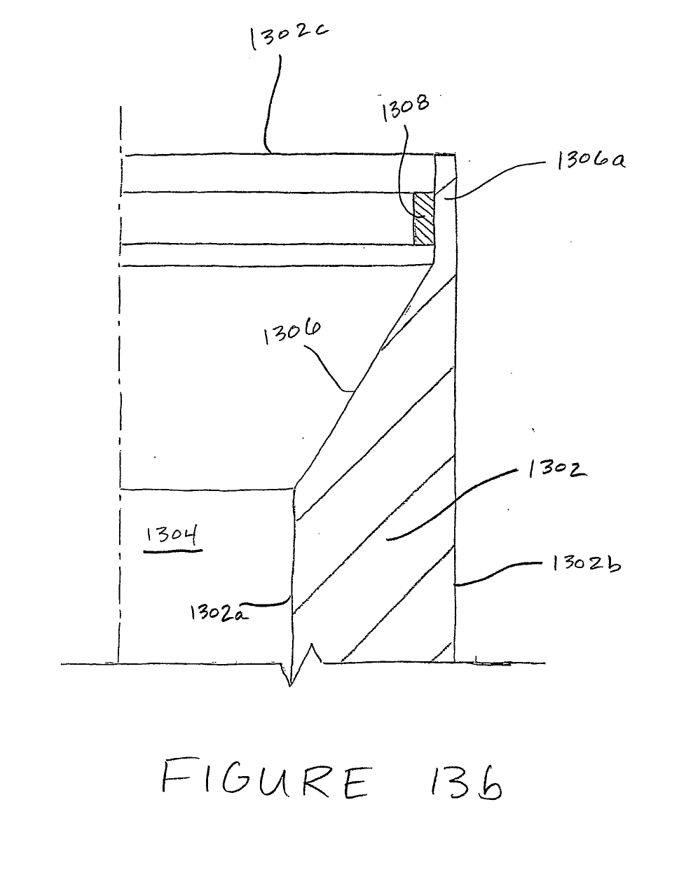

Referring now to FIGS. 13a and 13b, a first expandable tubular member 1300 is illustrated. The first expandable tubular member 1300 includes a wall 1302 having an inner surface 1302a, an outer surface 1302b located opposite the inner surface 1302a, and defining a passageway 1304 along the length of the first expandable tubular member 1300. A coupling edge 1306 is located on a distal end 1302c of the first expandable tubular member 1300 and extends between the inner surface 1302a and the outer surface 1302b at an angle with respect to the inner surface 1302a and the outer surface 1302b. A coupling member 1306a extends from the coupling edge 1306 on the first expandable tubular member 1300 and is substantially parallel to the inner surface 1302a and the outer surface 1302b and located adjacent the outer surface 1302b of the first expandable tubular member 1300. A compressible member 1308 is coupled to the coupling member 1306a and located adjacent the coupling edge 1306. In an exemplary embodiment, the first expandable tubular member 1300 is fabricated from a metallic material. In an exemplary embodiment, the compressible member 1308 includes a compressible ring coupled to the coupling member 1308. In an exemplary embodiment, the compressible member 1308 is fabricated from a metallic material. In an exemplary embodiment, the compressible member 1308 is fabricated from an elastomer material.

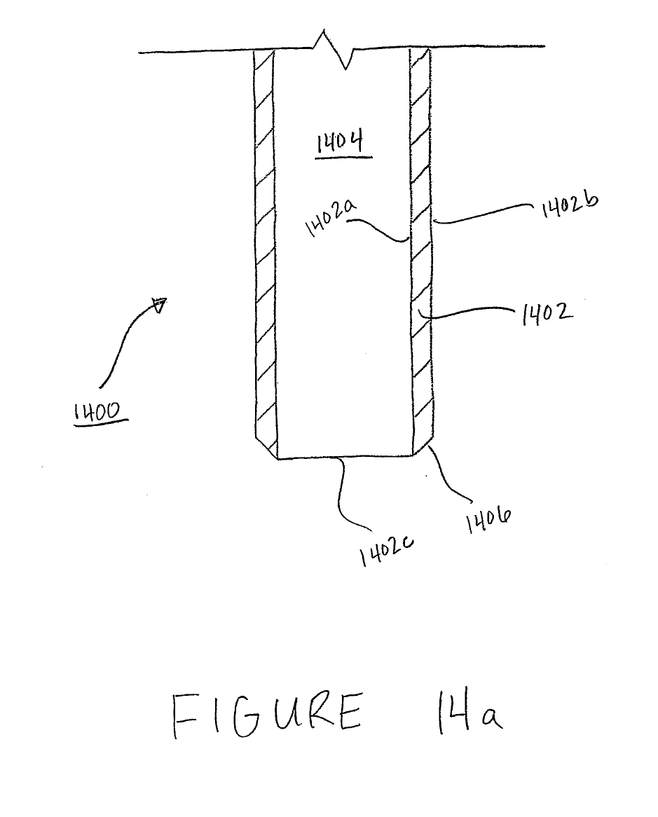

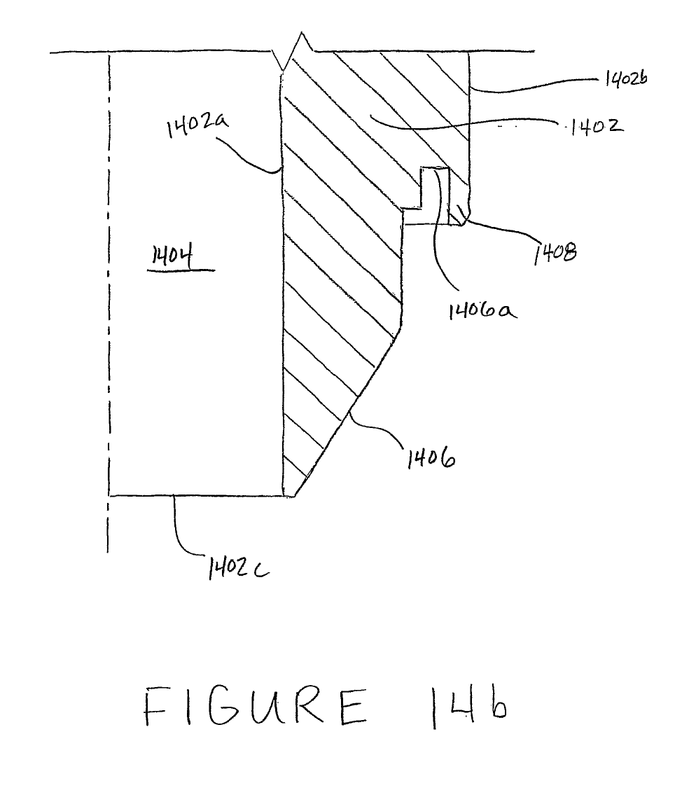

Referring now to FIGS. 14a and 14b, a second expandable tubular member 1400 is illustrated. The second expandable tubular member 1400 includes a wall 1402 having an inner surface 1402a, an outer surface 1402b located opposite the inner surface 1402a, and defining a passageway 1404 along the length of the second expandable tubular member 1400. A coupling edge 1406 is located on a distal end 1402c of the first expandable tubular member 1400 and extends between the inner surface 1402a and the outer surface 1402b at an angle with respect to the inner surface 102a and the outer surface 1402b. The coupling edge 1406 and the wall 1402 define a coupling channel 1406a which is substantially parallel to the inner surface 1402a and the outer surface 1402b and located adjacent the outer surface 1402b of the second expandable tubular member 1400. A sealing member 1408 extends from the wall 1402 and is located adjacent the coupling channel 1406a and the outer surface 1402b of the second expandable tubular member 1400. In an exemplary embodiment, the second expandable tubular member 1400 is fabricated from a metallic material.

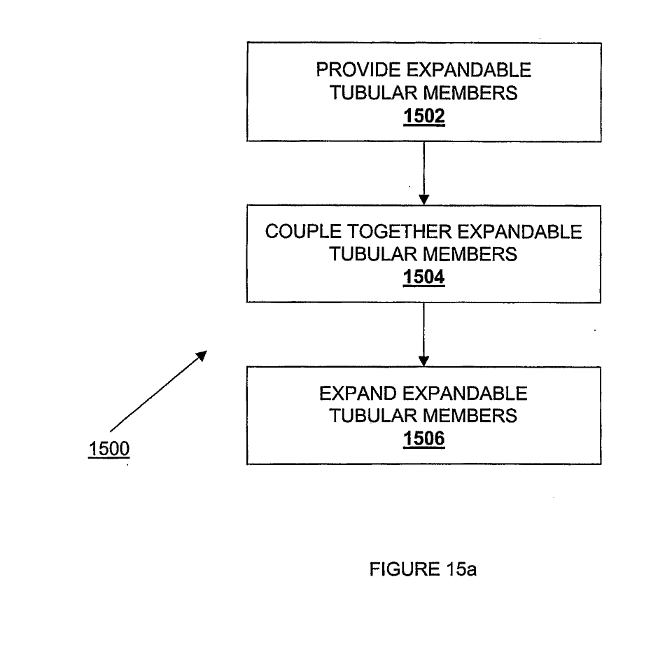

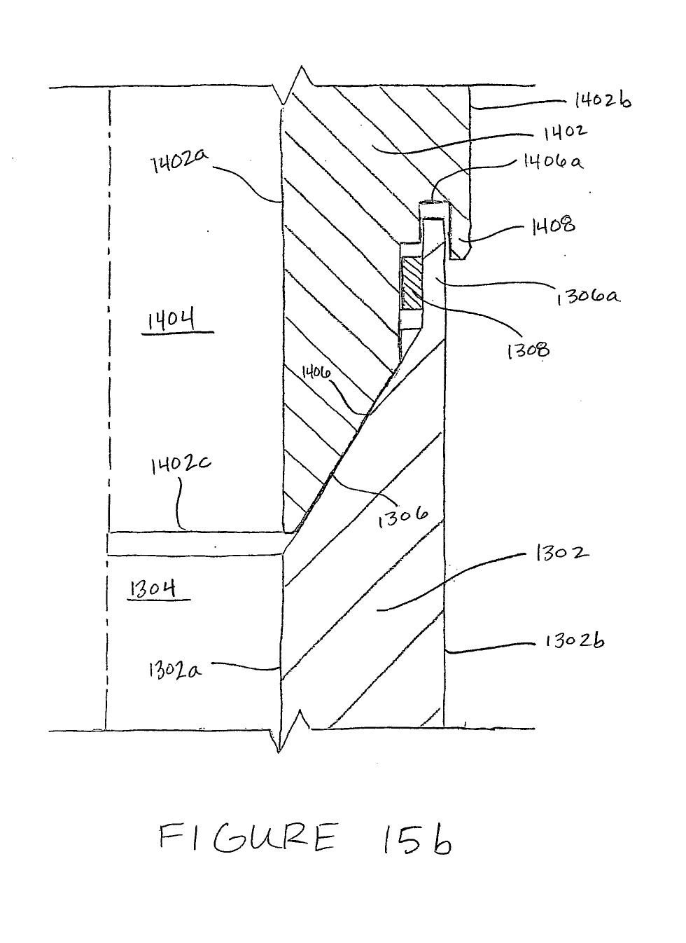

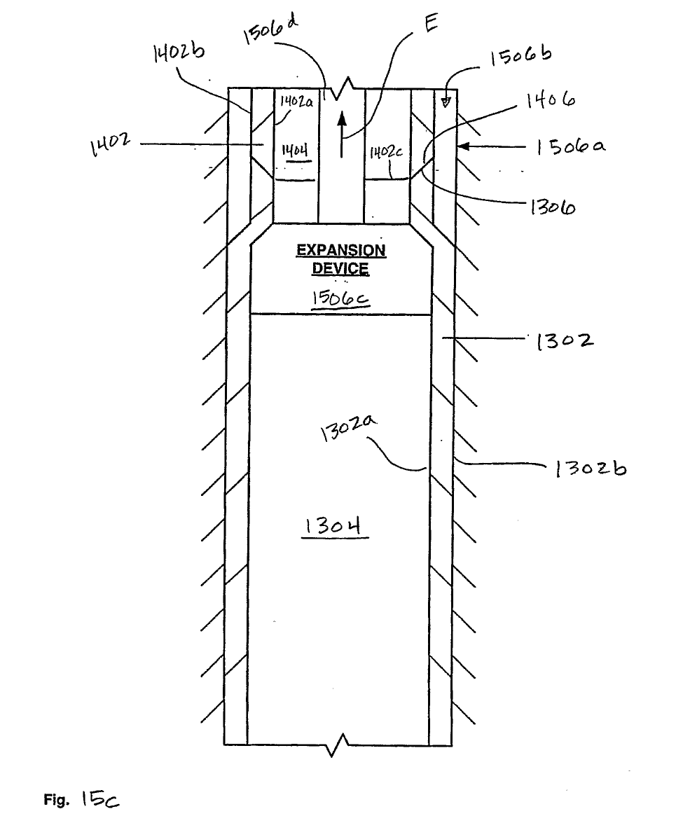

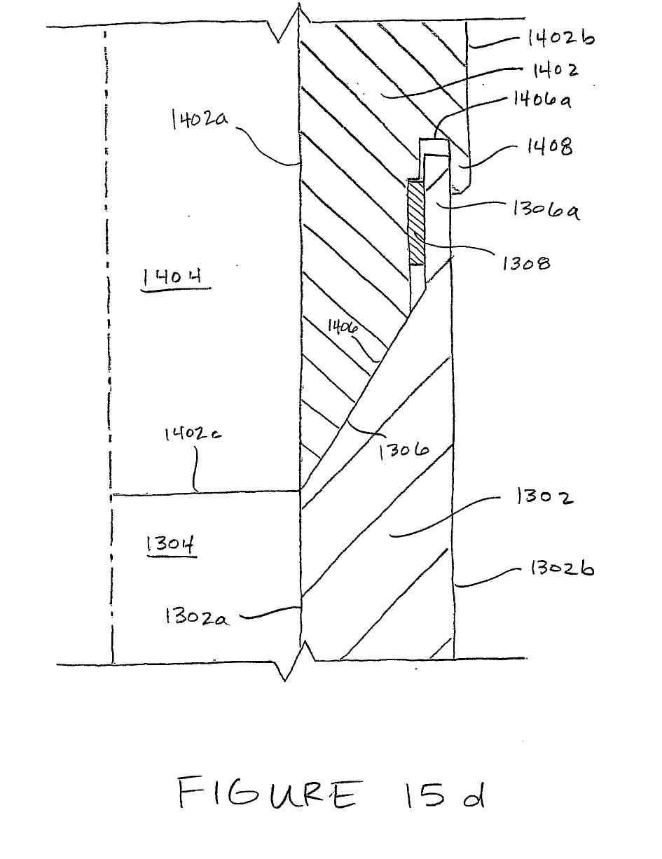

Referring now to FIGS. 13a, 14a, 15a, and 15b, a method 1500 for coupling expandable tubular members is illustrated. The method 1500 begins at step 1502 where the first expandable tubular member 1300 and the second expandable tubular member 1400 are provided. The method 1500 then proceeds to step 1504 where the first expandable tubular member 1300 and the second expandable tubular member 1400 are coupled together. The first expandable tubular member 1300 and the second expandable tubular member 1400 are positioned such that the distal end 1302c on the first expandable tubular member 1300 is adjacent the distal end 1402c on the second expandable tubular member 1400. The coupling member 1306a on the first expandable tubular member 1300 is then positioned in the coupling channel 1406a on the second expandable tubular member 1400, as illustrated in FIG. 15b. With the coupling member 1306a positioned in the coupling channel 1406a, the coupling edge 1306 on the first expandable tubular member 1300 engages the coupling edge 1406 on the second expandable tubular member 1400 and the passageway 1304 on first expandable tubular member 1300 is substantially co-axial with the passageway 1404 on the second expandable tubular member 1400. In an exemplary embodiment, the coupling of the first expandable tubular member 1300 and the second expandable tubular member 1400 may include methods such as, for example, threading, welding, brazing, or a variety of other coupling methods known in the art.

Referring now to FIGS. 13a, 14a, 15a, 15c, and 15d, the method 1500 proceeds to step 1506 wherein the first expandable tubular member 1300 and the second expandable tubular member 1400 are expanded. A wellbore 1506a is provided which defines a passageway 1506b along its length. The coupled-together first expandable tubular member 1300 and second expandable tubular member 1400 are positioned in the passageway 1506b of the wellbore 1506a. An expansion device 1506c, which may be a conventional expansion device known in the art, is provided which is coupled to a drill string 1506d and which includes a larger diameter than the inside diameter of the first expandable tubular member 1300 and the second expandable tubular member 1400. The expansion device 1506c is positioned in the passageway 1304 on the first expandable tubular member 1300 and in engagement with the inner surface 1302a of the first expandable tubular member 1300, which results in the expansion of the first expandable tubular member 1300. The expansion device 1506c may then be moved in a direction E such that the first expandable tubular member 1300 and the second expandable tubular member 1400 are expanded into engagement with the wellbore 1506a. Upon expansion of the first expandable tubular member 1300 and the second expandable tubular member 1400, the compressible member 1308 is compressed by the wall 1402 of second expandable tubular member 1400, resulting in the coupling member 1306a on first expandable tubular member 1300 engaging the sealing member 1408, as illustrated in FIG. 15d. In an exemplary embodiment, compressing of the compressible member 1308 during expansion provides an air and liquid tight seal between the first expandable tubular member 1300 and the second expandable tubular member 1400 after expansion. In an exemplary embodiment, the compressing of the compressible member 1308 during expansion provides a metal to metal seal between the coupling member 1306a and the sealing member 1408.

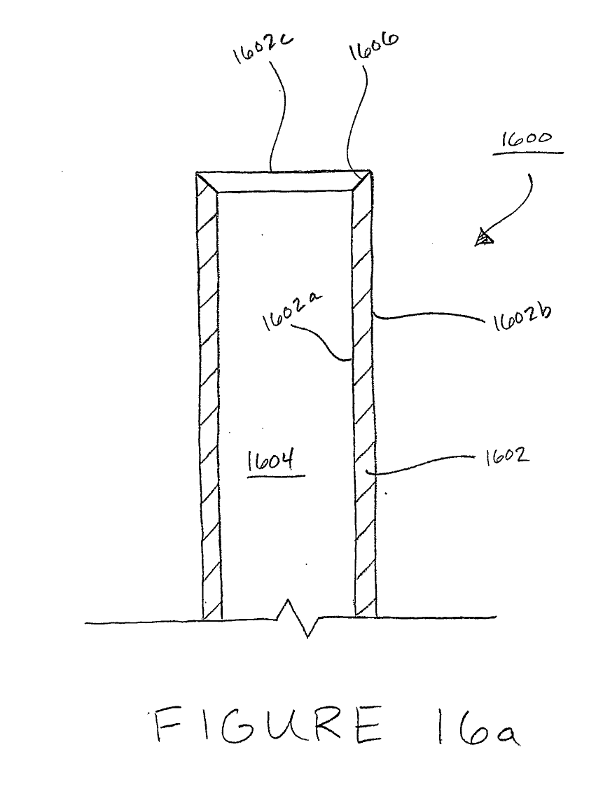

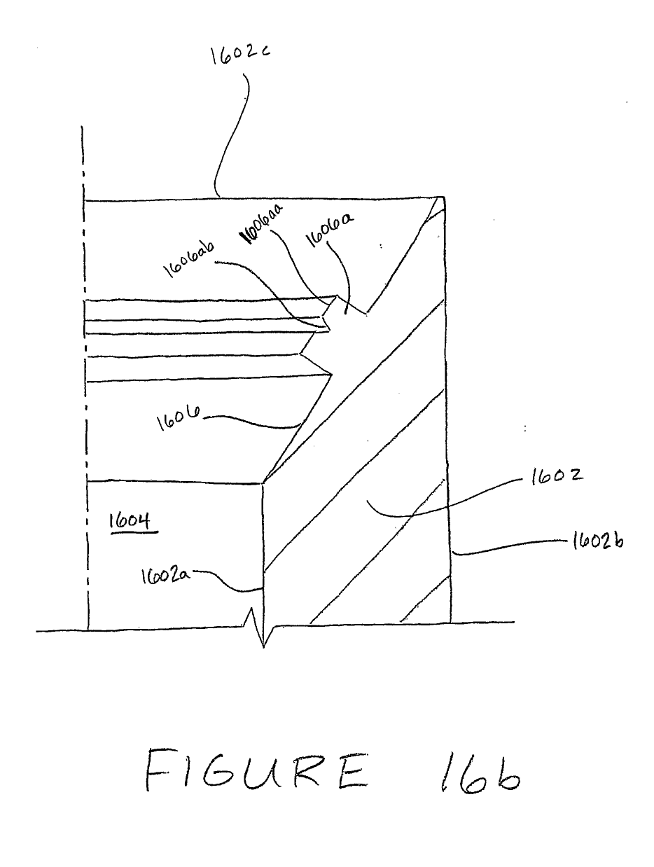

Referring now to FIGS. 16a and 16b, a first expandable tubular member 1600 is illustrated. The first expandable tubular member 1600 includes a wall 1602 having an inner surface 1602a, an outer surface 1602b located opposite the inner surface 1602a, and defining a passageway 1604 along the length of the first expandable tubular member 1600. A coupling edge 1606 is located on a distal end 1602c of the first expandable tubular member 1600 and extends between the inner surface 1602a and the outer surface 1602b at an angle with respect to the inner surface 1602a and the outer surface 1602p. A thread member 1606a extends substantially perpendicularly from the coupling edge 1606 on the first expandable tubular member 1600, includes an end 1606aa, and is substantially centrally located on the coupling edge 1606 of the first expandable tubular member 1600 between the inner surface 1602a and the outer surface 1602b. A deformation channel 1606ab is defined by the thread member 1606a and is substantially centrally located on the thread member 1606a adjacent the end 1606aa. In an exemplary embodiment, the first expandable tubular member 1600 is fabricated from a metallic material. In an exemplary embodiment, a plurality of thread members which are substantially similar in design and operation to the thread member 1606a are provided on the coupling edge 1606.

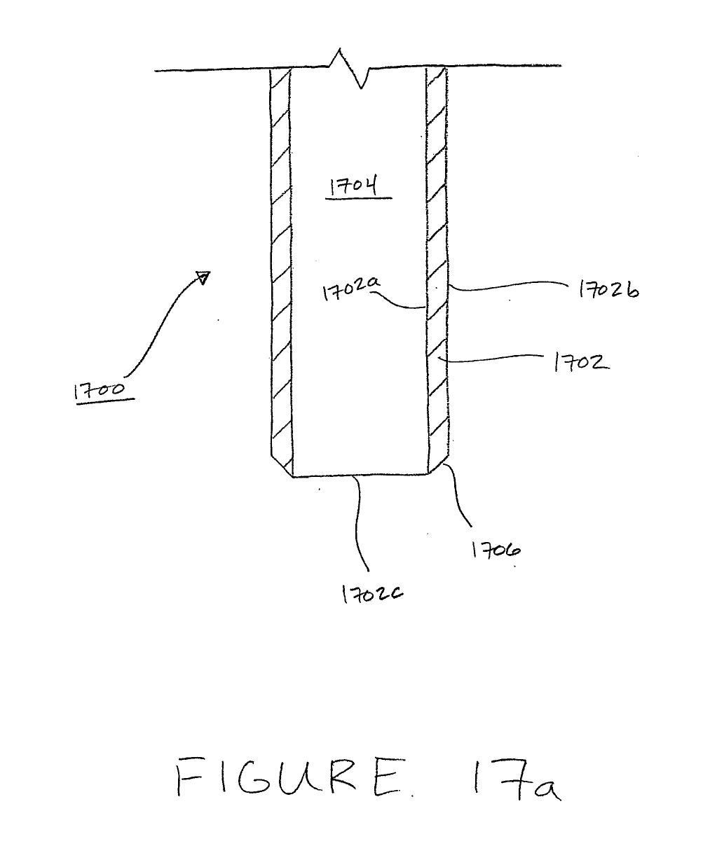

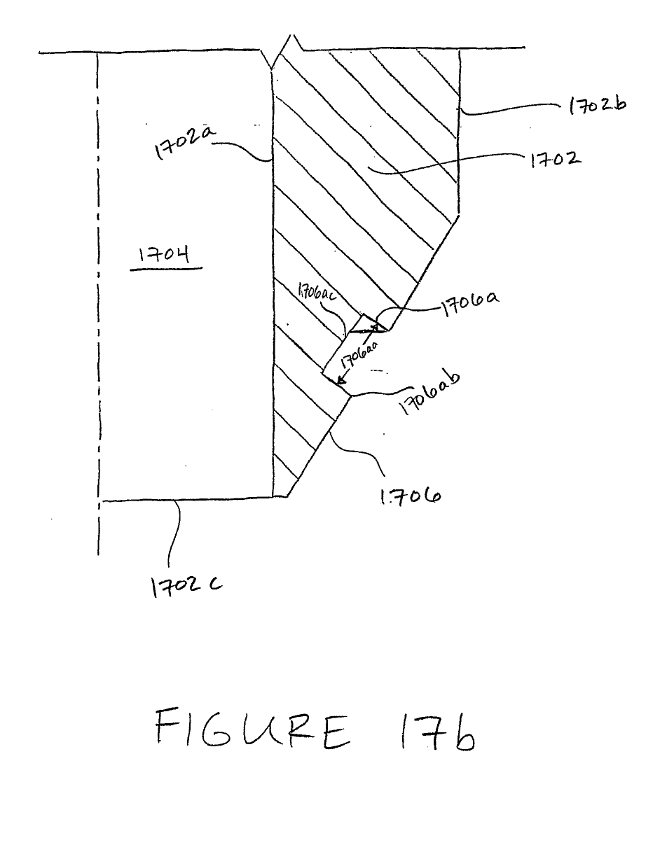

Referring now to FIGS. 17a and 17b, a second expandable tubular member 1700 is illustrated. The second expandable tubular member 1700 includes a wall 1702 having an inner surface 1702a, an outer surface 1702b located opposite the inner surface 1702a, and defining a passageway 1704 along the length of the second expandable tubular member 1700. A coupling edge 1706 is located on a distal end 1702c of the first expandable tubular member 1700 and extends between the inner surface 1702a and the outer surface 1702b at an angle with respect to the inner surface 1702a and the outer surface 1702b. The coupling edge 1706 and the wall 1702 define a thread channel 1706a which is substantially centrally located on the coupling edge 1706, oriented substantially perpendicularly with respect to the coupling edge 1706, and has a width 1706aa which is substantially constant from a entrance 1706ab of the thread channel 1706a to an end 1706ac of the thread channel 1706a. In an exemplary embodiment, the second expandable tubular member 1700 is fabricated from a metallic material. In an exemplary embodiment, a plurality of thread channels which are substantially similar in design and operation to the thread channel 1706a are provided on the coupling edge 1706.

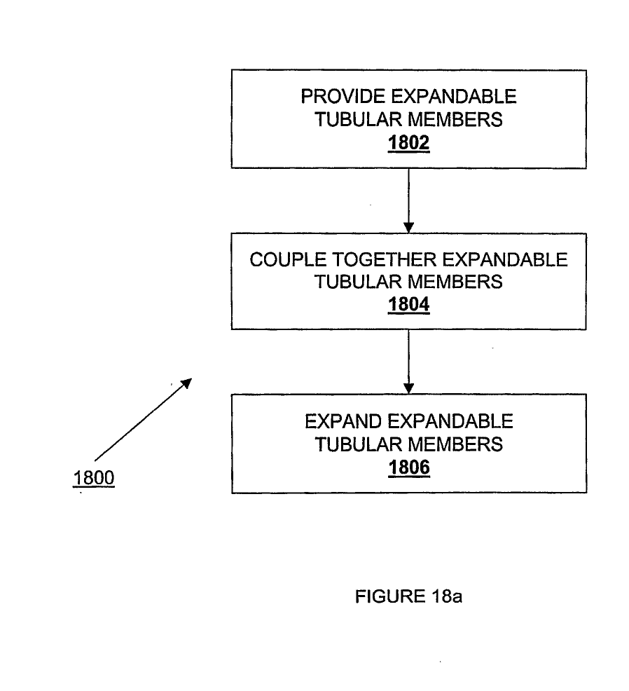

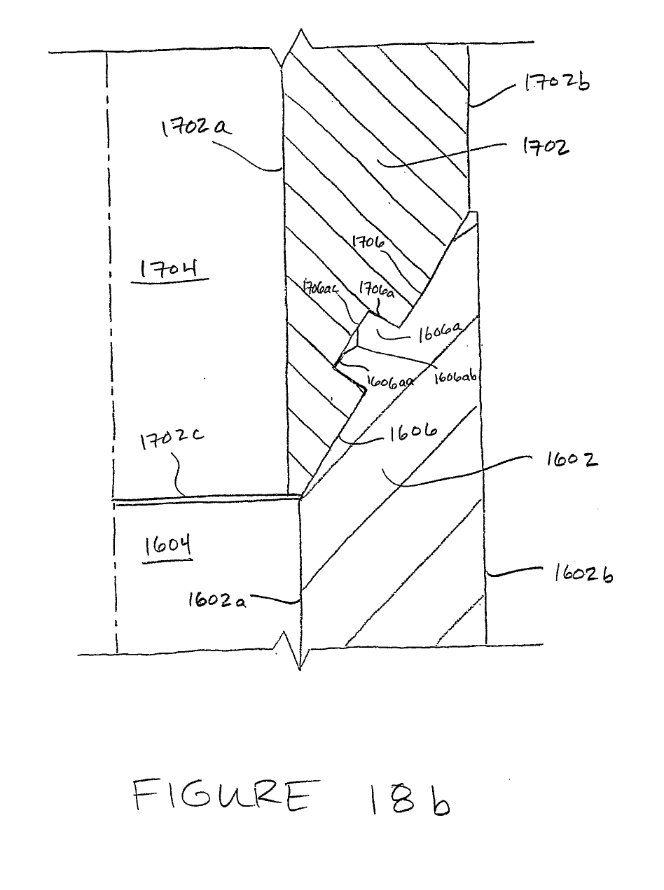

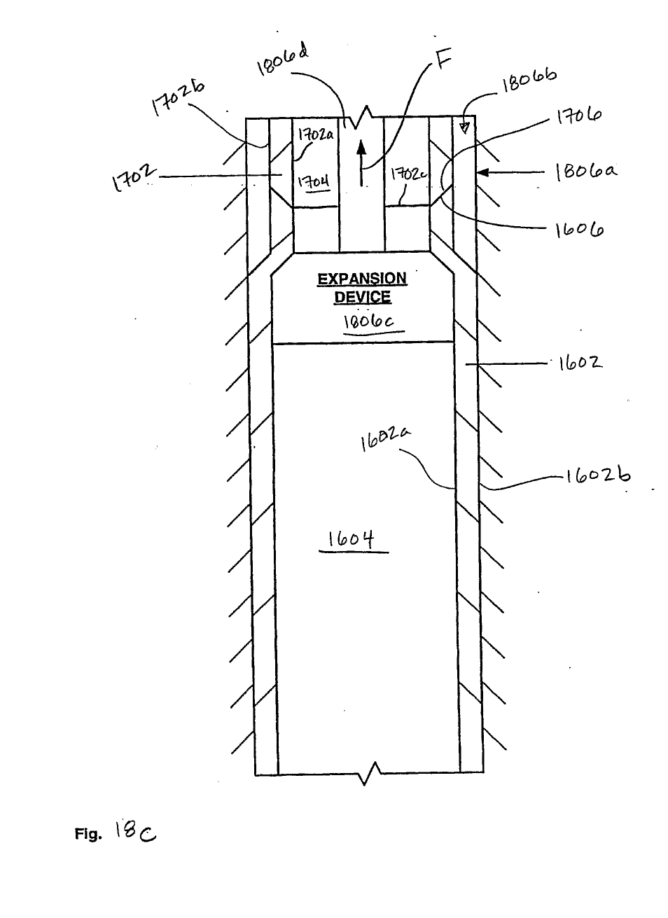

Referring now to FIGS. 16a, 17a, 18a, and 18b, a method 1800 for coupling expandable tubular members is illustrated. The method 1800 begins at step 1802 where the first expandable tubular member 1600 and the second expandable tubular member 1700 are provided. The method 1800 then proceeds to step 1704 where the first expandable tubular member 1600 and the second expandable tubular member 1700 are coupled together. The first expandable tubular member 1600 and the second expandable tubular member 1700 are positioned such that the distal end 1602c on the first expandable tubular member 1600 is adjacent the distal end 1702c on the second expandable tubular member 1700. The thread member 1606a on the first expandable tubular member 1600 is then positioned in the thread channel 1706a on the second expandable tubular member 1700. With the thread member 1606a positioned in the thread channel 1706a, the passageway 1604 on first expandable tubular member 1600 is substantially co-axial with the passageway 1704 on the second expandable tubular member 1700 and the coupling edge 1606 on the first expandable tubular member 1600 may be engaged with the coupling edge 1706 on the second expandable tubular member 1700 by rotating the first expandable tubular member 1600 relative to the second expandable tubular 1700. As the first expandable tubular member 1600 is rotated relative to the second expandable tubular 1700, the thread member 1606a will engage the end 1706ac of the thread channel 1706a. The deformation channel 1606ab allows the thread member 1606a to deform in the thread channel 1702a, as illustrated in FIG. 18b. In an exemplary embodiment, deforming the thread member 1606a in the thread channel 1706a provides an air and liquid tight seal between the first expandable tubular member 1600 and the second expandable tubular member 1700. In an exemplary embodiment, deforming the thread member 1606a in the thread channel 1706a provides a metal to metal seal between the thread member 1606a and the second expandable tubular member 1700. In an exemplary embodiment, the coupling of the first expandable tubular member 1600 and the second expandable tubular member 1700 may include methods such as, for example, threading, welding, brazing, or a variety of other coupling methods known in the art.

Referring now to FIGS. 16a, 17a, 18a, 18b, and 18c, the method 1800 proceeds to step 1806 wherein the first expandable tubular member 1600 and the second expandable tubular member 1700 are expanded. A wellbore 1806a is provided which defines a passageway 1806b along its length. The coupled-together first expandable tubular member 1600 and second expandable tubular member 1700 are positioned in the passageway 1806b of the wellbore 1806a. An expansion device 1806c, which may be a conventional expansion device known in the art, is provided which is coupled to a drill string 1806d and which includes a larger diameter than the inside diameter of the first expandable tubular member 1600 and the second expandable tubular member 1700. The expansion device 1806c is positioned in the passageway 1604 on the first expandable tubular member 1600 and in engagement with the inner surface 1602a of the first expandable tubular member 1600, which results in the expansion of the first expandable tubular member 1600. The expansion device 1806c may then be moved in a direction F such that the first expandable tubular member 1600 and the second expandable tubular member 1700 are expanded into engagement with the wellbore 1806a. Upon expansion of the first expandable tubular member 1600 and the second expandable tubular member 1700, the thread member 1606a deforms further in the thread channel 1706a. In an exemplary embodiment, the deformation of the thread member 1606a in the thread channel 1706a during expansion provides an air and liquid tight seal between the first expandable tubular member 1600 and the second expandable tubular member 1700 after expansion. In an exemplary embodiment, the deformation of the thread member 1606a in the thread channel 1706a during expansion provides a metal to metal seal between the thread member 1606a and the second expandable tubular member 1700.

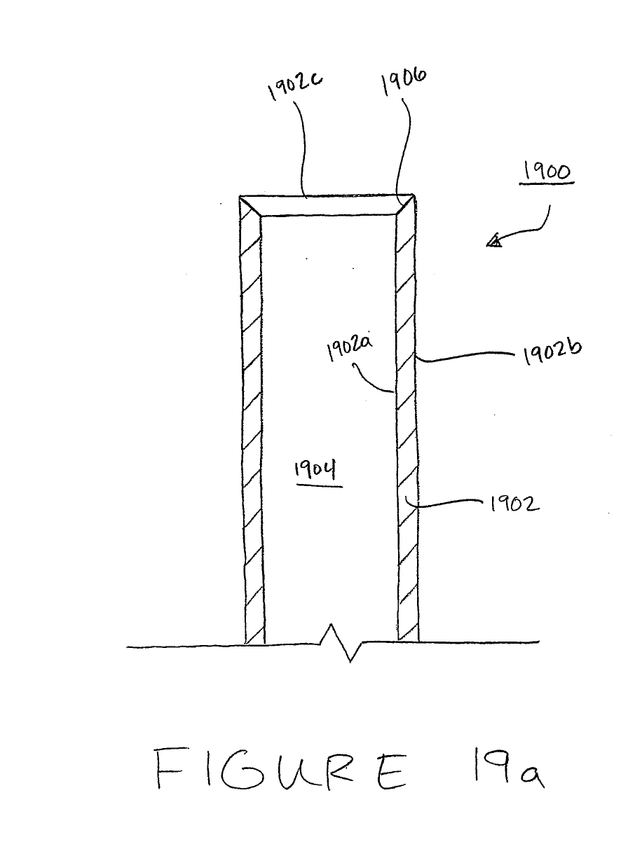

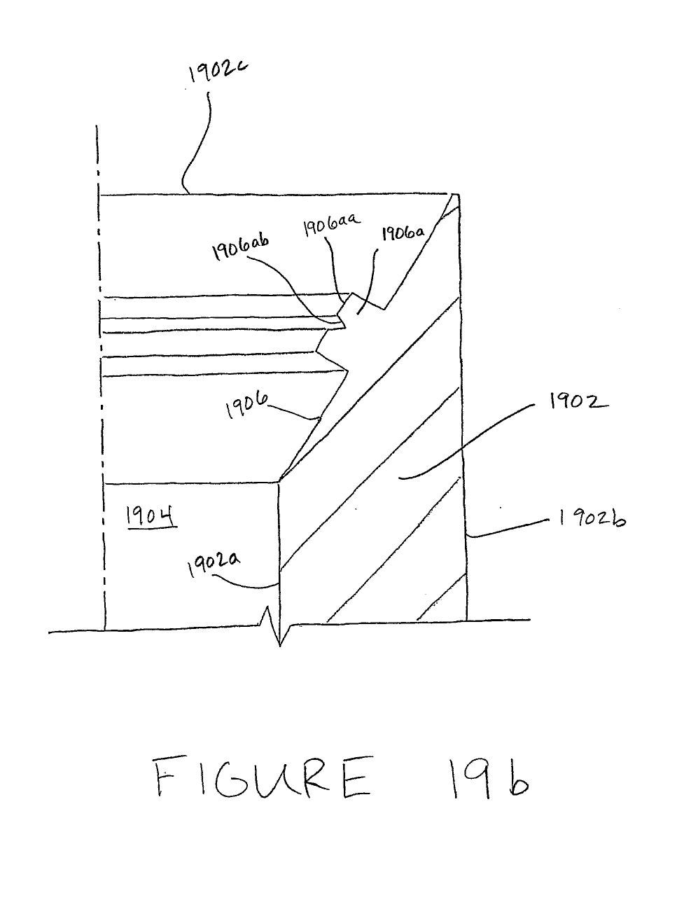

Referring now to FIGS. 19a and 19b, a first expandable tubular member 1900 is illustrated. The first expandable tubular member 1900 includes a wall 1902 having an inner surface 1902a, an outer surface 1902b located opposite the inner surface 1902a, and defining a passageway 1904 along the length of the first expandable tubular member 1900. A coupling edge 1906 is located on a distal end 1902c of the first expandable tubular member 1900 an extends between the inner surface 1902a and the outer surface 1902b at an angle with respect to the inner surface 1902a and the outer surface 1902b. A thread member 1906a extends substantially perpendicularly from the coupling edge 1906 on the first expandable tubular member 1900, includes an end 1906aa, and is substantially centrally located on the coupling edge 1906 of the first expandable tubular member 1900 between the inner surface 1902a and the outer surface 1902b. A deformation channel 1906ab is defined by the thread member 1906a and is substantially centrally located on the thread member 1906a adjacent the end 1906aa. In an exemplary embodiment, the first expandable tubular member 1900 is fabricated from a metallic material. In an exemplary embodiment, a plurality of thread members which are substantially similar in design and operation to the thread member 1906a are provided on the coupling edge 1906.

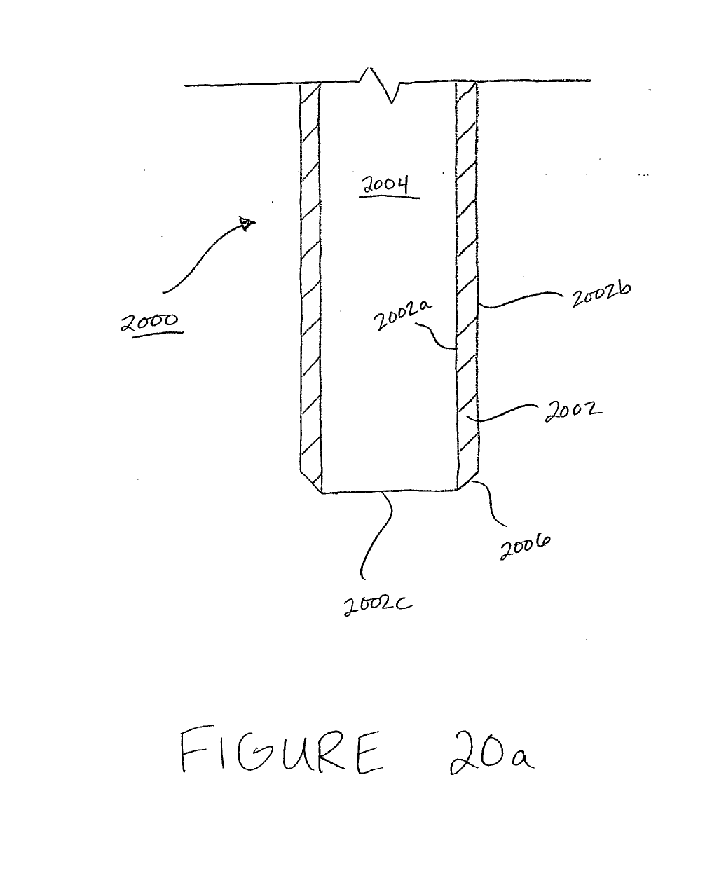

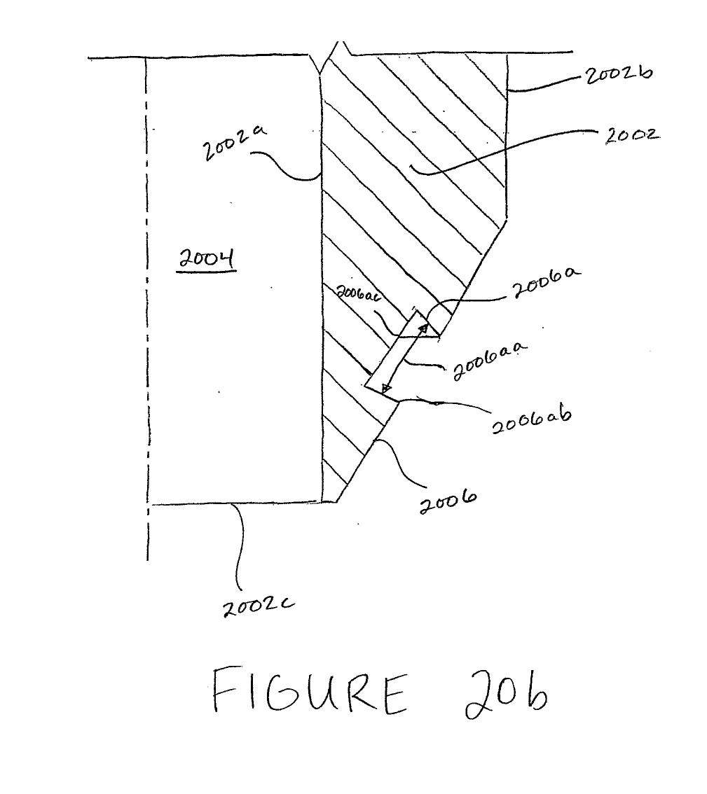

Referring now to FIGS. 20a and 20b, a second expandable tubular member 2000 is illustrated. The second expandable tubular member 2000 includes a wall 2002 having an inner surface 2002a, an outer surface 2002b located opposite the inner surface 2002a, and defining a passageway 2004 along the length of the second expandable tubular member 2000. A coupling edge 2006 is located on a distal end 2002c of the first expandable tubular member 2000 and extends between the inner surface 2002a and the outer surface 2002b at an angle with respect to the inner surface 2002a and the outer surface 2002b. The coupling edge 2006 and the wall 2002 define a thread channel 2006a which is substantially centrally located on the coupling edge 2006, oriented substantially perpendicularly with respect to the coupling edge 2006, and has a tapered width 2006aa which increases from a entrance 2006ab of the thread channel 2006a to an end 2006ac of the thread channel 2006a. In an exemplary embodiment, the second expandable tubular member 2000 is fabricated from a metallic material. In an exemplary embodiment, a plurality of thread channels which are substantially similar in design and operation to the thread channel 2006a are provided on the coupling edge 2006.

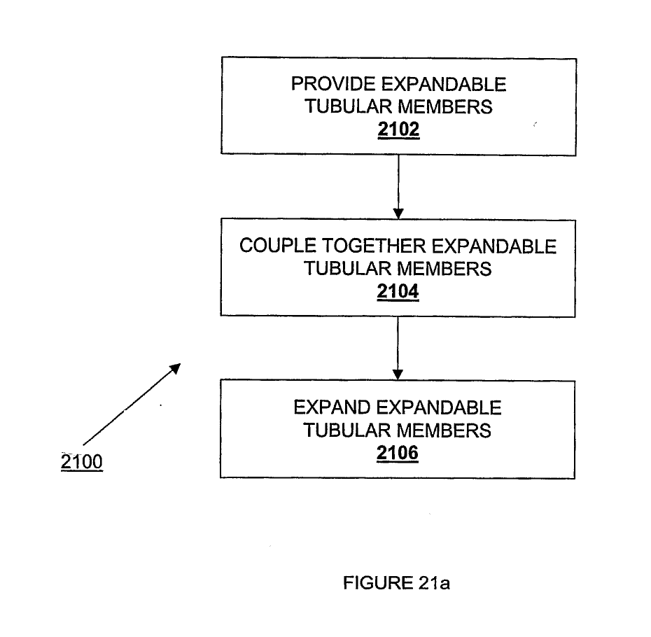

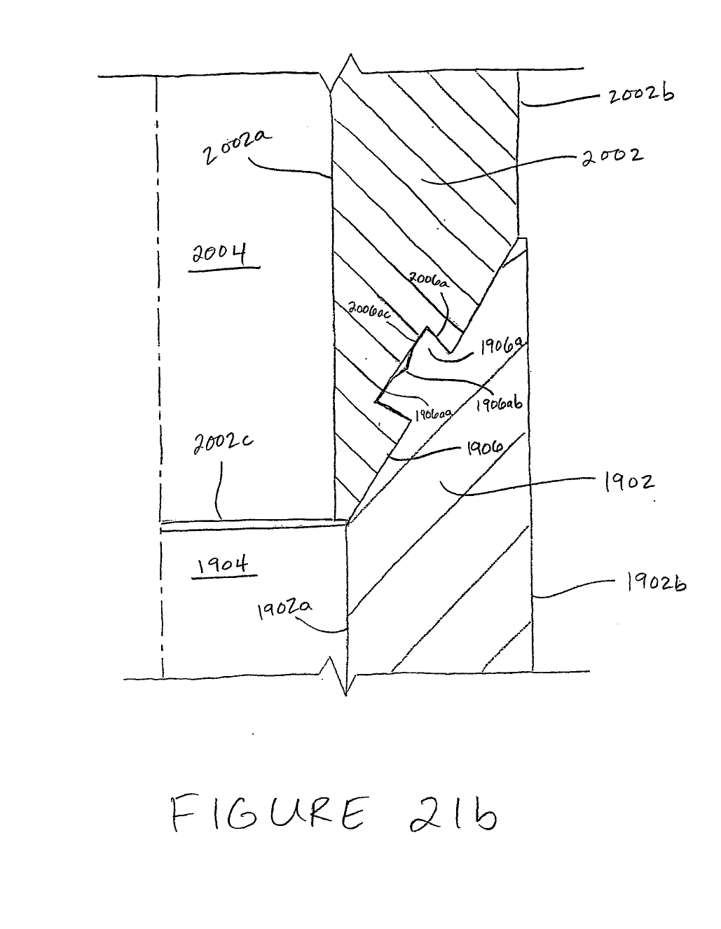

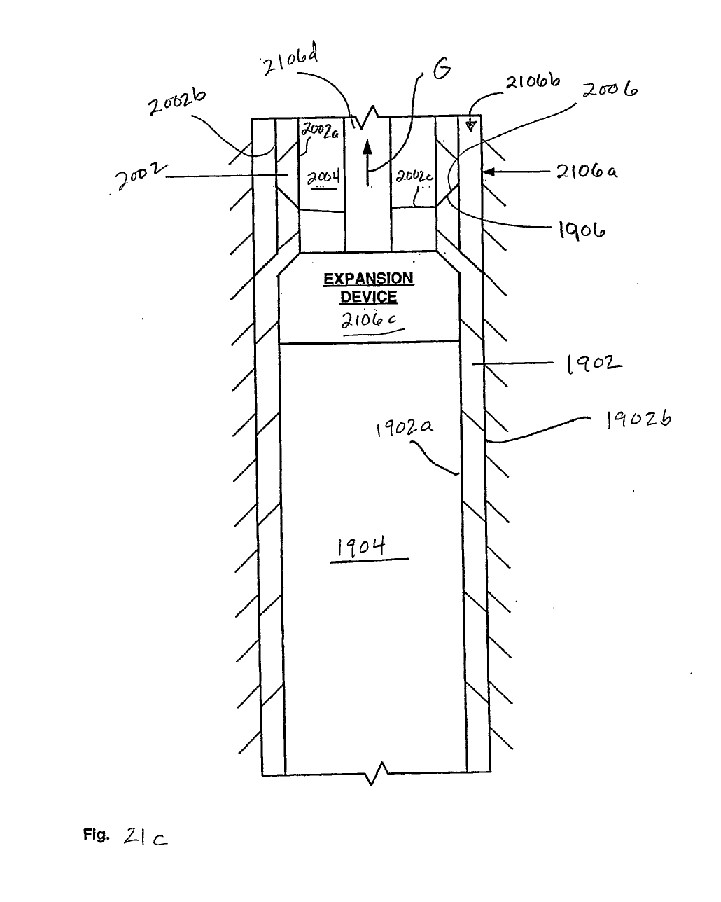

Referring now to FIGS. 19a, 20a, 21a, and 21b, a method 2100 for coupling expandable tubular members is illustrated. The method 2100 begins at step 2102 where the first expandable tubular member 1900 and the second expandable tubular member 2000 are provided. The method 2100 then proceeds to step 2104 where the first expandable tubular member 1900 and the second expandable tubular member 2000 are coupled together. The first expandable tubular member 1900 and the second expandable tubular member 2000 are positioned such that the distal end 1902c on the first expandable tubular member 1900 is adjacent the distal end 2002c on the second expandable tubular member 2000. The thread member 1906a on the first expandable tubular member 1900 is then positioned in the thread channel 2006a on the second expandable tubular member 2000. With the thread member 1906a positioned in the thread channel 2006a, the passageway 1904 on first expandable tubular member 1900 is substantially co-axial with the passageway 2004 on the second expandable tubular member 2000 and the coupling edge 1906 on the first expandable tubular member 1900 may be engaged with the coupling edge 2006 on the second expandable tubular member 2000 by rotating the first expandable tubular member 1900 relative to the second expandable tubular 2000. As the first expandable tubular member 1900 is rotated relative to the second expandable tubular 2000, the thread member 1906a will engage the end 2006ac of the thread channel 2006a. The deformation channel 1906ab allows the thread member 1906a to deform in the thread channel 2002a, as illustrated in FIG. 18b. In an exemplary embodiment, deforming the thread member 1906a in the thread channel 2006a provides an air and liquid tight seal between the first expandable tubular member 1900 and the second expandable tubular member 2000. In an exemplary embodiment, deforming the thread member 1906a in the thread channel 2006a provides a metal to metal seal between the thread member 1906a and the second expandable tubular member 2000. In an exemplary embodiment, the coupling of the first expandable tubular member 1900 and the second expandable tubular member 2000 may include methods such as, for example, threading, welding, brazing, or a variety of other coupling methods known in the art.

Referring now to FIGS. 19a, 20a, 21a, 21b, and 21c, the method 2100 proceeds to step 2106 wherein the first expandable tubular member 1900 and the second expandable tubular member 2000 are expanded. A wellbore 2106a is provided which defines a passageway 2106b along its length. The coupled-together first expandable tubular member 1900 and second expandable tubular member 2000 are positioned in the passageway 2106b of the wellbore 2106a. An expansion device 2106c, which may be a conventional expansion device known in the art, is provided which is coupled to a drill string 2106d and which includes a larger diameter than the inside diameter of the first expandable tubular member 1900 and the second expandable tubular member 2000. The expansion device 2106c is positioned in the passageway 1904 on the first expandable tubular member 1900 and in engagement with the inner surface 1902a of the first expandable tubular member 1900, which results in the expansion of the first expandable tubular member 1900. The expansion device 2106c may then be moved in a direction G such that the first expandable tubular member 1900 and the second expandable tubular member 2000 are expanded into engagement with the wellbore 2106a. Upon expansion of the first expandable tubular member 1900 and the second expandable tubular member 2000, the thread member 1906a deforms further in the thread channel 2006a. In an exemplary embodiment, the deformation of the thread member 1906a in the thread channel 2006a during expansion provides an air and liquid tight seal between the first expandable tubular member 1900 and the second expandable tubular member 2000 after expansion. In an exemplary embodiment, the deformation of the thread member 1906a in the thread channel 2006a during expansion provides a metal to metal seal between the thread member 1906a and the second expandable tubular member 2000.

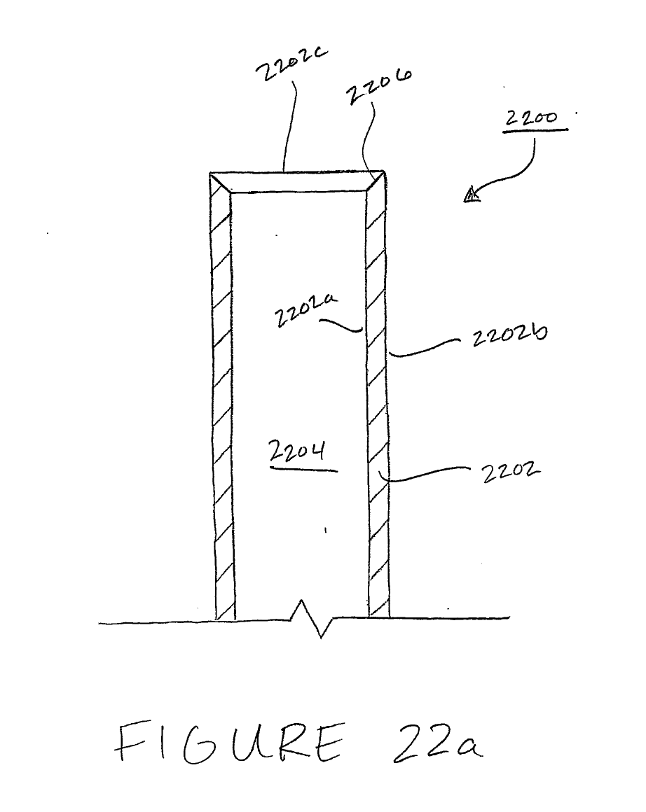

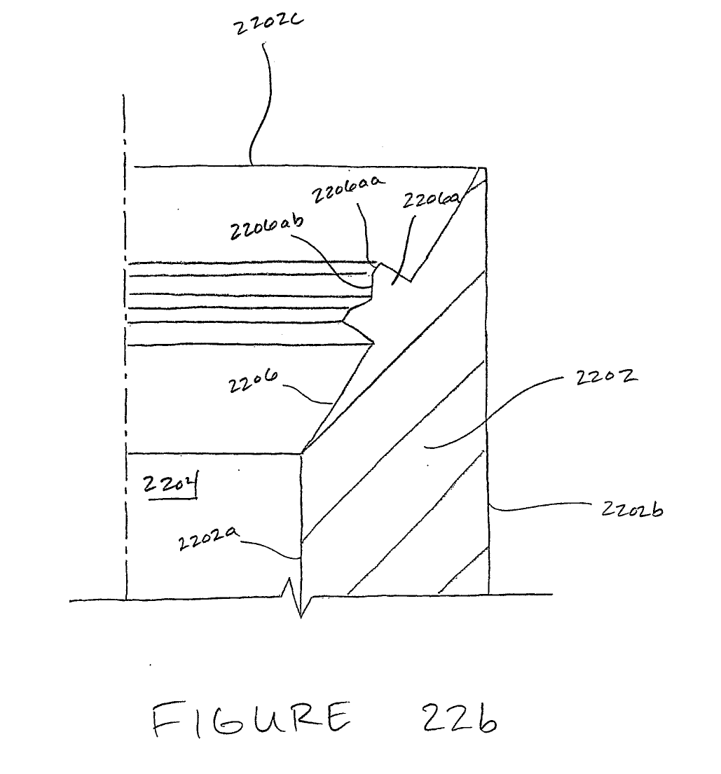

Referring now to FIGS. 22a and 22b, a first expandable tubular member 2200 is illustrated. The first expandable tubular member 2200 includes a wall 2202 having an inner surface 2202a, an outer surface 2202b located opposite the inner surface 2202a, and defining a passageway 2204 along the length of the first expandable tubular member 2200. A coupling edge 2206 is located on a distal end 2202c of the first expandable tubular member 2200 and extends between the inner surface 2202a and the outer surface 2202b at an angle with respect to the inner surface 2202a and the outer surface 2202b. A thread member 2206a extends substantially perpendicularly from the coupling edge 2206 on the first expandable tubular member 2200, includes an end 2206aa, and is substantially centrally located on the coupling edge 2206 of the first expandable tubular member 2200 between the inner surface 2202a and the outer surface 2202b. A deformation channel 2206ab is defined by the thread member 2206a and is substantially centrally located on the thread member 2206a adjacent the end 2206aa. In an exemplary embodiment, the first expandable tubular member 2200 is fabricated from a metallic material. In an exemplary embodiment, a plurality of thread members which are substantially similar in design and operation to the thread member 2206a are provided on the coupling edge 2206.

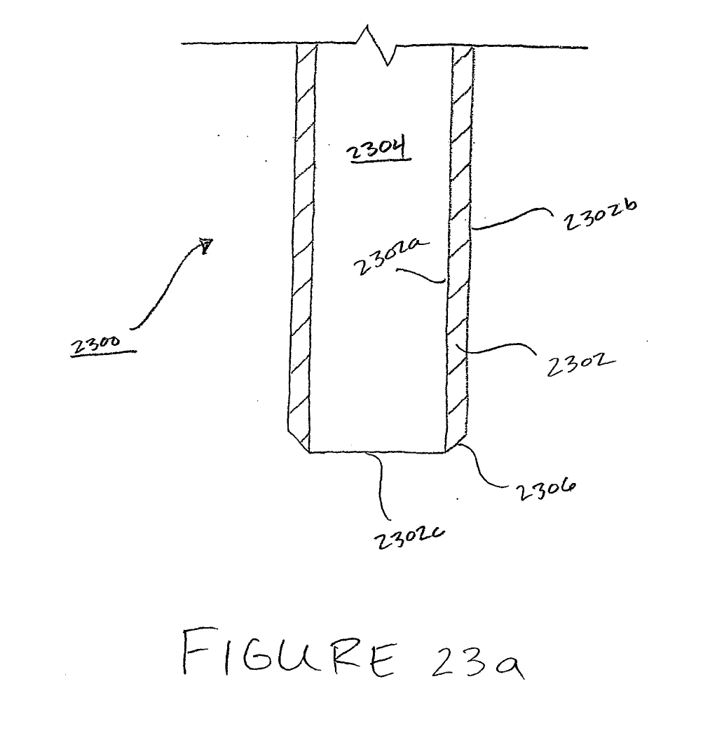

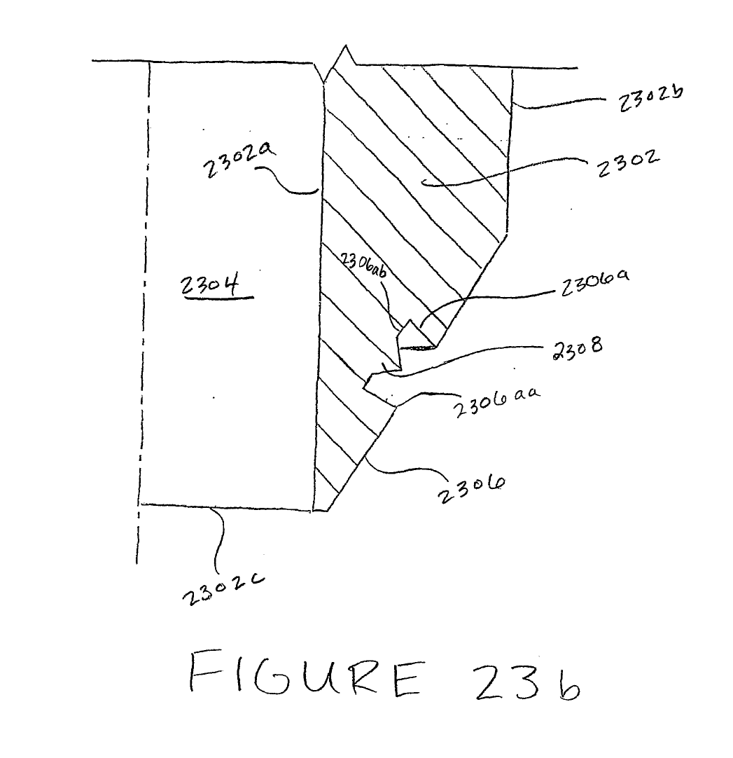

Referring now to FIGS. 23a and 23b, a second expandable tubular member 2300 is illustrated. The second expandable tubular member 2300 includes a wall 2302 having an inner surface 2302a, an outer surface 2302b located opposite the inner surface 2302a, and defining a passageway 2304 along the length of the second expandable tubular member 2300. A coupling edge 2306 is located on a distal end 2302c of the first expandable tubular member 2300 and extends between the inner surface 2302a and the outer surface 2302b at an angle with respect to the inner surface 2302a and the outer surface 2302b. The coupling edge 2306 and the wall 2302 define a thread channel 2306a which is substantially centrally located on the coupling edge 2306, oriented substantially perpendicularly with respect to the coupling edge 2306, and including an entrance 2306aa and an end 2306ab. A deformation member 2308 extends from the end 2306ab and into the thread channel 2306a. In an exemplary embodiment, the second expandable tubular member 2300 is fabricated from a metallic material. In an exemplary embodiment, a plurality of thread channels which are substantially similar in design and operation to the thread channel 2306a are provided on the coupling edge 2306.

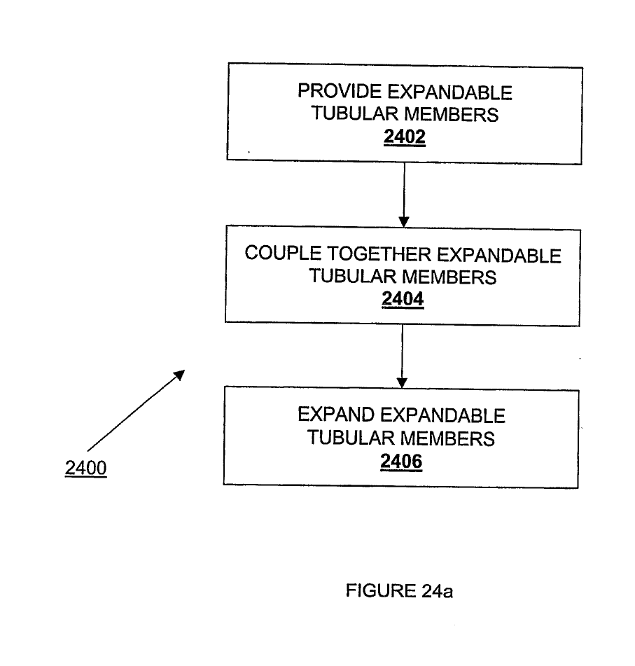

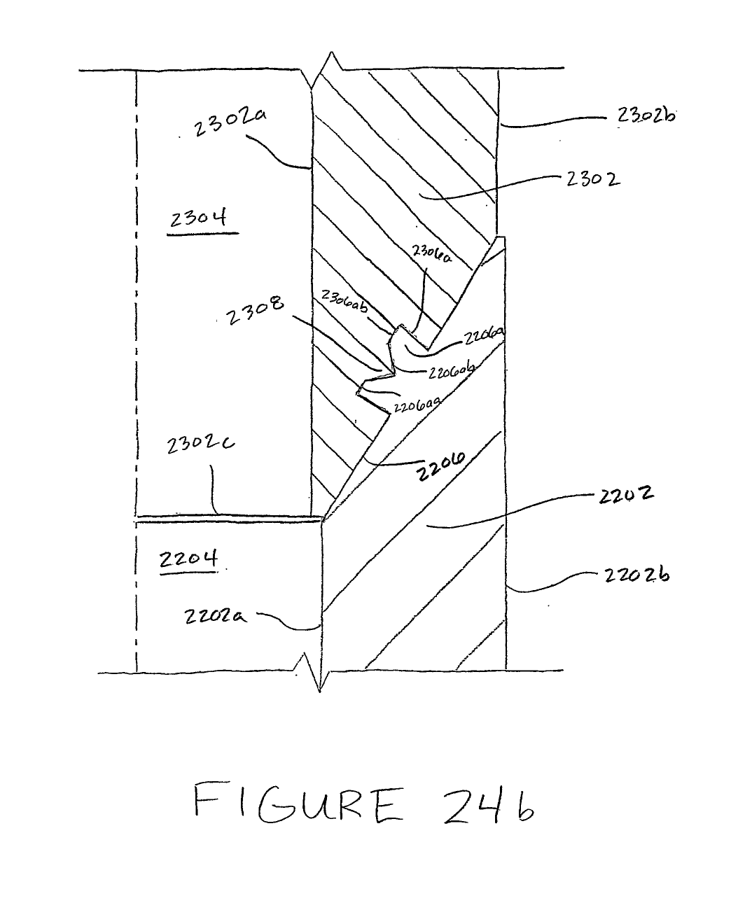

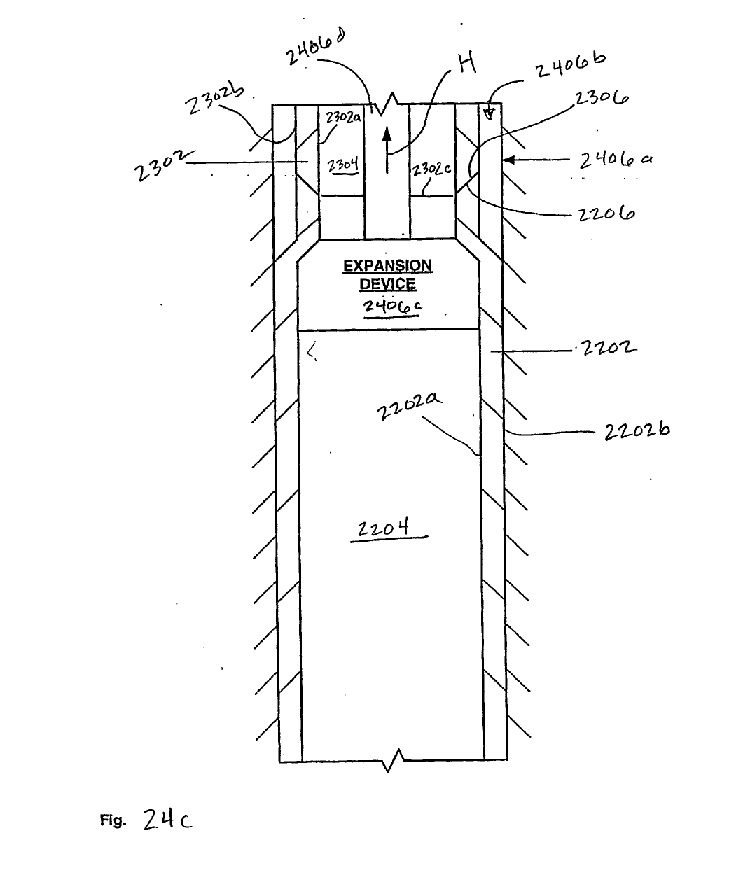

Referring now to FIGS. 22a, 23a, 24a, and 24b, a method 2400 for coupling expandable tubular members is illustrated. The method 2400 begins at step 2402 where the first expandable tubular member 2200 and the second expandable tubular member 2300 are provided. The method 2400 then proceeds to step 2404 where the first expandable tubular member 2200 and the second expandable tubular member 2300 are coupled together. The first expandable tubular member 2200 and the second expandable tubular member 2300 are positioned such that the distal end 2202c on the first expandable tubular member 2200 is adjacent the distal end 2302c on the second expandable tubular member 2300. The thread member 2206a on the first expandable tubular member 2200 is then positioned in the thread channel 2306a on the second expandable tubular member 2300. With the thread member 2206a positioned in the thread channel 2306a, the passageway 2204 on first expandable tubular member 2200 is substantially co-axial with the passageway 2304 on the second expandable tubular member 2300 and the coupling edge 2206 on the first expandable tubular member 2200 may be engaged with the coupling edge 2306 on the second expandable tubular member 2300 by rotating the first expandable tubular member 2200 relative to the second expandable tubular 2300. As the first expandable tubular member 2200 is rotated relative to the second expandable tubular 2300, the deformation member 2308 extending into the thread channel 2306a will engage the deformation channel 2206ab on the thread member 2206a. The engagement of the deformation member 2308 with the deformation channel 2206ab allows the thread member 2206a to deform in the thread channel 2306a, as illustrated in FIG. 24b. In an exemplary embodiment, deforming the thread member 2206a in the thread channel 2306a provides an air and liquid tight seal between the first expandable tubular member 2200 and the second expandable tubular member 2300. In an exemplary embodiment, deforming the thread member 2206a in the thread channel 2306a provides a metal to metal seal between the thread member 2206a and the second expandable tubular member 2300. In an exemplary embodiment, the coupling of the first expandable tubular member 2200 and the second expandable tubular member 2300 may include methods such as, for example, threading, welding, brazing, or a variety of other coupling methods known in the art.

Referring now to FIGS. 22a, 23a, 24a, 24b, and 24c, the method 2400 proceeds to step 2406 wherein the first expandable tubular member 2200 and the second expandable tubular member 2300 are expanded. A wellbore 2406a is provided which defines a passageway 2406b along its length. The coupled-together first expandable tubular member 2200 and second expandable tubular member 2300 are positioned in the passageway 2406b of the wellbore 2406a. An expansion device 2406c, which may be a conventional expansion device known in the art, is provided which is coupled to a drill string 2406d and which includes a larger diameter than the inside diameter of the first expandable tubular member 2200 and the second expandable tubular member 2300. The expansion device 2406c is positioned in the passageway 2204 on the first expandable tubular member 2200 and in engagement with the inner surface 2202a of the first expandable tubular member 2200, which results in the expansion of the first expandable tubular member 2200. The expansion device 2406c may then be moved in a direction H such that the first expandable tubular member 2200 and the second expandable tubular member 2300 are expanded into engagement with the wellbore 2406a. Upon expansion of the first expandable tubular member 2200 and the second expandable tubular member 2300, the thread member 2206a deforms further in the thread channel 2306a. In an exemplary embodiment, the deformation of the thread member 2206a in the thread channel 2306a during expansion provides an air and liquid tight seal between the first expandable tubular member 2200 and the second expandable tubular member 2300 after expansion. In an exemplary embodiment, the deformation of the thread member 2206a in the thread channel 2306a during expansion provides a metal to metal seal between the thread member 2206a and the second expandable tubular member 2300.

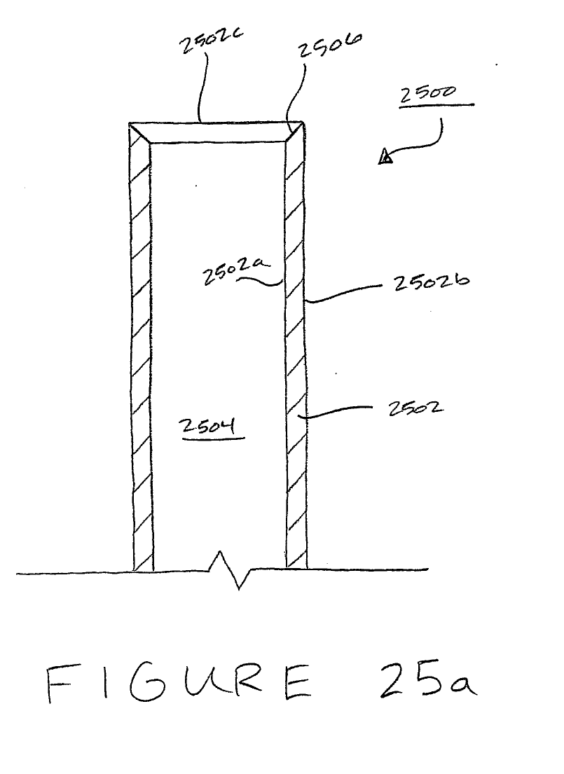

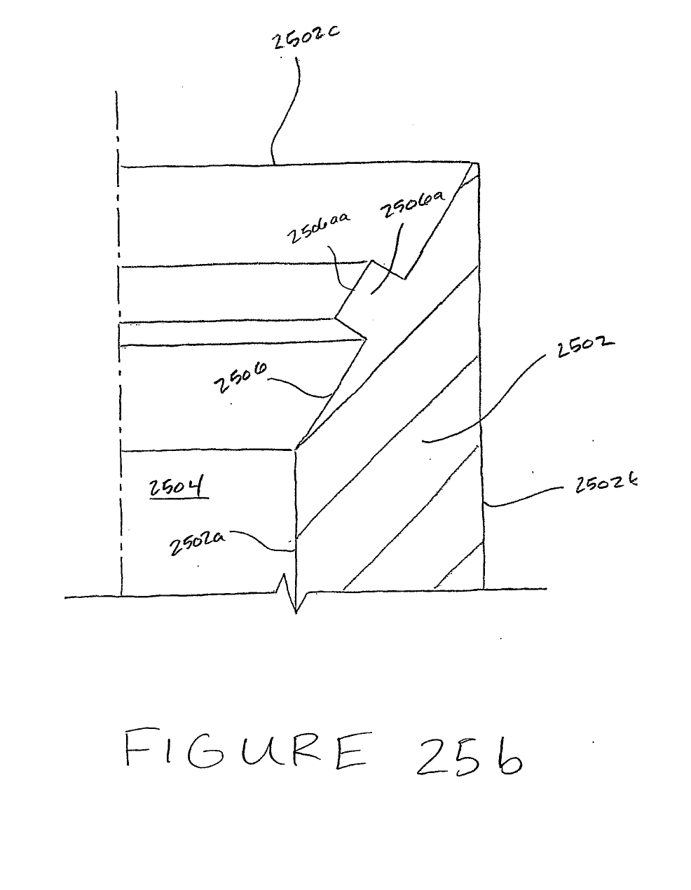

Referring now to FIGS. 25a and 25b, a first expandable tubular member 2500 is illustrated. The first expandable tubular member 2500 includes a wall 2502 having an inner surface 2502a, an outer surface 2502b located opposite the inner surface 2502a, and defining a passageway 2504 along the length of the first expandable tubular member 2500. A coupling edge 2506 is located on a distal end 2502c of the first expandable tubular member 2500 and extends between the inner surface 2502a and the outer surface 2502b at an angle with respect to the inner surface 2502a and the outer surface 2502b. A thread member 2506a extends substantially perpendicularly from the coupling edge 2206 on the first expandable tubular member 2200, includes an end 2506aa, and is substantially centrally located on the coupling edge 2506 of the first expandable tubular member 2500 between the inner surface 2502a and the outer surface 2502b. In an exemplary embodiment, the first expandable tubular member 2500 is fabricated from a metallic material. In an exemplary embodiment, a plurality of thread members which are substantially similar in design and operation to the thread member 2506a are provided on the coupling edge 2506.

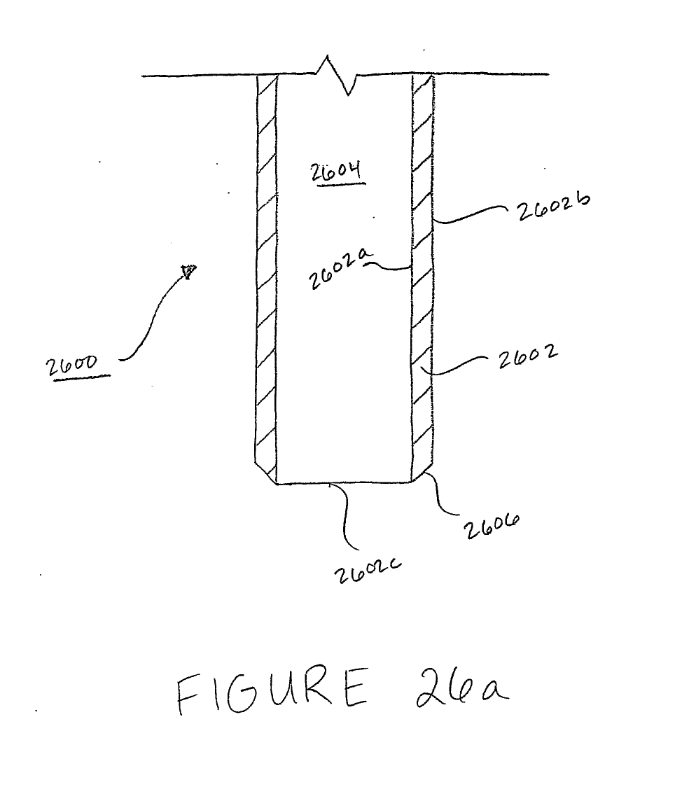

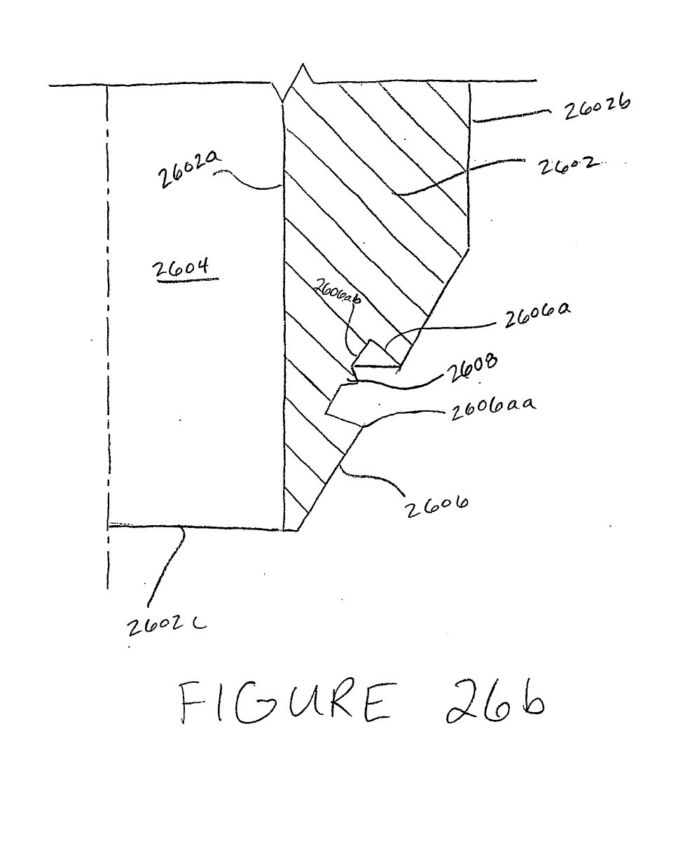

Referring now to FIGS. 26a and 26b, a second expandable tubular member 2600 is illustrated. The second expandable tubular member 2600 includes a wall 2602 having an inner surface 2602a, an outer surface 2602b located opposite the inner surface 2602a, and defining a passageway 2604 along the length of the second expandable tubular member 2600. A coupling edge 2606 is located on a distal end 2602c of the first expandable tubular member 2600 and extends between the inner surface 2602a and the outer surface 2602b at an angle with respect to the inner surface 2602a and the outer surface 2602b. The coupling edge 2606 and the wall 2602 define a thread channel 2606a which is substantially centrally located on the coupling edge 2606, oriented substantially perpendicularly with respect to the coupling edge 2602, and includes an entrance 2606aa and an end 2606ab. A deformation member 2608 extends from the end 2606ab and into the thread channel 2606a. In an exemplary embodiment, the second expandable tubular member 2600 is fabricated from a metallic material. In an exemplary embodiment, a plurality of thread channels which are substantially similar in design and operation to the thread channel 2606a are provided on the coupling edge 2606.

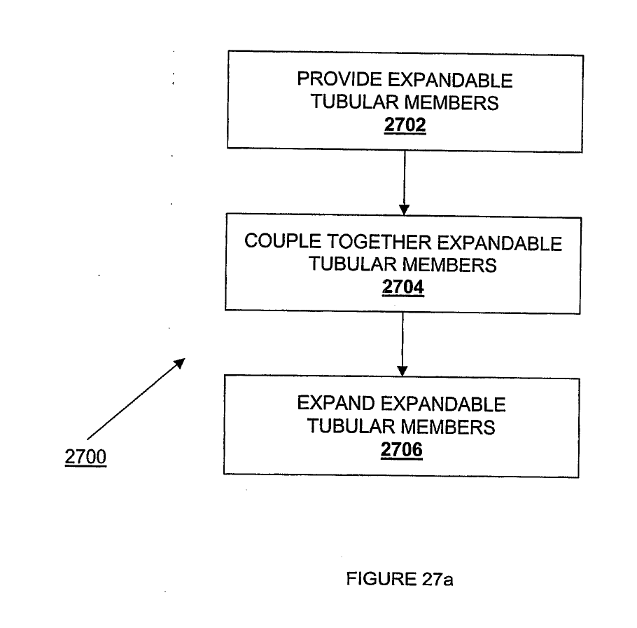

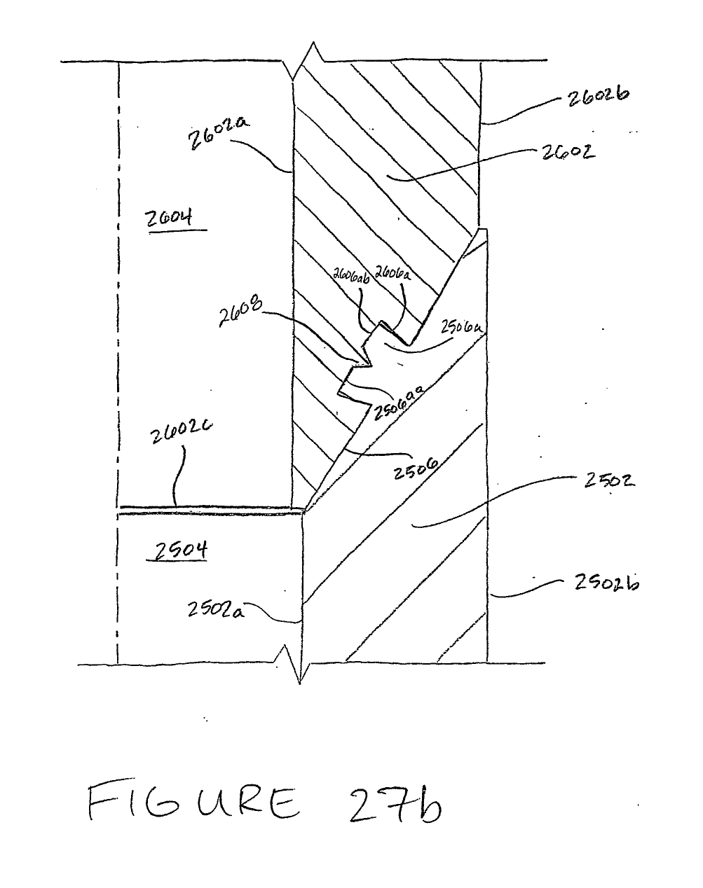

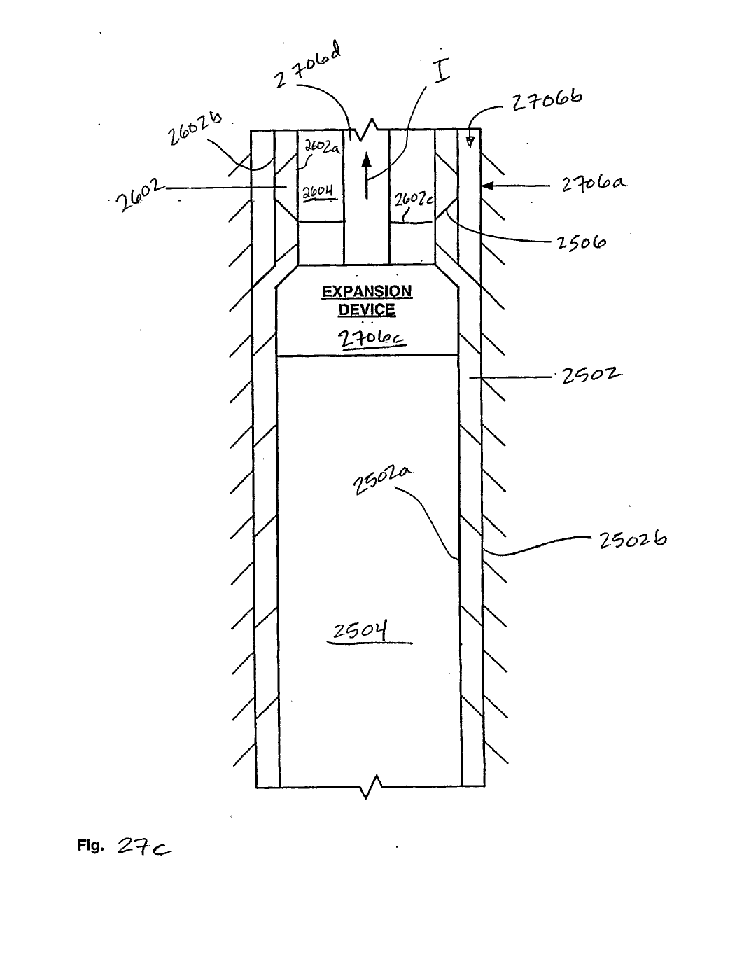

Referring now to FIGS. 25a, 26a, 27a, and 27b, a method 2700 for coupling expandable tubular members is illustrated. The method 2700 begins at step 2702 where the first expandable tubular member 2500 and the second expandable tubular member 2600 are provided. The method 2700 then proceeds to step 2704 where the first expandable tubular member 2500 and the second expandable tubular member 2600 are coupled together. The first expandable tubular member 2500 and the second expandable tubular member 2600 are positioned such that the distal end 2502c on the first expandable tubular member 2500 is adjacent the distal end 2602c on the second expandable tubular member 2600. The thread member 2506a on the first expandable tubular member 2500 is then positioned in the thread channel 2606a on the second expandable tubular member 2600. With the thread member 2506a positioned in the thread channel 2606a, the passageway 2504 on first expandable tubular member 2500 is substantially co-axial with the passageway 2604 on the second expandable tubular member 2600 and the coupling edge 2506 on the first expandable tubular member 2500 may be engaged with the coupling edge 2606 on the second expandable tubular member 2600 by rotating the first expandable tubular member 2500 relative to the second expandable tubular 2600. As the first expandable tubular member 2500 is rotated relative to the second expandable tubular 2600, the deformation member 2608 extending into the thread channel 2606b will engage the thread member 2506a. The engagement of the deformation member 2608 with the thread member 2506a allows the thread member 2506a to deform in the thread channel 2606a, as illustrated in FIG. 27b. In an exemplary embodiment, deforming the thread member 2506a in the thread channel 2606a provides an air and liquid tight seal between the first expandable tubular member 2500 and the second expandable tubular member 2600. In an exemplary embodiment, deforming the thread member 2506a in the thread channel 2606a provides a metal to metal seal between the thread member 2506a and the second expandable tubular member 2600. In an exemplary embodiment, the coupling of the first expandable tubular member 2500 and the second expandable tubular member 2600 may include methods such as, for example, threading, welding, brazing, or a variety of other coupling methods known in the art.

Referring now to FIGS. 25a, 26a, 27a, 27b, and 27c, the method 2700 proceeds to step 2706 wherein the first expandable tubular member 2500 and the second expandable tubular member 2600 are expanded. A wellbore 2706a is provided which defines a passageway 2706b along its length. The coupled-together first expandable tubular member 2500 and second expandable tubular member 2600 are positioned in the passageway 2706b of the wellbore 2706a. An expansion device 2706c, which may be a conventional expansion device known in the art, is provided which is coupled to a drill string 2706d and which includes a larger diameter than the inside diameter of the first expandable tubular member 2500 and the second expandable tubular member 2600. The expansion device 2706c is positioned in the passageway 2504 on the first expandable tubular member 2500 and in engagement with the inner surface 2502a of the first expandable tubular member 2500, which results in the expansion of the first expandable tubular member 2500. The expansion device 2706c may then be moved in a direction I such that the first expandable tubular member 2500 and the second expandable tubular member 2600 are expanded into engagement with the wellbore 2706a. Upon expansion of the first expandable tubular member 2500 and the second expandable tubular member 2600, the thread member 2506a deforms further in the thread channel 2606a. In an exemplary embodiment, the deformation of the thread member 2506a in the thread channel 2606a during expansion provides an air and liquid tight seal between the first expandable tubular member 2500 and the second expandable tubular member 2600 after expansion. In an exemplary embodiment, the deformation of the thread member 2506a in the thread channel 2606a during expansion provides a metal to metal seal between the thread member 2506a and the second expandable tubular member 2600.

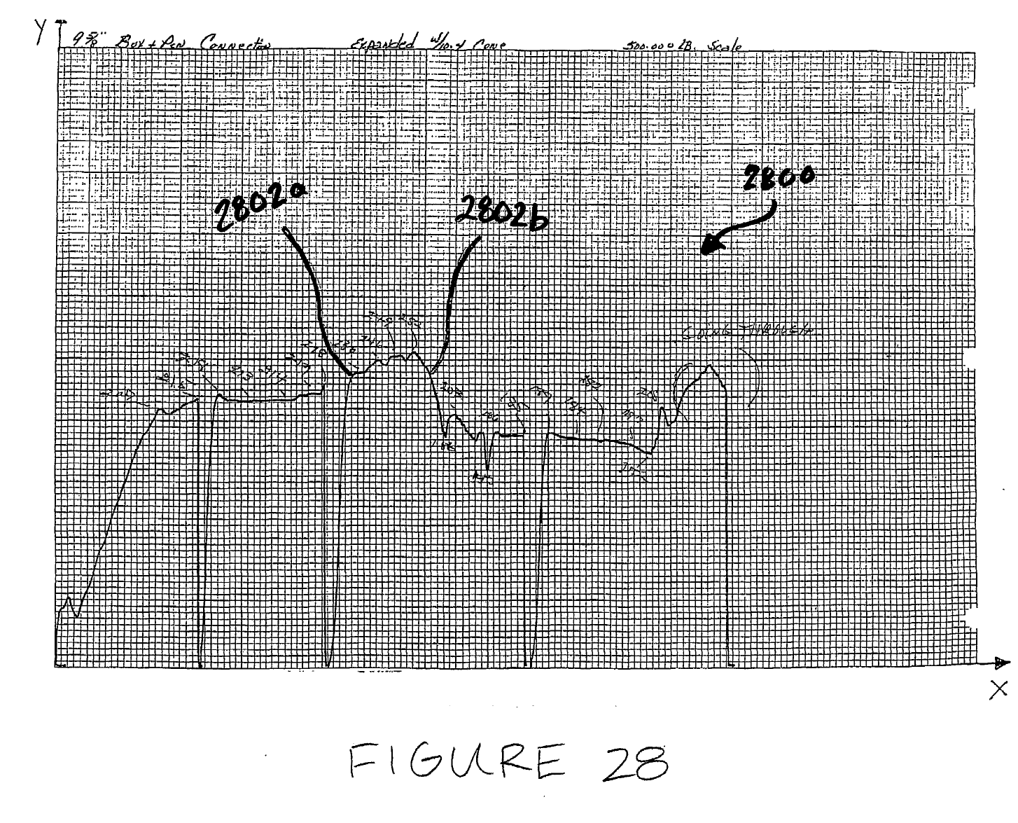

Referring now to FIG. 28, in an exemplary experimental embodiment 2800, the first expandable tubular member 1600, described above with reference to FIGS. 16a and 16b, and the second expandable tubular member 1700, described above with reference to FIGS. 17a and 17b, were coupled together and expanded according to the method 1800, described above with reference to FIGS. 18a, 18b, and 18c. The first expandable tubular member 1600 and the second expandable tubular member 1700 each had an inner diameter of approximately 9⅝ inches and were expanded by a 10.4 inch expansion cone. The graph of the experimental embodiment 2800, illustrated in FIG. 28, shows a plot of expansion force on the Y-axis vs. displacement of the expansion cone long the first expandable tubular member 1600 and the second expandable tubular member 1700 on the X-axis. The connection of the first expandable tubular member 1600 and the second expandable tubular member 1700 is shown on the graph between data points 2802a and 2802b, and indicates that the connection of the first expandable tubular member 1600 and the second expandable tubular member 1700 may be expanded using slightly more force than is required to expand each of the first expandable tubular member 1600 and the second expandable tubular member 1700. This was an unexpected result. Thus, the addition of the thread member 1606a to the first expandable tubular member 1600 and the addition of the thread channel 1706a to the second expandable tubular member 1700 does not substantially increase the force required to expand the first expandable tubular member 1600 and the second expandable tubular member 1700 when they are coupled together, thereby providing a cost effective enhancement and method for coupling together the first expandable tubular member 1600 and the second expandable tubular member 1700 and providing a gas and liquid tight metal to metal seal before, during, and after the expansion of the first expandable tubular member 1600 and the second expandable tubular member 1700.

An expandable tubular member has been described which includes a first expandable tubular member comprising a first coupling member, and a second expandable tubular member defining a second coupling channel, whereby the first expandable tubular member is operable to sealingly couple to the second expandable tubular member by deforming the first coupling member in the second coupling channel. In an exemplary embodiment, the expandable tubular member further includes a first coupling channel defined by the first expandable tubular member, and a second coupling member defined by the second expandable tubular member, whereby the first expandable tubular member is operable to sealingly couple to the second expandable tubular member by deforming the second coupling member in the first coupling channel. In an exemplary embodiment, the first coupling channel is located adjacent an inner surface of the first expandable tubular member and the first coupling member is located adjacent an outer surface of the first expandable tubular member. In an exemplary embodiment, the second coupling channel is located adjacent an outer surface of the second expandable tubular member and the second coupling member is located adjacent an inner surface of the second expandable tubular member. In an exemplary embodiment, the deforming of the first coupling member in the second coupling channel results in a gas and liquid tight seal between the first expandable tubular member and the second expandable tubular member. In an exemplary embodiment, the gas and liquid tight seal comprises a metal to metal seal between the first coupling member and the second expandable tubular member. In an exemplary embodiment, the gas and liquid tight seal is provided upon expansion of the first expandable tubular member and the second expandable tubular member. In an exemplary embodiment, the positioning of the second coupling member in the first coupling channel results in a gas and liquid tight seal between the first expandable tubular member and the second expandable tubular member. In an exemplary embodiment, the gas and liquid tight seal comprises a metal to metal seal between the second coupling member and the first expandable tubular member. In an exemplary embodiment, the gas and liquid tight seal is provided upon expansion of the first expandable tubular member and the second expandable tubular member. In an exemplary embodiment, the expandable tubular member further includes a third coupling member on the first expandable tubular member, and a third coupling channel defined by the second expandable tubular member, whereby deforming the first coupling member in the second coupling channel and deforming the second coupling member in the first coupling channel results in the third coupling member deforming in the third coupling channel to sealingly couple the first expandable tubular member to the second expandable tubular member. In an exemplary embodiment, the deforming of the third coupling member in the third coupling channel results in a gas and liquid tight seal between the first expandable tubular member and the second expandable tubular member. In an exemplary embodiment, the gas and liquid tight seal comprises a metal to metal seal between the third coupling member and the second expandable tubular member. In an exemplary embodiment, the gas and liquid tight seal is provided upon expansion of the first expandable tubular member and the second expandable tubular member.

An expandable tubular member has been described which includes a first expandable tubular member comprising a coupling member and a compressible member coupled to the coupling member, and a second expandable tubular member defining a coupling channel and operable to couple to the first expandable tubular member by positioning the coupling member in the coupling channel. In an exemplary embodiment, the coupling member is located adjacent an outer surface of the first expandable tubular member. In an exemplary embodiment, the coupling channel is located adjacent an outer surface of the second expandable tubular member. In an exemplary embodiment, the compressible member comprises a compressible ring coupled to the coupling member. In an exemplary embodiment, the compressible member comprises a metal material. In an exemplary embodiment, the compressible member comprises an elastomer material. In an exemplary embodiment, the coupling of the first expandable tubular member and the second expandable tubular member and the expansion of the first expandable tubular member and the second expandable tubular member results in a gas and liquid tight seal between the first expandable tubular member and the second expandable tubular member. In an exemplary embodiment, the gas and liquid tight seal comprises a metal to metal seal between the coupling member and the second expandable tubular member. In an exemplary embodiment, the gas and liquid tight seal if formed between the first expandable tubular member and the second expandable tubular member by the engagement of the coupling member and the second expandable tubular member as a result of compressing the compressible member during expansion of first expandable tubular member and the second expandable tubular member.

An expandable tubular member has been described which includes a first expandable tubular member comprising a thread member which defines an deformation channel, and a second expandable tubular member defining a thread channel and operable to couple to the first expandable tubular member by deforming the thread member in the thread channel using the deformation channel. In an exemplary embodiment, the deformation channel is located on a first end of the thread member. In an exemplary embodiment, the thread channel has an approximately constant width from an entrance of the thread channel to an end of the thread channel. In an exemplary embodiment, the thread channel increases in width from an entrance of the thread channel to an end of the thread channel. In an exemplary embodiment, a gas and liquid tight seal is formed between the first expandable tubular member and the second expandable tubular member from the deformation of the thread member in the thread channel. In an exemplary embodiment, the gas and liquid tight seal comprises a metal to metal seal between the thread member and the second expandable tubular member. In an exemplary embodiment, the expandable tubular member further includes a deformation member extending from the second expandable tubular member and into the thread channel, whereby the deformation of the thread member in the thread channel in accomplished by engaging the deformation member with the deformation channel. In an exemplary embodiment, a gas and liquid tight seal is formed between the first expandable tubular member and the second expandable tubular member from the deformation of the thread member in the thread channel. In an exemplary embodiment, the gas and liquid tight seal comprises a metal to metal seal between the thread member and the second expandable tubular member.

An expandable tubular member has been described which includes a first expandable tubular member comprising a thread member, and a second expandable tubular member defining a thread channel and comprising a deformation member extending from the second expandable tubular member and into the thread channel, the second expandable tubular member operable to couple to the first expandable tubular member by deforming the thread member in the thread channel as a result of engagement of the deformation member with the thread member. In an exemplary embodiment, the thread channel has an approximately constant width from an entrance of the thread channel to an end of the thread channel. In an exemplary embodiment, the thread channel increases in width from an entrance of the thread channel to an end of the thread channel. In an exemplary embodiment, a gas and liquid tight seal is formed between the first expandable tubular member and the second expandable tubular member from the deformation of the thread member in the thread channel. In an exemplary embodiment, the gas and liquid tight seal comprises a metal to metal seal between the thread member and the second expandable tubular member.

An expandable tubular member has been described which includes a first expandable tubular member, a second expandable tubular member, and deforming means for sealingly coupling the first expandable tubular member to the second expandable tubular member. In an exemplary embodiment, the deforming means comprises a means for deforming the second expandable tubular member into sealing engagement with the first expandable tubular member. In an exemplary embodiment, the deforming means is operable to provide a gas and liquid tight seal between the first expandable tubular member and the second expandable tubular member. In an exemplary embodiment, the gas and liquid tight seal is provided upon expansion of the first expandable tubular member and the second expandable tubular member. In an exemplary embodiment, the gas and liquid tight seal comprises a metal to metal seal between the first coupling member and the second coupling channel.

A method for coupling expandable tubular members has been described which includes providing a first expandable tubular member defining a first coupling channel and comprising a first coupling member, providing a second expandable tubular member defining a second coupling channel and comprising a second coupling member, and coupling the first expandable tubular member to the second expandable tubular member by deforming the first coupling member in the second coupling channel and deforming the second coupling member in the first coupling channel. In an exemplary embodiment, the coupling comprises providing a gas and liquid tight seal between the first expandable tubular member and the second expandable tubular member. In an exemplary embodiment, the coupling comprises providing a metal to metal seal between the first expandable tubular member and the second expandable tubular member. In an exemplary embodiment, the method further includes expanding the first expandable tubular member and the second expandable tubular member. In an exemplary embodiment, the expanding provides a gas and liquid tight seal between the first expandable tubular member and the second expandable tubular member. In an exemplary embodiment, the expanding provides a metal to metal seal between the first expandable tubular member and the second expandable tubular member. In an exemplary embodiment, the method further includes providing a third coupling member on the first expandable tubular member and defining a third coupling channel by the second expandable tubular member, and deforming the third coupling member in the third coupling channel to couple the first expandable tubular member to the second expandable tubular member. In an exemplary embodiment, the deforming comprises providing a gas and liquid tight seal between the first expandable tubular member and the second expandable tubular member. In an exemplary embodiment, the deforming comprises providing a metal to metal seal between the first expandable tubular member and the second expandable tubular member. In an exemplary embodiment, the method further includes expanding the first expandable tubular member and the second expandable tubular member. In an exemplary embodiment, the expanding provides a gas and liquid tight seal between the first expandable tubular member and the second expandable tubular member. In an exemplary embodiment, the expanding provides a metal to metal seal between the first expandable tubular member and the second expandable tubular member.

A method for coupling expandable tubular members has been described which includes providing a first expandable tubular member comprising a coupling member and a compressible member coupled to the coupling member, providing a second expandable tubular member defining a coupling channel, coupling the first expandable tubular member to the second expandable tubular member by positioning the coupling member in the coupling channel, and expanding the first expandable tubular member and the second expandable tubular member, whereby the expanding compresses the compressible material and sealingly engages the coupling member and the second expandable tubular member. In an exemplary embodiment, the expanding provides a gas and liquid tight seal between the first expandable tubular member and the second expandable tubular member. In an exemplary embodiment, the expanding provides a metal to metal seal between the first expandable tubular member and the second expandable tubular member.

A method for coupling expandable tubular members has been described which includes providing a first expandable tubular member comprising a thread member which defines an deformation channel, providing a second expandable tubular member defining a thread channel, and coupling the second expandable tubular member to the first expandable tubular member by deforming the thread member in the thread channel using the deformation channel. In an exemplary embodiment, the coupling comprises providing a gas and liquid tight seal between the first expandable tubular member and the second expandable tubular member. In an exemplary embodiment, the coupling comprises providing a metal to metal seal between the first expandable tubular member and the second expandable tubular member. In an exemplary embodiment, the method further includes expanding the first expandable tubular member and the second expandable tubular member. In an exemplary embodiment, the expanding provides a gas and liquid tight seal between the first expandable tubular member and the second expandable tubular member. In an exemplary embodiment, the expanding provides a metal to metal seal between the first expandable tubular member and the second expandable tubular member. In an exemplary embodiment, the method further includes providing a deformation member extending from the second expandable tubular member and into the thread channel, whereby the coupling comprises engaging the deformation member with the deformation channel.

A method for coupling expandable tubular members has been described which includes providing a first expandable tubular member comprising a thread member, providing a second expandable tubular member defining a thread channel and comprising a deformation member extending from the second expandable tubular member and into the thread channel, and coupling the second expandable tubular member to the first expandable tubular member by deforming the thread member in the thread channel by engaging the deformation member with the thread member. In an exemplary embodiment, the coupling provides a gas and liquid tight seal between the first expandable tubular member and the second expandable tubular member. In an exemplary embodiment, the coupling comprises providing a metal to metal seal between the first expandable tubular member and the second expandable tubular member. In an exemplary embodiment, the method further includes expanding the first expandable tubular member and the second expandable tubular member. In an exemplary embodiment, the expanding comprises providing a gas and liquid tight seal between the first expandable tubular member and the second expandable tubular member. In an exemplary embodiment, the expanding comprises providing a metal to metal seal between the first expandable tubular member and the second expandable tubular member.

An expandable tubular member has been described which includes a first expandable tubular member defining a first coupling channel located adjacent an inner surface of the first expandable tubular member and comprising a first coupling member located adjacent an outer surface of the first expandable tubular member, and a second expandable tubular member defining a second coupling channel located adjacent an outer surface of the second expandable tubular member and comprising a second coupling member located adjacent an inner surface of the second expandable tubular member, whereby the first expandable tubular member is operable to sealingly couple to the second expandable tubular member and provide and gas and liquid tight metal to metal seal by positioning the first coupling member in the second coupling channel and deforming the first coupling member in the second coupling channel and positioning the second coupling member in the first coupling channel and deforming the second coupling member in the second coupling channel.

An expandable tubular member has been described which includes a first expandable tubular member defining a first coupling channel located adjacent an inner surface of the first expandable tubular member, comprising a first coupling member located adjacent an outer surface of the first expandable tubular member, and comprising a third coupling member located between the first coupling channel and the first coupling member, and a second expandable tubular member defining a second coupling channel located adjacent an outer surface of the second expandable tubular member, comprising a second coupling member located adjacent an inner surface of the second expandable tubular member, and comprising a third coupling channel located between the second coupling channel and the second coupling member, whereby the first expandable tubular member is operable to sealingly couple to the second expandable tubular member and provide and gas and liquid tight metal to metal seal by positioning the third coupling member in the third coupling channel and deforming the third coupling member in the third coupling channel.

An expandable tubular member has been described which includes a first expandable tubular member comprising a coupling member located adjacent an outer surface of the first expandable tubular member and a compressible metal ring coupled to the coupling member, and a second expandable tubular member defining a coupling channel located adjacent an outer surface of the second expandable tubular member and operable to couple to the first expandable tubular member by positioning the coupling member in the coupling channel, whereby a gas and liquid tight metal to metal seal is formed between the first expandable tubular member and the second expandable tubular member by the engagement of the coupling member and the second expandable tubular member upon the expansion of the first expandable tubular member and the second expandable tubular member and the compressing of the compressible member.

An expandable tubular member has been described which includes a first expandable tubular member comprising a thread member which defines a deformation channel located on a first end of the thread member, and a second expandable tubular member defining a thread channel having an approximately constant width from an entrance of the thread channel to an end of the thread channel, the thread member and the thread channel operable to provide a gas and liquid tight metal to metal seal between the first expandable tubular member and the second expandable tubular member by deforming the thread member in the thread channel using the deformation channel.

An expandable tubular member has been described which includes a first expandable tubular member comprising a thread member which defines a deformation channel located on a first end of the thread member, and a second expandable tubular member defining a thread channel which increases in width from an entrance of the thread channel to an end of the thread channel, the thread member and the thread channel operable to provide a gas and liquid tight metal to metal seal between the first expandable tubular member and the second expandable tubular member by deforming the thread member in the thread channel using the deformation channel.

An expandable tubular member has been described which includes a first expandable tubular member comprising a thread member which defines a deformation channel located on a first end of the thread member, and a second expandable tubular member defining a thread channel and comprising a deformation member extending from the second expandable tubular member and into the thread channel, the thread member and the thread channel operable to provide a gas and liquid tight metal to metal seal between the first expandable tubular member and the second expandable tubular member by deforming the thread member in the thread channel by engaging the deformation member with the deformation channel.

A method for coupling expandable tubular members has been described which includes providing a first expandable tubular member defining a first coupling channel and comprising a first coupling member, providing a second expandable tubular member defining a second coupling channel and comprising a second coupling member, coupling together and providing a gas and liquid tight metal to metal seal between the first expandable tubular member to the second expandable tubular member by deforming the first coupling member in the second coupling channel and deforming the second coupling member in the first coupling channel, and expanding the first expandable tubular member and the second expandable tubular member and providing a gas and liquid tight metal to metal seal between the first expandable tubular member and the second expandable tubular member.

A method for coupling expandable tubular members has been described which includes providing a first expandable tubular member defining a first coupling channel, comprising a first coupling member, and comprising a third coupling member, providing a second expandable tubular member defining a second coupling channel, comprising a second coupling member, and defining a third coupling channel, coupling together and providing a gas and liquid tight metal to metal seal between the first expandable tubular member to the second expandable tubular member by positioning the first coupling member in the second coupling channel, positioning the second coupling member in the first coupling channel, and deforming the third coupling member in the third coupling channel, and expanding the first expandable tubular member and the second expandable tubular member and providing a gas and liquid tight metal to metal seal between the first expandable tubular member and the second expandable tubular member.

A method for coupling expandable tubular members has been described which includes providing a first expandable tubular member comprising a coupling member and a compressible member coupled to the coupling member, providing a second expandable tubular member defining a coupling channel, coupling the first expandable tubular member to the second expandable tubular member by positioning the coupling member in the coupling channel, and expanding the first expandable tubular member and the second expandable tubular member, whereby the expanding compresses the compressible material and provides a gas and liquid tight metal to metal seal between the first expandable tubular member and the second expandable tubular member by the engagement of the coupling member and the second expandable tubular member.

A method for coupling expandable tubular members has been described which includes providing a first expandable tubular member comprising a thread member which defines a deformation channel, providing a second expandable tubular member defining a thread channel, coupling the second expandable tubular member to the first expandable tubular member by deforming the thread member in the thread channel using the deformation channel and providing a gas and liquid tight metal to metal seal between the first expandable tubular member and the second expandable tubular member, and expanding the first expandable tubular member and the second expandable tubular member and providing a gas and liquid tight metal to metal seal between the first expandable tubular member and the second expandable tubular member.

A method for coupling expandable tubular members has been described which includes providing a first expandable tubular member comprising a thread member which defines a deformation channel, providing a second expandable tubular member defining a thread channel and comprising a deformation member extending from the second expandable tubular member and into the thread channel, coupling the second expandable tubular member to the first expandable tubular member by deforming the thread member in the thread channel using the deformation member and the deformation channel and providing a gas and liquid tight metal to metal seal between the first expandable tubular member and the second expandable tubular member, and expanding the first expandable tubular member and the second expandable tubular member and providing a gas and liquid tight metal to metal seal between the first expandable tubular member and the second expandable tubular member.

A method for coupling expandable tubular members has been described which includes providing a first expandable tubular member comprising a thread member, providing a second expandable tubular member defining a thread channel and comprising a deformation member extending from the second expandable tubular member and into the thread channel, coupling the second expandable tubular member to the first expandable tubular member by deforming the thread member in the thread channel by engaging the deformation member with the thread member and providing a gas and liquid tight metal to metal seal between the first expandable tubular member and the second expandable tubular member, and expanding the first expandable tubular member and the second expandable tubular member and providing a gas and liquid tight metal to metal seal between the first expandable tubular member and the second expandable tubular member.

It is understood that variations may be made in the foregoing without departing from the scope of the invention. Furthermore, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

1. An expandable tubular member comprising:
a first expandable tubular member comprising a first coupling member; and
a second expandable tubular member defining a first coupling channel, whereby the first expandable tubular member is operable to sealingly couple to the second expandable tubular member by deforming the first coupling member in the first coupling channel.

2. The expandable tubular member of claim 1 further comprising:
a second coupling channel defined by the first expandable tubular member; and
a second coupling member defined by the second expandable tubular member, whereby the first expandable tubular member is operable to sealingly couple to the second expandable tubular member by deforming the second coupling member in the second coupling channel.

3. The expandable tubular member of claim 2 wherein the second coupling channel is located adjacent an inner surface of the first expandable tubular member and the first coupling member is located adjacent an outer surface of the first expandable tubular member.

4. The expandable tubular member of claim 2 wherein the first coupling channel is located adjacent an outer surface of the second expandable tubular member and the second coupling member is located adjacent an inner surface of the second expandable tubular member.

5. The expandable tubular member of claim 1 wherein the deforming of the first coupling member in the first coupling channel results in a gas and liquid tight seal between the first expandable tubular member and the second expandable tubular member.

6. The expandable tubular member of claim 5 wherein the gas and liquid tight seal comprises a metal to metal seal between the first coupling member and the second expandable tubular member.

7. The expandable tubular member of claim 5 wherein the gas and liquid tight seal is provided upon expansion of the first expandable tubular member and the second expandable tubular member.

8. The expandable tubular member of claim 2 wherein the positioning of the second coupling member in the second coupling channel results in a gas and liquid tight seal between the first expandable tubular member and the second expandable tubular member.

9. The expandable tubular member of claim 8 wherein the gas and liquid tight seal comprises a metal to metal seal between the second coupling member and the first expandable tubular member.

10. The expandable tubular member of claim 8 wherein the gas and liquid tight seal is provided upon expansion of the first expandable tubular member and the second expandable tubular member.

11. The expandable tubular member of claim 2 further comprising:
a third coupling member on the first expandable tubular member; and
a third coupling channel defined by the second expandable tubular member, whereby deforming the first coupling member in the first coupling channel and deforming the second coupling member in the second coupling channel results in the third coupling member deforming in the third coupling channel to sealingly couple the first expandable tubular member to the second expandable tubular member.

12-14. (canceled)

15. An expandable tubular member comprising:
a first expandable tubular member comprising a coupling member and a compressible member coupled to the coupling member, and
a second expandable tubular member defining a coupling channel and operable to couple to the first expandable tubular member by positioning the coupling member in the coupling channel.

16. The expandable tubular member of claim 15 wherein the coupling member is located adjacent an outer surface of the first expandable tubular member.

17. (canceled)

18. The expandable tubular member of claim 15 wherein the compressible member comprises a compressible ring coupled to the coupling member.

19. The expandable tubular member of claim 15 wherein the compressible member comprises a metal material.

20. The expandable tubular member of claim 15 wherein the compressible member comprises an elastomer material.

21-22. (canceled)

23. The expandable tubular member of claim 15 wherein a gas and liquid tight seal is formed between the first expandable tubular member and the second expandable tubular member by the engagement of the coupling member and the second expandable tubular member as a result of compressing the compressible member during expansion of the first expandable tubular member and the second expandable tubular member.

24. An expandable tubular member comprising:
a first expandable tubular member comprising a thread member which defines an deformation channel; and
a second expandable tubular member defining a thread channel and operable to couple to the first expandable tubular member by deforming the thread member in the thread channel using the deformation channel.

25. The expandable tubular member of claim 24 wherein the deformation channel is located on a first end of the thread member.

26. The expandable tubular member of claim 24 wherein the thread channel has an approximately constant width from an entrance of the thread channel to an end of the thread channel.

27. The expandable tubular member of claim 24 wherein the thread channel increases in width from an entrance of the thread channel to an end of the thread channel.

28-32. (canceled)

33. An expandable tubular member comprising:
a first expandable tubular member comprising a thread member; and
a second expandable tubular member defining a thread channel and comprising a deformation member extending from the second expandable tubular member and into the thread channel, the second expandable tubular member operable to couple to the first expandable tubular member by deforming the thread member in the thread channel as a result of engagement of the deformation member with the thread member.

34-37. (canceled)

38. A method for coupling expandable tubular members comprising:
providing a first expandable tubular member defining a first coupling channel and comprising a first coupling member;
providing a second expandable tubular member defining a second coupling channel and comprising a second coupling member; and
coupling the first expandable tubular member to the second expandable tubular member by deforming the first coupling member in the second coupling channel and deforming the second coupling member in the first coupling channel.

39-40. (canceled)

41. The method of claim 38 further comprising:
expanding the first expandable tubular member and the second expandable tubular member.

42-43. (canceled)

44. The method of claim 38 further comprising:
providing a third coupling member on the first expandable tubular member and defining a third coupling channel by the second expandable tubular member; and
deforming the third coupling member in the third coupling channel to couple the first expandable tubular member to the second expandable tubular member.

45-49. (canceled)

50. A method for coupling expandable tubular members comprising:
providing a first expandable tubular member comprising a coupling member and a compressible member coupled to the coupling member;
providing a second expandable tubular member defining a coupling channel;
coupling the first expandable tubular member to the second expandable tubular member by positioning the coupling member in the coupling channel; and
expanding the first expandable tubular member and the second expandable tubular member, whereby the expanding compresses the compressible member and sealingly engages the coupling member and the second expandable tubular member.

51-65. (canceled)
